(19) United States
(12) Patent Application Publication
(10) Pub. No.: US 2020/0265522 A1
(43) Pub. Date: Aug. 20, 2020

(54) RIVING LONGEVITY-CONTINGENT INSTRUMENTS

(71) Applicant: 2BC Innovations, LLC, Barrington, IL (US)

(72) Inventor: Gary W. Grube, Barrington Hills, IL (US)

(73) Assignee: 2BC Innovations, LLC, Barrington, IL (US)

(21) Appl. No.: 16/866,684

(22) Filed: May 5, 2020

Related U.S. Application Data
(63) Continuation-in-part of application No. 16/243,828, filed on Jan. 9, 2019.
(60) Provisional application No. 62/628,127, filed on Feb. 8, 2018.

(51) Int. Cl. G06Q 40/06; G06Q 40/08; G06Q 10/10; G06Q 10/06

(52) U.S. Cl. CPC G06Q 40/06; G06Q 10/067; G06Q 10/1057; G06Q 40/08

(57) ABSTRACT

A method executed by a computing device includes interpreting digitally encoded rive parameters to produce rive approach requirements and determining an initial rive approach. The method further includes analyzing available longevity-contingent instruments to produce characterization information. When the characterization information indicates availability of a first face value benefit to fund a first sequential portion of a second premium payment stream using the initial rive approach, the method further includes selecting first and second longevity-contingent instruments to include in an initial set of longevity-contingent instruments and riving the first and second longevity-contingent instruments to produce first and second sub-assets and first and second sub-liabilities. The method further includes issuing sub-asset information to a benefactor computing device and issuing sub-liability information to a debtor computing device.

### CROSS REFERENCE TO RELATED PATENTS

The present U.S. Utility Patent Application claims priority pursuant to 35 U.S.C. § 120 as a continuation in part of U.S. Utility application Ser. No. 16/243,828, entitled “ASSET UTILIZATION OPTIMIZATION COMMUNICATION SYSTEM AND COMPONENTS THEREOF,” filed Jan. 9, 2019, pending, which claims priority pursuant to 35 U.S.C. § 119(e) to U.S. Provisional Application No. 62/628,127, entitled “ASSET UTILIZATION OPTIMIZATION COMMUNICATION SYSTEM AND COMPONENTS THEREOF,” filed Feb. 8, 2018, all of which are hereby incorporated herein by reference in their entirety and made part of the present U.S. Utility Patent Application for all purposes.

### STATEMENT REGARDING FEDERALLY SPONSORED RESEARCH OR DEVELOPMENT—NOT APPLICABLE

### INCORPORATION-BY-REFERENCE OF MATERIAL SUBMITTED ON A COMPACT DISC—NOT APPLICABLE

### BACKGROUND OF THE INVENTION

### Technical Field of the Invention

This invention relates generally to communication systems and more particularly to asset reconfiguration and reassignment within the communication system.

### Description of Related Art

Communication systems are known to communicate data between communication devices of the communication system. The data may be communicated in one or more of an unaltered form (e.g., raw data from a first communication device), in an altered form to provide enhanced transmission reliability (e.g., error encoded), in an altered form to provide enhanced security of access (e.g., credentialed access, encryption), and in an altered form to enhance communication resource utilization (e.g., compression). The data may represent a wide variety of data types including one or more of video, audio, text, graphics, and images. Text data is widely known to represent text character documentation, financial documents of numerical nature, and/or a combination thereof.

Global enterprise operations are increasingly utilizing communication systems to communicate representations of financial affairs. Financial documents associated with the financial affairs may include advertisements, solicitations, asset pricing information, purchase orders, invoices, payment transactions, asset distribution information, complex settlement information, financing information, financial market information, asset titling information, transaction guarantee information, global finance trend analysis information, and other information associated with the increasingly complex world of electronic commerce.

The global velocity of data communication and massive volume of data representing financial documents is ever-increasing and as a result it is a growing challenge to communicate, manipulate, and enhance the data related to financial affairs. Such challenges include refreshing an asset base of the financial system (e.g., including detecting growing issues with regards to desired funding levels of the financial system), unlocking untapped asset value (e.g., conversion of one asset type to another), and rapidly retitling new or re-spun assets (e.g., assigning new assets, reassigning converted assets).

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of a device of a communication system in accordance with the present invention;

FIG. 3 is a schematic block diagram of an embodiment of a server of a communication system in accordance with the present invention;

FIGS. 4A-4B are schematic block diagrams of another embodiment of a communication system in accordance with the present invention;

FIG. 4C is a logic diagram of an example of a method of enhancing a legacy asset base in accordance with the present invention;

FIG. 4D is a logic diagram of another method of enhancing a legacy asset base in accordance with the present invention;

FIG. 5A is a schematic block diagram of an embodiment of a diagnostic module in accordance with the present invention;

FIG. 5B is a logic diagram of an example of a method of diagnosing a legacy asset base in accordance with the present invention;

FIG. 6A is a schematic block diagram of an embodiment of an acquisition module in accordance with the present invention;

FIG. 6B is a diagram of an example of acquiring augmenting assets in accordance with the present invention;

FIG. 6C is a logic diagram of an example of a method of acquiring augmenting assets in accordance with the present invention;

FIG. 7A is a schematic block diagram of an embodiment of an augmentation module in accordance with the present invention;

FIG. 7B is a diagram of an example of utilizing augmenting assets in accordance with the present invention;

FIG. 7C is a logic diagram of an example of a method utilizing augmenting assets in accordance with the present invention;

FIG. 8A is a schematic block diagram of another embodiment of a communication system in accordance with the present invention;

FIG. 8B is a logic diagram of another example of a method of enhancing a legacy asset base in accordance with the present invention;

FIG. 9A is a schematic block diagram of another embodiment of a communication system in accordance with the present invention;

FIG. 9B is a logic diagram of an example of a method of acquisition of an augmenting asset bundle in accordance with the present invention;

FIG. 10A is a schematic block diagram of another embodiment of a communication system in accordance with the present invention;

FIG. 10B is a logic diagram of an example of a method of updating an acquired augmenting asset bundle in accordance with the present invention;

FIG. 11A is a schematic block diagram of another embodiment of a communication system in accordance with the present invention;

FIG. 11B is a logic diagram of another example of a method of updating an acquired augmenting asset bundle in accordance with the present invention;

FIG. 12A is a schematic block diagram of another embodiment of a communication system in accordance with the present invention;

FIG. 12B is a logic diagram of another example of a method of updating an acquired augmenting asset bundle in accordance with the present invention;

FIG. 13A is a schematic block diagram of another embodiment of a communication system in accordance with the present invention;

FIG. 13B is a logic diagram of another example of a method of updating an acquired augmenting asset bundle in accordance with the present invention;

FIG. 14A is a schematic block diagram of another embodiment of a communication system in accordance with the present invention;

FIG. 14B is a logic diagram of an example of a method of converting the financial system from a first type to a second type in accordance with the present invention;

FIG. 15A is a schematic block diagram of another embodiment of a communication system in accordance with the present invention;

FIG. 15B is a logic diagram of an example of a method of modifying terms of a financial instrument in accordance with the present invention;

FIG. 16A is a schematic block diagram of another embodiment of a communication system in accordance with the present invention;

FIG. 16B is a logic diagram of an example of a method of evaluating performance of the financial system bundle in accordance with the present invention;

FIG. 16C is a logic diagram of an example of a method of optimizing performance of a financial system in accordance with the present invention;

FIG. 17A is a schematic block diagram of another embodiment of a communication system in accordance with the present invention;

FIG. 17B is a logic diagram of an example of a method of detecting a shift in a financial system in accordance with the present invention;

FIG. 18A is a schematic block diagram of another embodiment of a communication system in accordance with the present invention;

FIG. 18B is a logic diagram of another example of a method of updating an acquired augmenting asset bundle in accordance with the present invention;

FIG. 19A is a schematic block diagram of another embodiment of a communication system in accordance with the present invention;

FIG. 19B is a logic diagram of an example of a method of enhancing payments of a financial system in accordance with the present invention;

FIG. 20A is a schematic block diagram of another embodiment of a communication system in accordance with the present invention;

FIG. 20B is a logic diagram of another example of a method of acquiring augmenting assets in accordance with the present invention;

FIG. 21A is a schematic block diagram of another embodiment of a communication system in accordance with the present invention;

FIG. 21B is a logic diagram of an example of a method of funding a financial system in accordance with the present invention;

FIG. 22A is a schematic block diagram of another embodiment of a communication system in accordance with the present invention;

FIG. 22B is a logic diagram of an example of a method of enhancing performance of a plurality of financial systems in accordance with the present invention;

FIG. 23A is a schematic block diagram of another embodiment of a communication system in accordance with the present invention;

FIG. 23B is a logic diagram of an example of a method of matching augmenting assets to payment commitments in accordance with the present invention;

FIG. 24A is a schematic block diagram of another embodiment of a communication system in accordance with the present invention;

FIG. 24B is a logic diagram of an example of a method of trading assets in accordance with the present invention;

FIGS. 25A-25E are schematic block diagrams of another embodiment of a communication system illustrating an embodiment of a method for servicing a plurality of rived longevity-contingent instruments within a computing system in accordance with the present invention;

FIGS. 26A-26E are schematic block diagrams of another embodiment of a communication system illustrating an embodiment of a method for riving longevity-contingent instruments within a computing system in accordance with the present invention; and

FIGS. 27A-27E are schematic block diagrams of another embodiment of a communication system illustrating another embodiment of a method for riving longevity-contingent instruments within a computing system in accordance with the present invention.

### DETAILED DESCRIPTION OF THE INVENTION

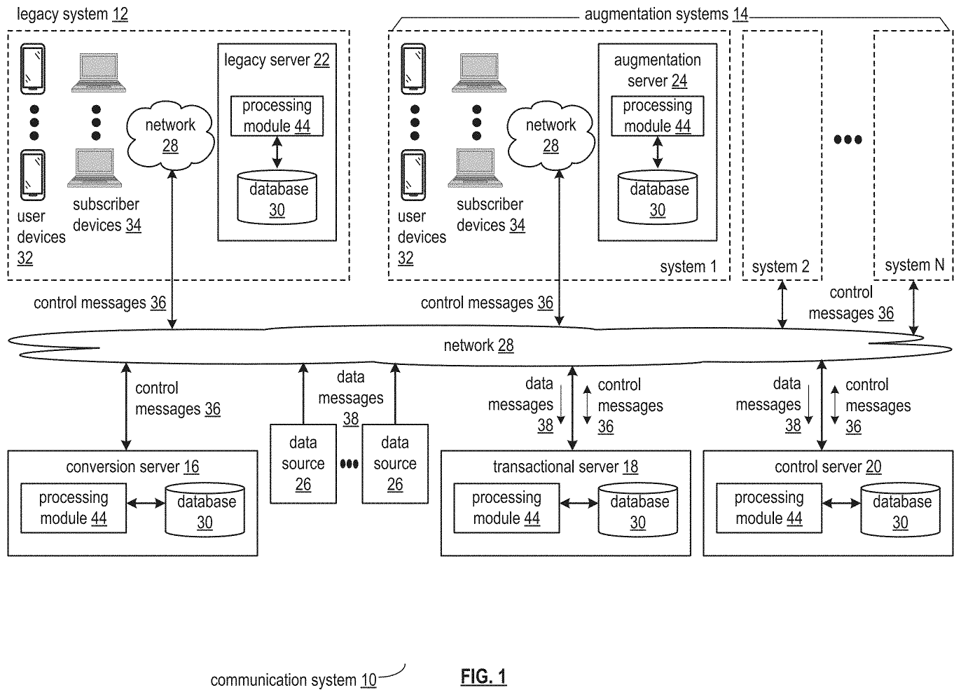

FIG. 1 is a schematic block diagram of an embodiment of a communication system 10 that includes a legacy system 12, a plurality of N augmentation systems 14, a conversion server 16, a transactional server 18, a control server 20, one or more data sources 26, and a network 28. Alternatively, the communication system 10 may include any number of legacy systems 12 and any number of servers 16-20.

The legacy system 12 includes a plurality of user devices 32, a plurality of subscriber devices 34, a portion of the network 28, and a legacy server 22. Each user device 32 may be implemented utilizing one or more portable communication devices. Examples of portable communication devices include a smart phone, a basic cell phone, a Wi-Fi communication device, a satellite phone, and/or any other device that includes a computing core (e.g., providing processing module functionality), one or more wireless modems, sensors, and one or more user interfaces, and is capable of operating in a portable mode untethered from a fixed and/or wired network. For example, a particular user device 32 is implemented utilizing the smart phone, where the smart phone is utilized by a user associated with the legacy system 12. At least some of the user devices 32 are capable to communicate data encoded as wireless communication signals and/or wireless location signals with the portion of the network 28 associated with the legacy system 12 and/or directly or indirectly to other user devices 32 and/or to at least some of the user devices 34.

Each subscriber device 34 may be implemented utilizing one or more computing devices. Examples of portable computing devices includes a laptop computer, a tablet computer, a handheld computer, a desktop computer, a cable television set-top box, an application processor, an internet television user interface, and/or any other device that includes a computing core a (e.g., providing the processing module functionality), one or more modems, sensors, and one or more user interfaces. For example, a particular user subscriber device 34 is implemented utilizing the laptop computer, where the laptop computer is utilized by a subscriber associated with the legacy system 12. The subscriber devices 34 are capable to communicate data that is encoded into wireless and/or wired communication signals via the portion of the network 28 associated with the legacy system 12 and/or directly or indirectly to other subscriber devices 34 and/or to at least some of the user devices 32.

The components of the communication system 10 are coupled via the network 28, which may include one or more of wireless and/or wireline communications networks, one or more wireless location networks, one or more private communications systems, a public Internet system, one or more local area networks (LAN), and one or more wide area networks (WAN). For example, the network 28 is implemented utilizing the Internet to provide connectivity between the legacy system 12, the plurality of augmentation systems 14, the one or more data source 26, and the servers 16-20. The wireless location networks communicate wireless location signals with the user devices 32. Each wireless location network may be implemented utilizing one or more of a portion of a global positioning satellite (GPS) satellite constellation, a portion of a private location service, a wireless local area network (WLAN) access point, a Bluetooth (BT) beacon and/or communication unit, and a radiofrequency identifier (RFID) tag and/or transceiver. Each wireless location network generates and transmits the wireless location signals in accordance with one or more wireless location industry standards (e.g., including synchronize timing information (i.e., GPS), and a geographic reference identifier (ID) (i.e., a beacon ID, a MAC address, an access point ID such as a wireless local area network SSID)).

The wireless communication networks of the network 28 include one or more of a public wireless communication network and a private wireless communication network and may operate in accordance with one or more wireless industry standards including 5G, 4G, universal mobile telecommunications system (UMTS), global system for mobile communications (GSM), long term evolution (LTE), wideband code division multiplexing (WCDMA), and IEEE 802.11. For example, a first user device 32 communicates data encoded as wireless communication signals with a 4G public wireless communication network of the network 28 and a second user device 32 communicates data encoded as wireless communication signals with a Wi-Fi wireless communication network of the network 28.

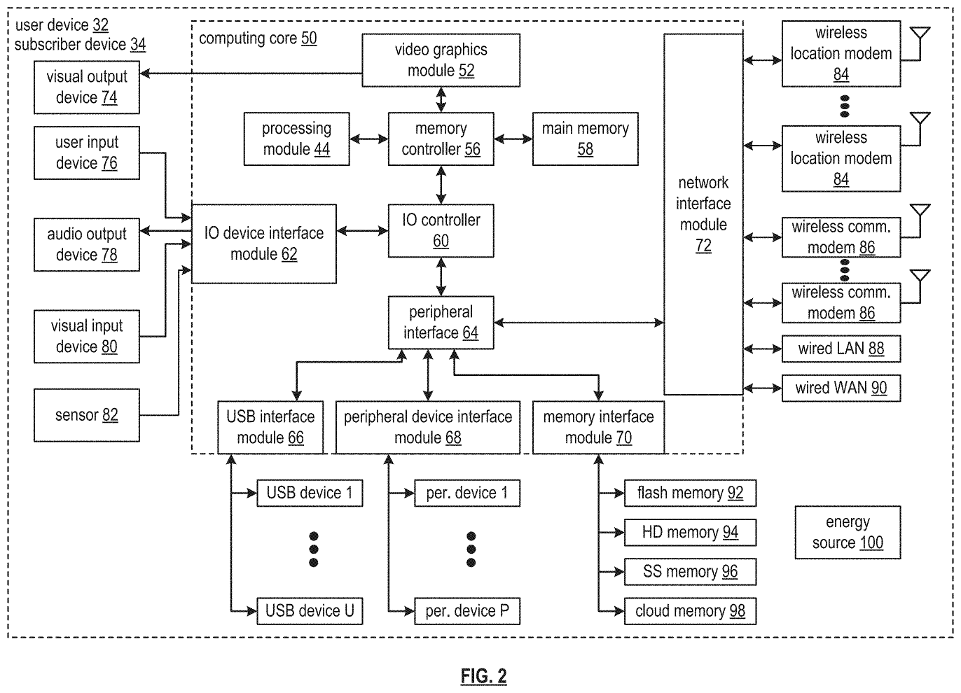

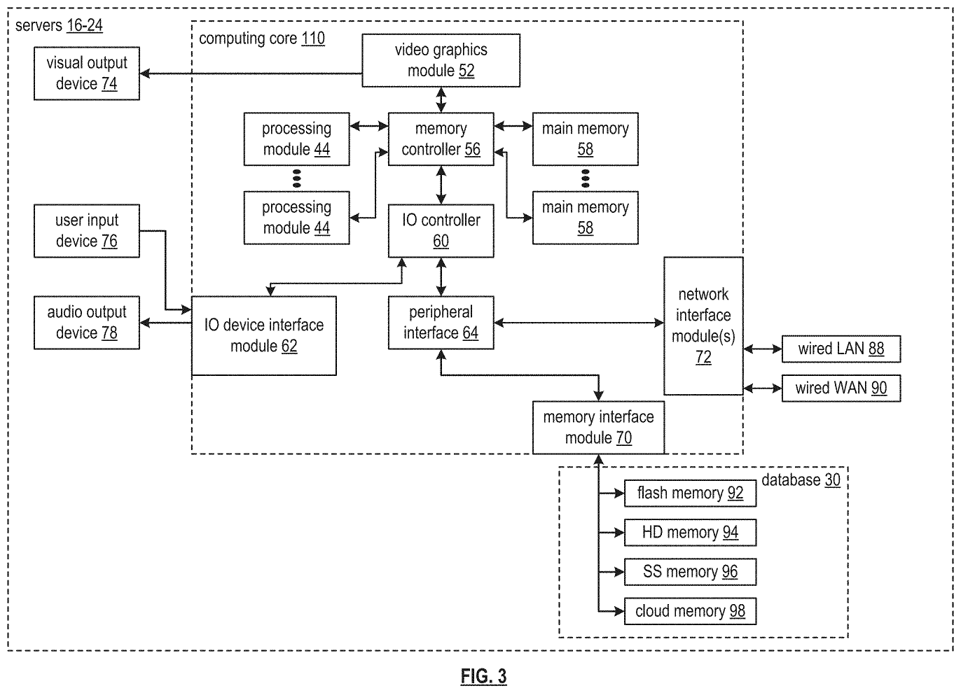

The legacy server 22 includes at least one processing module 44 and at least one database 30. The processing module 44 processes control messages 36 and data messages 38 via the network 28 with one or more of the user devices 32, the subscriber devices 34, the augmentation systems 14, the data sources 26, the conversion server 16, a transactional server 18, and the control server 20. The processing module 44 further stores and retrieves data in the database 30. The processing module 44 is discussed in greater detail with respect to FIGS. 2-3 and the database 30 is discussed in greater detail with reference to FIG. 3.

Each augmentation system 14 includes another plurality of user devices 32, another plurality of subscriber devices 34, another portion of the network 28, and an augmentation server 24. The augmentation server 24 includes another processing module 44 and another database 30. Each of the conversion server 16, the transactional server 18, and the control server 20 includes another processing module 44 and another database 30.

Each data source 26 may be implemented utilizing one or more of a server, a subscription service, a website data feed, or any other portal to data messages 38 that provide utility for operation of the communication system 10. Further examples of the data source 26 includes one or more of a financial market server, a census server, a government record server, another transactional server, another control server, another conversion server, another legacy server, a weather service, a screen scraping algorithm, a website, another database, a schedule server, a live traffic information feed, an information server, a service provider, and a data aggregator. The data messages 38 includes one or more of live financial market information, historical financial market information, weather information, a user daily activity schedule (e.g., a school schedule, a work schedule, a delivery schedule, a public transportation schedule), real-time traffic conditions, a road construction schedule, a community event schedule, address of residence information, user lifestyle information (e.g., smoker, non-smoker, physical activities, etc.), user death records, mortality tables, and other information associated with a user.

In general, and with respect to the asset reconfiguration and reassignment within the communication system 10, the communication system 10 supports three primary functions. The three primary functions include: 1) determining desired financial attributes of a financial system (e.g., supported by an underperforming legacy asset base), 2) facilitating acquisition of an augmenting asset bundle to enhance the financial system (e.g., enhancing and/or replacing the legacy asset base, and 3) facilitating the enhancement of the financial system utilizing the augmenting asset bundle such that the financial system substantially achieves the desired financial attributes. The communication system 10 may perform one or more of the three primary functions to provide the asset reconfiguration and reassignment.

The financial system is associated with the legacy system 12 where a plurality of users of the user devices 32 and the subscriber devices 34 are investors/beneficiaries of the legacy asset base supporting the financial system. The plurality of users may include thousands, hundreds of thousands, or even millions of users. The financial system includes any system to derive value for the plurality of users (e.g., balance sheet value and/or cash flow value) from the legacy asset base. Examples of the financial system includes a money market, a bond fund, a hedge fund, a pension system, and a stock fund. The desired financial attributes include one or more of present and future values of the legacy asset base, cash flows enabled by the legacy asset base, ongoing costs associated with the financial system, and return on investment levels for the legacy asset base. The legacy asset base may include thousands, hundreds of thousands, or even millions of individual assets, where assets may include tangible hard assets (e.g., property title, precious metals, commodities, etc.) and monetary assets (e.g., bonds, stocks, life insurance policies,

The augmenting asset bundle includes a bundle of selected assets acquired from one or more of the augmentation systems 14, where candidate assets associated with the augmentation systems 14 includes thousands, hundreds of thousands, and even millions of assets. The assets are selected such that when combined or replacing assets of the legacy assets, the desired financial attributes of the financial system can substantially be reached. The facilitating of the enhancement of the financial system utilizing the augmenting asset bundle manipulates (e.g., splits, un-bundles, transforms, re-bundles, retitles, etc.) the selected assets for combination with or the replacement of assets of the legacy asset base.

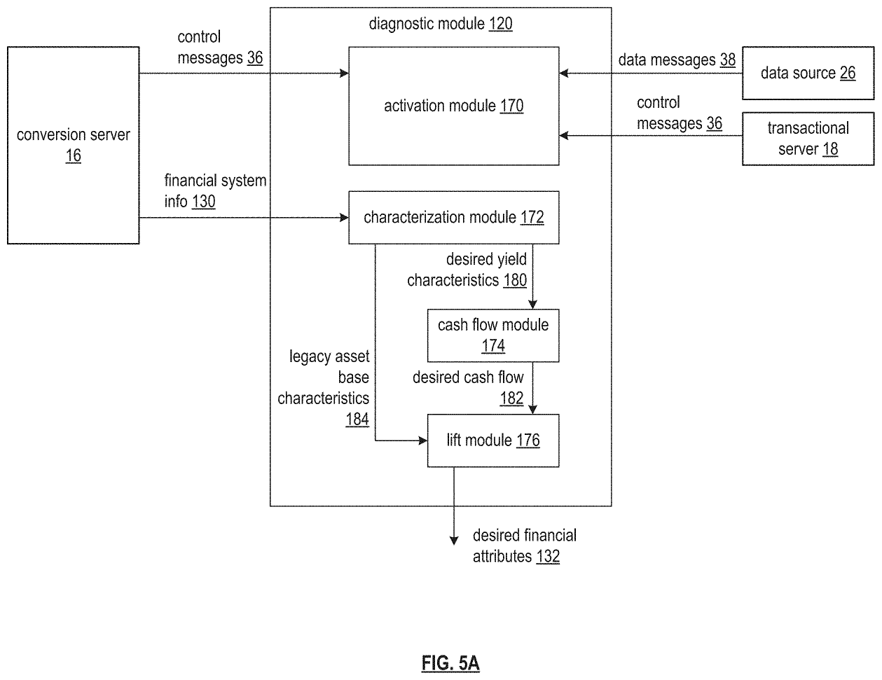

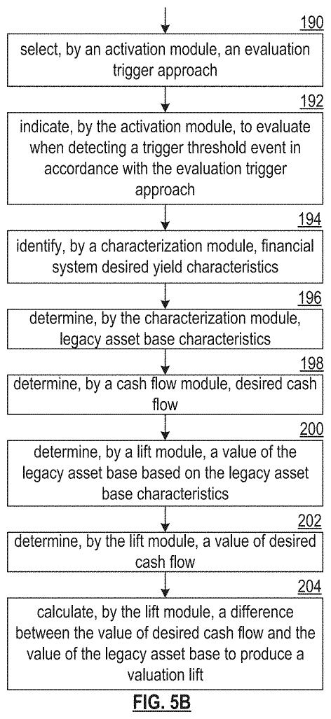

The first primary function includes the communication system 10 determining desired financial attributes of a financial system. In an example of operation where the financial system of the legacy system 12 is a pension system for over 100,000 pensioners, the legacy asset base includes assets that are a combination of cash and bonds, and the augmentation systems 14 lists millions of available life insurance policies, the processing module 44 of the control server 20 determines to evaluate the financial system. For example, the control server 20 receives, via the network 28, a control message 36 from the conversion server 16, where the control message 36 includes a request to address underperformance of the legacy asset base associated with the legacy system 12. Having determined to evaluate the financial system, the control server 20 characterizes the financial system to produce a desired cash flow and desired valuation improvement or left for the legacy asset base. For example, the control server 20 receives, via the network 28, another control message 36 from the legacy server 22 that includes information associated with the financial system, and evaluates the information associated with the financial system to determine the desired cash flow and desired valuation lift. The first primary function is discussed in greater detail with reference to FIGS. 5A-5B.

The second primary function includes the communication system 10 facilitating acquisition of an augmenting asset bundle to enhance the financial system. In an example of operation, the processing module 44 of the control server 20 accesses augmenting asset information to extract candidate asset characteristics and down selects candidate assets that compare favorably to augmenting asset preferences. The candidate asset characteristics includes one or more of asset identifier (ID), asset type (e.g., stock, bond, life insurance policy, tangible asset), estimated fair market value (FMV) of the asset, purchase price of the asset, a risk level associated with the asset, a risk level associated with the particular augmentation system tied to the asset, associated liabilities (e.g., premium payments), associated payouts (e.g., a death benefit of an insurance policy), estimated payout timing (e.g., estimated year of a life insurance death benefit payout), an estimated return on investment (ROI) level, and demographics of entities associated with the asset (e.g., age and other characteristics of an insured person associated with an insurance policy). The augmenting asset preferences includes one or more of a maximum desired risk level associated with the asset, a maximum desired risk level associated with the augmentation system tied to the asset, a maximum liability level, a minimum payout level, a minimum ROI level, and one or more preferred demographics of the entities associated with the asset. For example, the control server 20 receives control messages 36 from one or more of the augmentation servers 24, where the control messages 36 includes the candidate asset characteristics, and receives further control messages 36 from the conversion server 16, where the further control messages 36 includes the augmenting asset preferences.

Having obtained the candidate asset characteristics and the augmenting asset preferences, the control server 20 searches through available assets of the one or more augmentation systems 14 to down select the candidate assets that compare favorably to the augmenting asset preferences. For example, the control server 20 exchanges control messages 36 with the augmentation server of each of the one or more augmentation systems 14 to identify each available asset, compares the asset characteristics of the available asset to the augmenting asset preferences, and identify assets where the comparison is favorable (e.g., estimated ROI greater than minimum desired ROI, estimated risk level lower than maximum desired risk level, etc.) to produce the down selected candidate assets.

Having identified the down selected candidate assets, the control server 20 determines a financial contribution of each of the down selected candidate assets. For example, the control server 20 estimates a balance sheet contribution (e.g., a portion of the desired lift) and a cash flow contribution (e.g., a portion of the desired cash flow) for each down selected candidate asset based on the candidate asset characteristics. The control server 20 may produce the estimates based on the down selected candidate assets in an un-altered form and may produce further estimates based on altered forms of the down selected candidate assets, where each of the altered down selected candidate assets are reconfigured. The reconfiguring of a plurality of assets (e.g., selected candidate assets) includes the deconstruction of each of the assets into deconstructed asset elements of two or more element types in accordance with a deconstruction approach and re-bundling pluralities of deconstructed asset elements into two or more new asset bundles in accordance with a re-bundling approach to substantially satisfied the desired cash flow and desired valuation lift of the financial system, where each new asset bundle is generally titled to a different entity. For instance, the control server 20 utilizes a default deconstruction approach and default re-bundling approach to produce financial contributions of the down selected candidate assets when reconfigured (e.g., deconstructed and re-bundled in accordance with the default deconstruction approach and default re-bundling approach).

Having determined the financial contributions of each of the down selected candidate assets, the control server 20 selects assets from the down selected candidate assets to produce the augmenting asset bundle. The selecting includes choosing an asset selection approach to make the selections and completing the selecting utilizing the identified selection approach. The selection approaches include one or more of selecting assets that individually produce a highest level of ROI, selecting assets that produce a highest level of cash flow, selecting assets that produce a highest level of lift, selecting assets associated with highest levels of favorable financial contributions weighted by risk (e.g., asset risk, augmenting system risk, and transactional server entity risk), a random selection approach, and any other approach to optimize selection of the assets when considering utilization of deconstructed elements of the assets. The choosing of the asset selection approach may be based on one or more of a predetermination, a request, a correlation of historically utilized selection approaches and financial results, and a weighting factor that considers multiple desired outcomes.

Having chosen the asset selection approach, the control server 20 utilizes the asset selection approach to select assets from the down selected candidate assets based on the financial contributions to produce the augmenting asset bundle revealing characteristics of the selected assets (e.g., asset ID, asset type, etc.). For example, the control server 20 exchanges further control messages 36 with the one or more augmentation servers 24 to complete acquisition of the selected assets of the augmenting asset bundle based on the financial contributions of the selected assets.

The third primary function includes the communication system 10 facilitating the enhancement of the financial system utilizing the augmenting asset bundle such that the financial system substantially achieves the desired financial attributes. In an example of operation, the control server 20 selects a server to perform the reconfiguring of the acquired assets. The selection may be based on one or more of a predetermination, a request, and historical reconfiguring results. For example, the control server 20 selects the conversion server 16 to perform the reconfiguring of the acquired assets

Having selected the conversion server 16 to perform the reconfiguring of the acquired assets, the control server 20 facilitates the reconfiguring of the assets of the augmenting asset bundle. The facilitating includes selecting the deconstruction approach, selecting the re-bundling approach, and initiating the reconfiguring utilizing the selected approaches. The selecting may be based on one or more of a predetermination, a request, information extracted from data messages 38 of one or more of the data sources 26 (e.g., current market conditions), and historical financial results based on various approaches. The initiating of the reconfiguring includes performing the reconfiguring by the control server 20 and/or issuing a control message 36 to the conversion server 16, where the control message 36 includes a request to perform the reconfiguring of the assets of the augmenting asset bundle in accordance with the selected deconstruction approach and the selected re-bundling approach. The control message 36 may further include the characteristics of the selected assets of the augmenting asset bundle. For example, the conversion server 16 deconstructs each asset of the augmenting asset bundle in accordance with the deconstruction approach to produce two or more deconstructed asset elements (e.g., of two or more element types) and re-bundles pluralities of the deconstructed asset elements in accordance with the re-bundling approach to produce the two or more asset bundles.

Having facilitated the reconfiguring of the assets, the control server 20 facilitates the reassignment of the reconfigured assets where the two or more asset bundles are to be titled to two or more entities of the communication system 10 to substantially satisfied the desired cash flow and desired valuation lift of the financial system. The facilitating includes issuing titling information to the conversion server 16 such that the conversion server 16 titles the two or more asset bundles in accordance with the titling information. Having received the titling information, the conversion server 16 produces two asset bundles and issues the titling information via a control message 36 to the legacy server 22 to associate a first asset bundle with the legacy system 12 and issues the titling information via another control message 36 to the transactional server 18 to associate a second asset bundle with the transactional server 18.

Having facilitated the titling of the two or more asset bundles, the control server 20 identifies the transactional server 18 to facilitate subsequent financial transactions utilizing the new asset bundles produced from the re-bundling of the deconstructed elements of the acquired assets. For example, the control server 20 issues a control message 36, via the network 28, to the transactional server 18, where the control message 36 includes subsequent financial transaction information (e.g., how to utilize the new asset bundles). For instance, the transactional server 18 exchanges control messages 36 with an augmentation server 24 associated with a particular asset to settle a periodic liability (e.g., the transactional server 18 facilitates a liability payment to the augmentation server 24 such as a life insurance premium payment) and to collect a cash flow (e.g., a life insurance policy death benefit payment). As another instance, the transactional server 18 partitions the cash flow from the augmentation server 24 into a first portion and a second portion, where the first portion is associated with the legacy server 22 (e.g., a portion of the life insurance policy death benefit payment flows to the pension system associated with the financial system of the legacy server 22) and the second portion is associated with the transactional server 18 (e.g., a holdback if any). Such financial transactions may include one or more of electronic money wire transfers and blockchain encoded secure funds transfer.

In various embodiments, a non-transitory computer readable storage medium includes at least one memory section that stores operational instructions that, when executed by one or more processing modules of one or more computing devices that each include a processor and a memory, causes each processing module to perform operations including the above-described asset reconfiguration and reassignment within the communication system.

FIG. 2 is a schematic block diagram of an embodiment of the user device 32 and the subscriber device 34 of the communication system 10 that includes a computing core 50, a visual output device 74 (e.g., a display screen, a light-emitting diode), a user input device 76 (e.g., keypad, keyboard, touchscreen, voice to text, etc.), an audio output device 78 (e.g., a speaker, a transducer, a motor), a visual input device 80 (e.g., a photocell, a camera), a sensor 82 (e.g., an accelerometer, a velocity detector, electronic compass, a motion detector, electronic gyroscope, a temperature device, a pressure device, an altitude device, a humidity detector, a moisture detector, an image recognition detector, a biometric reader, an infrared detector, a radar detector, an ultrasonic detector, a proximity detector, a magnetic field detector, a biological material detector, a radiation detector, a mass and/or weight detector, a density detector, a chemical detector, a gas detector, a smoke detector, a fluid flow volume detector, a DNA detector, a wind speed detector, a wind direction detector, a medical condition detector, a human activity detector, a motion recognition detector, and a battery level detector), one or more universal serial bus (USB) devices 1-U, one or more peripheral devices, one or more memory devices (e.g., a local memory, a flash memory device 92, one or more hard drives 94, one or more solid state (SS) memory devices 96, and/or cloud memory 98), an energy source 100 (e.g., a battery, a generator, a solar cell, and a fuel cell), one or more wireless location modems 84 (e.g., a GPS receiver, a Wi-Fi transceiver, a Bluetooth transceiver, etc.), one or more wireless communication modems 86 (e.g., 4G, 5G cellular), a wired local area network (LAN) 88, and a wired wide area network (WAN) 90

The computing core 50 includes a video graphics processing module 52, one or more processing modules 44, a memory controller 56, one or more main memories 58 (e.g., RAM), one or more input/output (I/O) device interface modules 62 (e.g., interfaces), an input/output (I/O) controller 60, a peripheral interface 64, one or more USB interface modules 66, one or more network interface modules 72, one or more memory interface modules 70, and/or one or more peripheral device interface modules 68. Each of the interface modules 62, 66, 68, 70, and 72 includes a combination of hardware (e.g., connectors, wiring, etc.) and operational instructions stored on memory (e.g., driver software) that is executed by the processing module 44 and/or a processing circuit within the interface module. Each of the interface modules couples to one or more components of the user device 32. For example, one of the TO device interface modules 62 couples to an audio output device 78. As another example, one of the memory interface modules 70 couples to flash memory 92 and another one of the memory interface modules 70 couples to cloud memory 98 (e.g., an on-line storage system and/or on-line backup system).

The main memory 58 and the one or more memory devices include a computer readable storage medium that stores operational instructions that are executed by one or more processing modules 44 of one or more computing devices (e.g., the user device 32) causing the one or more computing devices to perform functions of the communication system 10. For example, the processing module 44 retrieves the stored operational instructions from the HD memory 94 for execution.

FIG. 3 is a schematic block diagram of an embodiment of the servers 16-24 of the communication system 10 that includes a computing core 110 and elements of the user device 32 (e.g., FIG. 2), including one or more of the visual output device 74, the user input device 76, the audio output device 78, the memories 92-98 to provide the database 30 of FIG. 1, the wired LAN 88, and the wired WAN 90. The computing core 110 includes elements of the computing core 50 of FIG. 2, including the video graphics module 52, the plurality of processing modules 44, the memory controller 56, the plurality of main memories 58, the input-output controller 60, the input-output device interface module 62, the peripheral interface 64, the memory interface module 70, and the network interface modules 72.

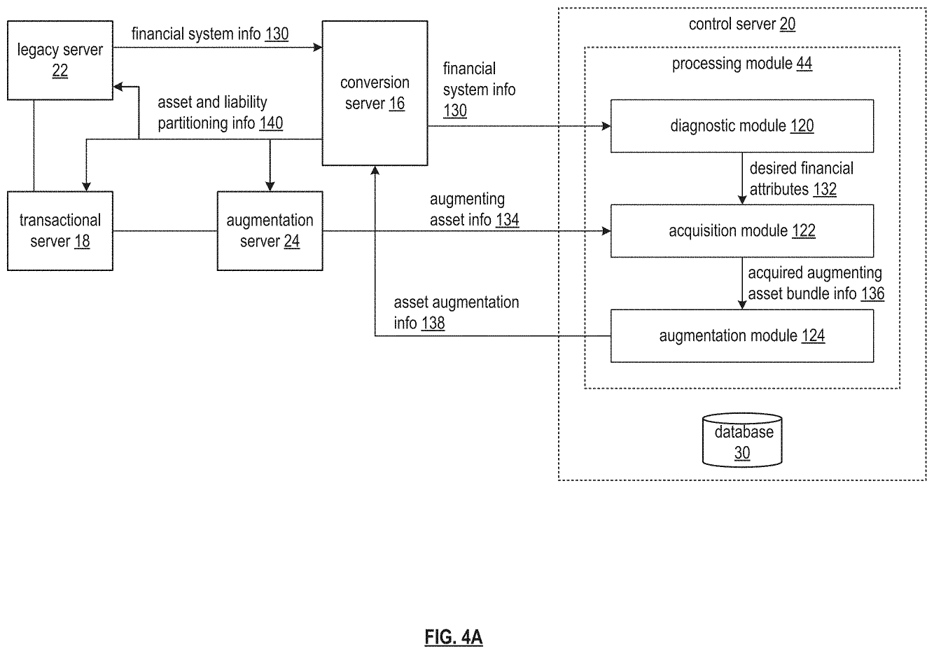

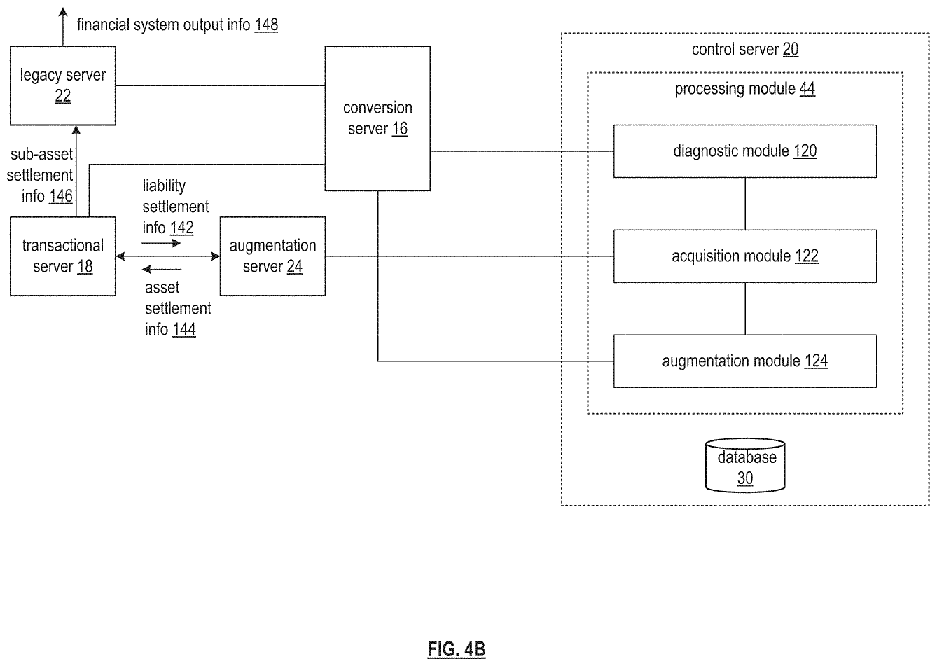

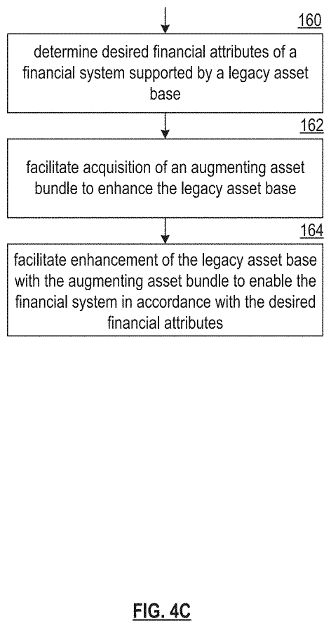

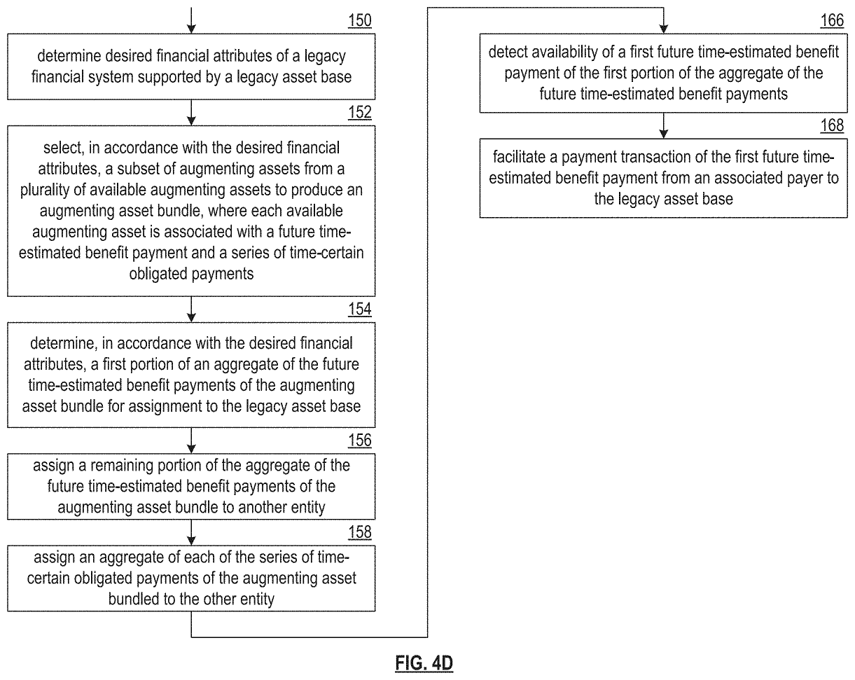

FIGS. 4A-4B are schematic block diagrams of another embodiment of a communication system that includes the legacy server 22 of FIG. 1, the conversion servers 16 of FIG. 1, the transactional server 18 of FIG. 1, the augmentation server 24 of FIG. 1, and the control server 20 of FIG. 1. The control server 20 includes the processing module 44 of FIG. 1 and the database 30 of FIG. 1. The processing module 44 includes a diagnostic module 120, an acquisition module 122, and an augmentation module 124. Each of the diagnostic module 120, the acquisition module 122, and the augmentation module 124, may be implemented utilizing a processing module. The communication system functions to facilitate asset reconfiguration and reassignment.

FIG. 4A illustrates an example of the facilitating of the asset reconfiguration and reassignment where the legacy server 22 communicates financial system information 130 to the conversion servers 16. The financial system information 130 includes one or more of yield characteristics (e.g., ROI, timing of yields) of the legacy asset base of the financial system associated with the legacy server 22, a current valuation of the legacy asset base, a risk level associated with the legacy asset base, a liability schedule (e.g., a pension liability schedule when the financial system is a pension system), and demographics associated with users of the financial system (e.g., ages, lifestyles associated with pension participants).

Having received the financial system information 130, the conversion servers 16 forwards the financial system information 130 to the diagnostic module 120. The diagnostic module 120 determines desired financial attributes 132 for the financial system supported by the legacy asset base by analyzing the financial system information 130 in accordance with historical financial system information and/or current market conditions. The desired financial attributes 132 includes one or more of a desired cash flow level and timing, and a desired valuation lift such that the valuation of the legacy asset base is corrected to a desired legacy asset value when the legacy asset base is augmented in the following step. The operation of the diagnostic module 120 is discussed in greater detail with reference to FIGS. 5A-5B.

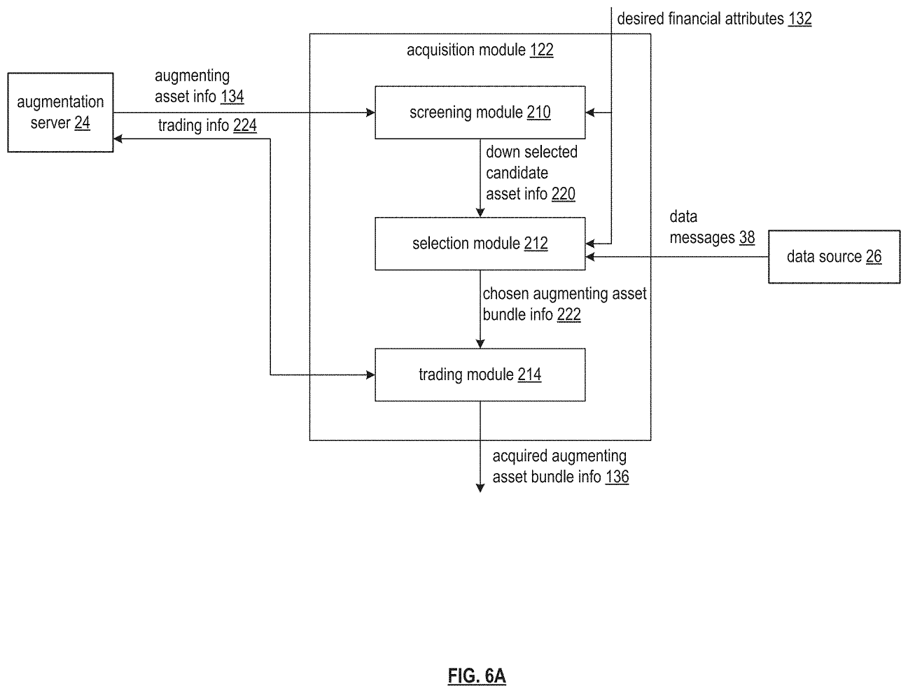

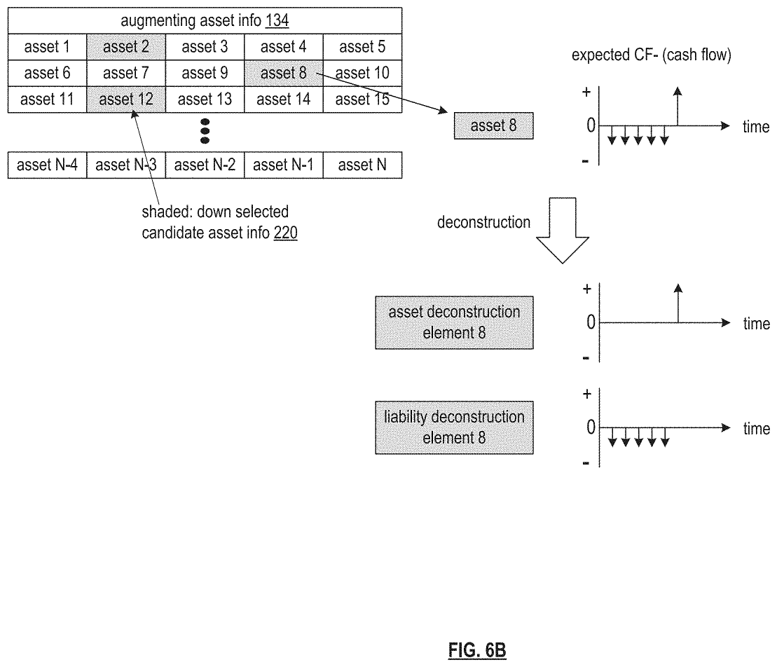

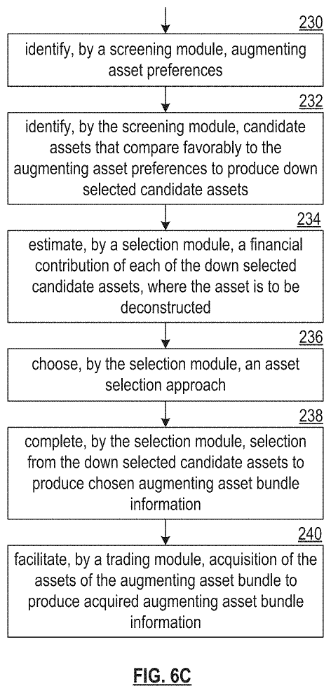

The acquisition module 122 facilitates acquisition of an augmenting asset bundle to enhance the legacy asset base such that the desired legacy asset value can be obtained while meeting the desired cash flow levels and timing. For example, the acquisition module 122 analyzes candidate asset characteristics of augmenting asset information 134 received from the augmentation server 24 to screen for candidate assets for acquisition, evaluates a financial contribution for each of the potentially acquired assets, selects a combination assets that when aggregated have a total financial contribution that compares favorably to the desired cash flow and desired valuation lift, and facilitates acquisition of the selected assets to produce acquired augmenting asset bundle information 136 (e.g., includes characteristics of the selected assets as well as identification). The operation of the acquisition module 122 is discussed in greater detail with reference to FIGS. 6A-6C.

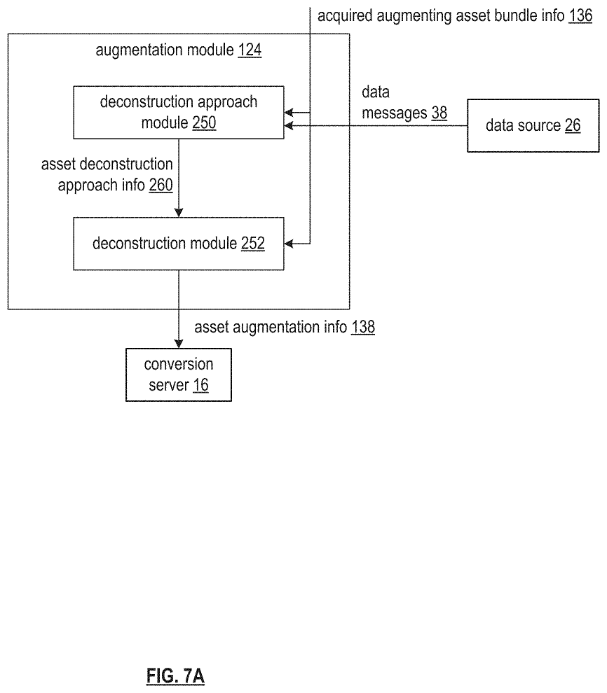

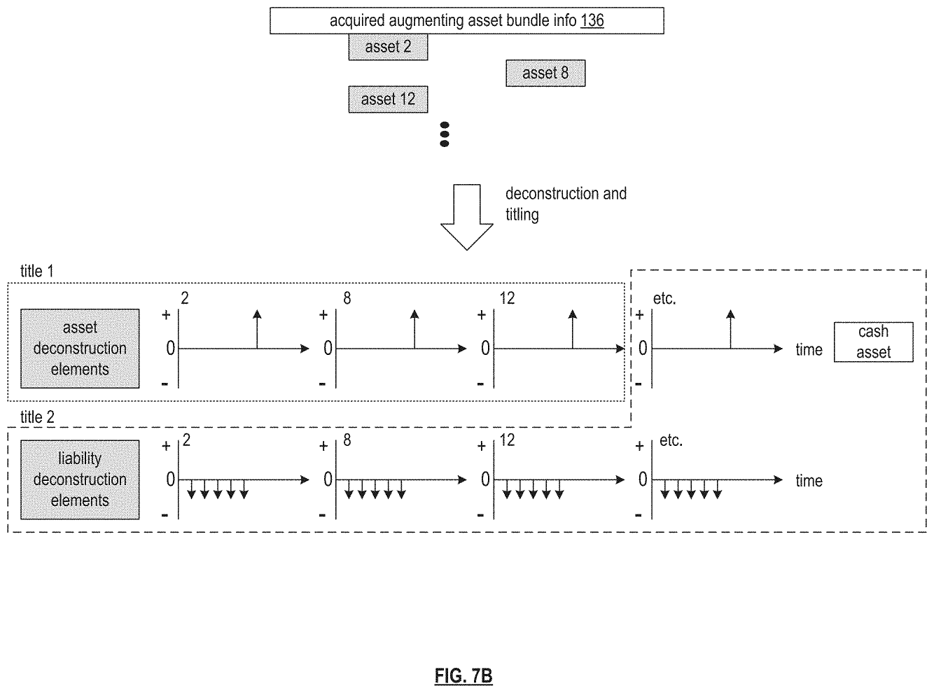

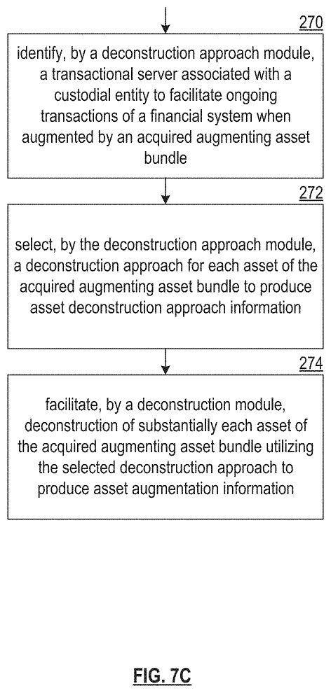

The augmentation module 124 facilitates enhancement of the legacy asset base with the augmenting asset bundle to enable the financial system in accordance with the desired financial attributes (e.g., cash flow and valuation lift). The facilitation includes the augmentation module 124 performing enhancement or the augmentation module 124 instructing another server (e.g., the conversion servers 16) to perform the enhancement. The enhancement includes selecting an asset deconstruction approach and utilizing the selected asset deconstruction approach, where each asset of the acquired augmenting asset bundle is deconstructed to produce at least two deconstructed elements and where individual elements are re-bundled into two or more groupings for titling to two or more entities of the communication system. For example, deconstructed elements are re-bundled into a first grouping that is to be titled to the legacy server 22 to replace the legacy asset base such that the new valuation and expected cash flow associated with the first grouping meets or exceeds the desired cash flow and desired valuation lift and other deconstructed elements are re-bundled into a second grouping that is to be titled to the transactional server 18. For instance, the augmentation module 124 outputs asset augmentation information 138 to the merchant server 16, where the asset augmentation information includes the selected asset deconstruction approach, and new asset titling information. Having received the asset augmentation information 138, the conversion servers 16 issues asset and liability partitioning information 140 to the legacy server 22 and to the transactional server 18, where the asset liability partitioning information 140 includes asset deconstruction results (e.g., characteristics of the deconstructed elements) and deconstructed asset element title information (e.g., which deconstructed elements are now affiliated with which entity). The operation of the augmentation module 124 is discussed in greater detail with reference to FIGS. 7A-7C.

FIG. 4B further illustrates the example of the facilitating of the asset reconfiguration and reassignment where the transactional server 18, when receiving the asset and liability partitioning information 140, issues liability settlement information 142 to the augmentation server 24 when detecting that a liability is to be resolved (e.g., making a life insurance policy premium payment in accordance with a schedule), issues further liability settlement information 142 to the augmentation server 24 when detecting that an asset settlement is to be resolved (e.g., submitting a death benefit claim for a particular life insurance policy based on detecting death of the insured), and receiving asset settlement information 144 from the augmentation server 24 to complete settlement of a particular asset (e.g., receiving a payment transaction for a death benefit related to a life insurance policy).

Having received asset settlement information 144, the transactional server 18 partitions a payment associated with the received asset settlement information 144 into two or more payment partitions, where the partitioning is in accordance with the asset and liability partitioning information 140. For example, the transactional server 18 partitions the payment into X and Y portions, where the X portion is associated with the legacy server 22 in accordance with titling information of the asset and liability partitioning information 140, where the Y portion is associated with the transactional server 18 in accordance with the titling information of the asset and liability partitioning information 140, and where X+Y=100%.

Having partitioned the payment, the transactional server 18 issues sub-asset settlement information 146 to the legacy server, where the sub-asset settlement information 146 facilitates a payment transaction (e.g., bank wire, electronic transaction, E-cash, blockchain currency) for a portion of the payment (e.g., a portion of the payment transaction for the death benefit related to the life insurance policy to be assigned to the legacy server 22). Having received the sub-asset settlement information 146, the legacy server 22 issues financial system output information 148 to include a desired cash flow in accordance with the financial system funded by a plurality of such payment transactions as communicated by the sub-asset settlement information 146. For example, the legacy server 22 facilitates payment transactions to satisfy periodic payments to pension plan participants funded by the portion of the death benefit payments, when the financial system is a pension system and the acquired assets of the augmentation server 24 include life insurance policies that have been deconstructed and re-bundled.

FIG. 4C is a logic diagram of an example of a method of enhancing a legacy asset base that includes step 160 where a processing module (e.g., of a communication system) determines desired financial attributes of a financial system supported by a legacy asset base. For example, the processing module determines to evaluate the financial system (e.g., by request, in accordance with a schedule, when a metric of the financial system is detected to be unfavorable compared to a desired value), analyzes the financial system to produce a desired cash flow level (e.g., identifies a stream of liability payments), and analyzes the financial system to produce a desired valuation lift (e.g., identifies a gap between a current valuation of the legacy asset base and a desired valuation of the legacy asset base).

The method continues at step 162 where the processing module facilitates acquisition of an augmenting asset bundle to enhance the legacy asset base. For example, the processing module identifies augmenting asset preferences (e.g., receives, performs a lookup, interprets a query response), accesses augmenting asset information from an augmenting asset entity (e.g., an augmentation server) to extract candidate asset characteristics (e.g., searches through thousands of life insurance policy records), down selects candidate assets the compare favorably to the augmenting asset preferences (e.g., a favorable quality level), determines financial contributions of each of the down selected candidate assets (e.g., when split utilizing a deconstruction approach), selects an asset selection approach (e.g., to maximize one or more of cash flow contribution and balance sheet contribution), complete selection and acquisition from the down selected candidate assets to produce the augmenting asset bundle utilizing the selected asset selection approach where an estimated financial contribution of the augmenting asset bundle compares favorably to the desired cash flow and valuation left, and summarize the augmenting asset bundle to reveal selected asset characteristics.

The method continues at step 164 where the processing module facilitates enhancement of the legacy asset base with the augmenting asset bundle to enable the financial system in accordance with the desired financial attributes. For example, the processing module identifies a custodial entity and associated custodial server (e.g., a transactional server identified in a predetermination or contest), selects a deconstruction approach for the acquired augmenting asset bundle where an estimated value of deconstructed asset elements compares favorably to one or more of the desired cash flow, the desired valuation lift, and other funding requirements (e.g., value to be generated associated with the custodial server, generates title transfer information for the deconstructed asset elements, and facilitates the construction of the acquired augmenting asset bundle utilizing the deconstruction approach to produce the deconstructed asset elements (e.g., deconstruct or request that another entity such as the custodial server perform the deconstruction by issuing a request that includes selected asset title transfer information and the selected asset deconstruction approach).

The processing module may determine the estimated value of the deconstructed asset elements by calculating the fair market or present value of a first deconstructed element (e.g., a death benefit of a life insurance policy) of the deconstructed asset as a function of: the value of a corresponding second deconstructed element (e.g., a series of premium payments associated with the life insurance policy) of the deconstructed asset, a credit rating associated with the custodial entity (e.g., likelihood of the custodial entity continuing to make life insurance premium payments to a corresponding leverage is comedy), a credit rating associated with the augmenting asset entity (e.g., likelihood that life insurance company associated with the life insurance policy will make the death benefit payment), and a life expectancy of an insured entity (e.g., a person) associated with insurance policy. The calculation of the value may further be based on market conditions where a plurality of augmenting assets are deconstructed and re-bundled by others thus influencing a general market condition for valuations and spreads due to arbitrage as such deconstructed elements pass through multiple levels of ownership and retitling.

FIG. 4D is a logic diagram of another method of enhancing a legacy asset base within a computing system and/or communication system. In particular, a method is presented for use in conjunction with one or more functions and features described in conjunction with FIGS. 1-3, 4A, 4B, 4C, and also FIG. 4D. The method includes step 150 where a processing module of one or more processing modules of one or more computing devices of the computing system determines desired financial attributes of a legacy financial system, where the legacy financial system is supported by a legacy asset base, where the legacy asset base includes a plurality of legacy assets associated with a plurality of legacy asset types, and where the plurality of legacy assets is to provide favorable support for a plurality of ongoing financial obligations in accordance with the desired financial attributes.

The determining the desired financial attributes includes one or more of establishing a desired valuation lift of the legacy asset base in accordance with a difference between a desired valuation of the legacy asset base and a current valuation of the legacy asset base when the desired valuation of the legacy asset base is greater than the current valuation of the legacy asset base, identifying, for at least one unfavorably-performing legacy asset of the plurality of legacy assets, an associated level of desired support for the plurality of ongoing financial obligations, analyzing a level of favorable support for the plurality of ongoing financial obligations to produce the desired financial attributes and interpreting an input to produce the desired financial attributes.

The method continues at step 152 where the processing module selects, in accordance with the desired financial attributes, a subset of augmenting assets from a plurality of available augmenting assets to produce an augmenting asset bundle, where each available augmenting asset is associated with a future time-estimated benefit payment and a series of time-certain obligated payments. The selecting of the subset of augmenting assets may be accomplished by a variety of approaches.

A first approach of selecting of the subset of augmenting assets includes determining, for each augmenting asset of the plurality of available augmenting assets, a valuation difference, wherein the valuation difference is a difference between a fair market value and a net present value, ranking the plurality of available augmenting assets based on the valuation difference associated with each augmenting asset to produce a rank ordered list of available augmenting assets, and selecting the subset of augmenting assets based on the rank ordered list of available augmenting assets, where financial aspects of the subset of augmenting assets compares favorably to the desired financial attributes.

The selecting of the subset of augmenting assets based on the rank ordered list further includes one or more of analyzing the rank ordered list to identify available augmenting assets associated with a greatest level of valuation difference, analyzing the rank ordered list to identify available augmenting assets associated with a maximum desired level of fair market value, analyzing the rank ordered list to identify available augmenting assets associated with a minimum desired level of net present value, selecting a number of available augmenting assets such that a sum of the fair market values of the selected available augmenting assets compares favorably to a desired valuation lift of the legacy asset base, and selecting another number of available augmenting assets such that a sum of the net present values of the selected available augmenting assets compares favorably to a desired maximum aggregate net present value.

A second approach of selecting of the subset of augmenting assets includes one or more of identifying the subset of augmenting assets associated with favorable support of a desired cash flow level for the ongoing financial obligations, identifying the subset of augmenting assets associated with a desired timing of the desired cash flow level for the ongoing financial obligations, identifying the subset of augmenting assets associated with a desired valuation of the legacy asset base, identifying the subset of augmenting assets associated with a desired minimum rate of return for the augmenting asset bundle, and identifying the subset of augmenting assets associated with a desired maximum risk level for the augmenting asset bundle.

The method continues at step 154 where the processing module determines, in accordance with the desired financial attributes, a first portion of an aggregate of the future time-estimated benefit payments of the augmenting asset bundle for assignment to the legacy asset base. The determining the first portion of the aggregate of the future time-estimated benefit payments of the augmenting asset bundle includes one or more of selecting a number of augmenting assets of the augmenting asset bundle such that a sum of fair market values of the selected augmenting assets compares favorably to a desired valuation lift of the legacy asset base, and selecting the number of augmenting assets of the augmenting asset bundle such that such that a sum of fair market values of each remaining augmenting asset of remaining augmenting assets compares favorably to a sum of an aggregate of each of the series of time-certain obligated payments associated with the augmenting asset bundle.

The method continues at step 156 where the processing module assigns a remaining portion of the aggregate of the future time-estimated benefit payments of the augmenting asset bundle to another entity. For example, the processing module facilitates titling of the remaining portion to a pension plan sponsor associated with a pension plan that is affiliated with the legacy asset base. As another example, the processing module facilitates titling of the remaining portion to a financial custodian.

The method continues at step 158 where the processing module assigns an aggregate of each of the series of time-certain obligated payments of the augmenting asset bundle to the other entity. For example, the processing module establishes a commitment from the financial custodian to fund the aggregate of each of the series of time-certain obligated payments when the financial custodian receives the remaining portion of the aggregate of the future time-estimated benefit payments, where the benefit payments and the obligated payments are similar in values.

The method continues at step 166 for the processing module detects availability of a first future time-estimated benefit payment of the first portion of the aggregate of the future time-estimated benefit payments (e.g., a life settlement payment is available). The method continues at step 168 where the processing module facilitates a payment transaction of the first future time-estimated benefit payment from an associated payer to the legacy asset base. For example, the processing module issues a payment request to a financial server of the associated payer (e.g., a life insurance company) such that payment is made from the associated payer to the legacy asset base (e.g., to a pension plan).

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers, one or more user devices) of the communication system 10, cause the one or more computing devices to perform any or all of the method steps described above.

FIG. 5A is a schematic block diagram of an embodiment of a diagnostic module that includes an activation module 170, a characterization module 172, a cash flow module 174, and a lift module 176, where the diagnostic module 120 communicates with one or more of the conversion server 16 of FIG. 1, the data source 26 of FIG. 1, and the transactional server 18 of FIG. 1. Each of the activation module 170, the characterization module 172, the cash flow module 174, and the lift module 176, may be implemented utilizing a processing module.

In an example of operation of the diagnostic module, the activation module 170 selects a financial system valuation trigger approach from a plurality of evaluation trigger approaches. The plurality of evaluation trigger approaches includes one or more of a legacy asset base value below a low threshold level, a desired cash flow level above a high threshold level, a desired valuation lift above a high threshold level, and evaluation time frame has expired, receiving a request, and detecting that an external factor level is beyond a normal threshold level. The selecting includes one or more of utilizing a predetermination, interpreting a request, and interpreting a received alert from the server or data source (e.g., receive a control message 36 and/or data message 38 from one or more of the conversion server 16, the data source 26, and the transactional server 18).

Having selected the evaluation trigger approach, the activation module 170 indicates to evaluate a financial system associated with the conversion server 16 when detecting a trigger threshold event in accordance with the evaluation trigger approach (e.g., where the conversion server 16 is affiliated with a sponsor that is associated with the financial system of a legacy server).

When evaluating the financial system, the characterization module 172 identifies financial system desired yield characteristics 180. The financial system desired yield characteristics includes one or more of an ROI level, a dividend level or similar payout level, and payout timing, (e.g., for payouts for a pension liability schedule, pension participant demographics, pension participant mortality information, pension participant lifestyle information). The identifying includes one or more of receiving, performing a lookup, interpreting a query response, interpreting financial system information 130 received from the conversion server, and generating an estimate based on a last stored financial system information.

The characterization module 172 determines legacy asset base characteristics 184 based on the financial system information 130. The legacy asset base characteristics include one or more of, for each asset type, a face amount, a fair market value, a net present value, associated timing, and a risk level. The determining includes one or more of interpreting a query response, performing a lookup, interpreting a data message 38 from the data source 26, and interpreting the financial system information 130 from the conversion server 16.

Having generated the desired yield characteristics 180 and the legacy asset base characteristics 184, the characterization module 172 sends the desired yield characteristics 180 to the cash flow module 174 and sends the legacy asset base characteristics 184 to the lift module 176. The cash flow module 174 determines a desired cash flow 182 based on the financial system desired yield characteristics 180 (e.g., cash flow to substantially match desired pension payouts when the financial system is a pension system). The lift module 176 determines a value of the legacy asset base based on the legacy asset base characteristics 184. The determining includes one or more of calculating utilizing at least one of fair market value approach, a net present value approach, and interpreting a query response (e.g., issue a value request to the transactional server 18, where the transactional server 18 utilizes market values to generate an estimate). The lift module determines a value of the desired cash flow based on the desired cash flow 182. The determining includes one or more of calculating utilizing at least one of a fire market value approach, a net present value approach, and interpreting a query response (e.g., issue a value request to the conversion server 16 and receive the query response). The lift module calculates a difference between the value of the desired cash flow and the value of the legacy asset base to produce a desired valuation lift. The lift module outputs desired financial attributes 132 to include the value of the desired cash flow and the desired valuation lift.

FIG. 5B is a logic diagram of an example of a method of diagnosing a legacy asset base which includes step 190 where an activation module selects an evaluation trigger approach. The selecting may be based on one or more of utilizing a predetermination, interpreting a request, and receiving an alert. The method continues at step 192 where the activation module indicates to evaluate when detecting a trigger threshold event in accordance with the evaluation trigger approach. For example, the activation module detects a favorable comparison of an input to a corresponding condition of the evaluation trigger approach and indicates to evaluate.

The method continues at step 194 where a characterization module identifies financial system desired yield characteristics. The identifying includes one or more of interpreting a query response, performing a lookup, and receiving financial system information that includes the financial system desired yield characteristics. The method continues at step 196 where the characterization module determines legacy asset base characteristics. The determining includes one or more of interpreting a message in response to a query, performing a lookup, and interpreting a data message from a data source.

The method continues at step 198 where a cash flow module determines desired cash flow. The determining may be based on calculating the desired cash flow based on the desired yield characteristics. The method continues at step 200 where a lift module determines a value of the legacy asset base based on the legacy asset base characteristics. The determining includes utilizing at least one of fair market value approach, a net present value approach, and interpreting market and/or historical conditions. The method continues at step 202 where the lift module determines a value of desired cash flow. The determining includes utilizing at least one of the fair market value approach, the net present value approach, and interpreting market and/or historical conditions. The method continues at step 204 where the lift module calculates a difference (e.g. subtract) between the value of desired cash flow and the value of the legacy asset base to produce a valuation lift.

FIG. 6A is a schematic block diagram of an embodiment of an acquisition module that includes a screening module 210, a selection module 212, and a trading module 214, where the acquisition module 122 communicates with one or more of the augmentation server 24 of FIG. 1, and the data source 26 of FIG. 1. Each of the screening module 210, the selection module 212, and the trading module 214, may be implemented utilizing a processing module.

In an example of operation of the acquisition module 122, a screening module 210 identifies augmenting asset preferences by interpreting augmenting asset information 134 from the augmentation server 24 and the desired financial attributes 132. The augmenting asset preferences includes one or more of a risk level of an entity associated with the augmentation server, a credit rating of the entity, the validity of available assets (e.g., insurable interest, title chain), and an estimated asset ROI.

Having identified the augmenting asset preferences, the screen module 210 identifies candidate assets that are associated with attributes that compare favorably to the augmenting asset preferences to produce down selected candidate asset information 220. For example, the selection module 212 interprets the augmenting asset information 134 to identify characteristics of the candidate assets, compares the characteristics to the asset preferences, and indicates the down selection (e.g., identifiers of selected assets) when the attributes of the candidate asset compares favorably to the asset preferences.

The selection module 212 estimates a financial contribution of each of the down selected candidate assets, where the estimation is based on valuation after the asset has been deconstructed. The estimating may be based on one or more of purchase price from the augmentation server 24, fair market valuation (e.g., based on a data message 38 from the data source 26 with regards to market pricing), asset and liability components of the asset, and matching to the desired financial attributes over a time frame of cash flow (e.g., of death benefit payments when the asset is a life insurance policy).

Having produced the estimated financial contributions, the selection module 212 chooses an asset selection approach. The asset selection approaches include 1) a passive approach where an estimated value after deconstructing each asset into a positive asset and a liability, where the positive asset is associated with the financial system of the legacy asset based, 2) an active approach where the desired financial attributes are matched to the estimated value after deconstructing each asset to produce positive assets associated with the financial system, and 3) an iterative approach where each asset is selected one by one to optimize resulting assets of the financial system in accordance with the desired financial attributes. The choosing may include one or more of utilizing a predetermination, interpreting a request, and interpreting historical selection data with regards to selection approach and financial results.

Having chosen the asset selection approach, the selection module 212 completes the selection from the down selected candidate assets to produce chosen augmenting asset bundle information 222 (e.g., identified assets), where the selection is made in accordance with the chosen asset selection approach, and where estimated financial contributions of the augmenting asset bundle compares favorably to the desired cash flow and desired valuation lift of the desired financial attributes 132. The trading module facilitates acquisition (e.g., purchase) of the assets of the augmenting asset bundle to produce acquired augmenting asset bundle information 136 that includes selected asset characteristics. The selected asset characteristics include one or more of identification of each asset, title information, expected financial contribution, risk levels, identity of the entity associated with the augmentation server of the ad set, and the suggested deconstruction approach. The facilitating includes exchanging trading information 224 with the augmentation server 24 to confirm purchase pricing, pass-through of funding in accordance with the purchase pricing, and confirming receipt and title of the purchased assets. Such a financial transaction may be carried out by utilizing one or more electronic financial transaction approaches including electronic cash, wire transfer, electronic funds transfer, and a blockchain approach.

FIG. 6B is a diagram of an example of acquiring augmenting assets where values of a plurality of assets are considered based on their characteristics and an asset deconstruction approach. The plurality of assets are associated with augmenting asset information 134. For example, a plurality of N augmenting assets, that are available for purchase (e.g., from an insurance company, from a hedge fund entity, from any other entity), each are associated with augmenting asset information. For example, an asset 8 represents a life insurance policy that is associated with a series of premium payments to maintain the life insurance policy and a one-time death benefit payment upon death of a person associated with a life insurance policy. A risk level associated with fulfilling continued payment of the premium payments may be higher when responsibility for making the premium payments is associated with the person associated with a life insurance policy as compared to when the responsibility for making the premium payments associated with a financial market entity known for making commitments (e.g., in this case committing to make the premium payments). A risk level associated with receiving the one-time death benefit payment may be higher when the associated life insurance company has an unfavorable death benefit payment history as compared to other life insurance companies or when the risk level of making the premium payments is higher than average.

The valuation of the asset based on the deconstruction approach involves deconstructing each asset into two or more deconstructed elements which may henceforth be alternatively referred to as deconstructives. For example, the asset 8 is deconstructed into an asset deconstruction element 8 and a liability deconstruction element 8, where the asset deconstruction element 8 is associated with the death benefit payment in the life insurance policy example and the liability deconstruction element 8 is associated with the plurality of premium payments. The selection of candidate assets to produce down selected candidate asset information 220 includes identifying assets associated with asset deconstruction elements with favorable payouts and payout timing within a desired risk level (e.g., relative to other assets, relative to minimum levels as compared to historical asset element information), and liability deconstruction elements associated with favorable premium payments and premium payment timing when under custodial care of an entity with a favorable risk level (e.g., relative to other liabilities, relative to historical liability element information).

FIG. 6C is a logic diagram of an example of a method acquiring augmenting assets that includes step 230 where a screening module identifies augmenting asset preferences. For example, the screening module interprets augmenting asset information and desired financial attributes to produce the augmenting asset preferences. The method continues at step 232 where the screening module identifies candidate assets that compare favorably to the augmenting asset preferences to produce down selected candidate assets. For example, the screen module interprets the augmenting asset information to identify characteristics of the candidate assets, compares the candidate assets to the asset preferences, and indicates down selection when the candidate asset compares favorably to the asset preferences.

The method continues at step 234 where a selection module estimates a financial contribution of each of the down selected candidate assets, where the asset is to be deconstructed. For example, the selection module analyzes deconstruction of the candidate asset into an inter-related asset and a liability, further based on one or more of price, fair market value, and matching to the desired financial attributes were a varying range of timing of benefits of the asset when the asset produces benefits (e.g., a death benefit payment of a life insurance policy). The method continues at step 236 where the selection module chooses an asset selection process. The choosing may be based on one or more of a predetermination, interpreting a request, and interpreting historical selection data and associated financial results.

The method continues at step 238 where the selection module completes selection from the down selected candidate assets to produce chosen augmenting asset bundle information, where the selection is made in accordance with the chosen asset selection approach, and where estimated financial contributions of the augmenting asset bundle compares favorably to a desired cash flow and a desired valuation lift of the desired financial attributes. The method continues at step 240 where a trading module facilitates acquisition of the assets of the augmenting asset bundle to produce acquired augmenting asset bundle information. For example, the trading module exchanges trading information with an augmentation server to confirm purchase pricing, passes through a funding transaction in accordance with the purchase pricing to purchase the assets, and confirms receipt and title of the purchase of the assets of the acquired augmenting asset bundle.

FIG. 7A is a schematic block diagram of an embodiment of an augmentation module 124 that includes a deconstruction approach module 250 and a deconstruction module 252, where the augmentation module 124 communicates with the data source 26 of FIG. 1 and the conversion server 16 of FIG. 1. Each of the deconstruction approach module 250 and the deconstruction module 252 may be implemented utilizing a processing module.

In an example of operation of the augmentation module 124, the deconstruction approach module 250 identifies a transactional server associated with a custodial entity to facilitate ongoing transactions of a financial system when augmented by an acquired augmenting asset bundle. The identifying includes one or more of interpreting a request, interpreting a query response, declaring a competition winner (e.g., a bid), analyzing historical transaction information, identifying a desired risk level for an entity associated with a transactional server, and interpreting risk information associated with entities of transactional servers.

Having identified the transactional server, the deconstruction approach module 250 selects a deconstruction approach for the acquired augmenting asset bundle based on acquired augmenting asset bundle information 136 to produce asset deconstruction approach information 260, where an estimated value of deconstructed asset elements compares favorably to one or more of a desired cash flow and a desired valuation lift and other funding requirements (e.g., value to be generated associated with the transactional server). The deconstruction approaches include a first approach where each asset is converted into a first deconstructed asset element that is an asset and a second peak constructed asset element that is a liability, a number of first elements are titled with an entity associated with a legacy server and a remaining number of first elements with another entity associated with the identified transactional server, substantially all of the second elements are titled to the entity associated with the identified transactional server, where the quantities of tight of the elements is in accordance with one or more of a net present value, exchange or market value historical pricing, instructed pricing, risk levels of each of the entities, and arbitrage information of a data message 38 received from the data source 26.

The deconstruction approaches includes a second approach where in combination with the first approach, a portion of the elements are titled to an entity associated with the conversion server. The selecting may be based on one or more of a predetermination, interpreting a request, interpreting historical results associated with particular deconstruction approaches, interpreting data messages 38 from the data source 26 associated with current market conditions, and optimizing a level of fit for cash flow and for value for at least a portion of the assets for two or more of the deconstruction approaches to identify a presently superior deconstruction approach, where asset element valuation depends on risk associated with entities affiliated with one or more of the legacy server, the transactional server and augmentation server, the conversion server 16. The selecting further includes outputting the asset deconstruction approach information to include one or more of the approach for each asset, a number of assets, identifiers of the assets, and preliminary asset titling information (e.g., which deconstructed asset is assigned to which entity).

Having selected the deconstruction approach for each asset, the deconstruction module 252 facilitates deconstruction of substantially each asset of the acquired augmenting asset bundle utilizing the selected deconstruction approach to produce asset augmentation information 138 (e.g., selected asset title transfer information, selected asset deconstruction approaches). The facilitating includes performing the deconstruction or requesting that the conversion server 16 execute the deconstruction (e.g., in accordance with an agreement).

FIG. 7B is a diagram of an example of utilizing augmenting assets where assets described by acquired augmenting asset bundle information 136 are deconstructed entitled to produce two or more groupings of deconstructed elements from the assets of an acquired augmenting asset bundle. For example, assets 2, 8, and 12 are deconstructed in accordance with a deconstruction approach to produce asset deconstruction elements and liability deconstruction elements, when the assets 2, 8, and 12 are part of the acquired augmenting asset bundle.

Having deconstructed each element, individual elements are partitioned into two or more groupings, where each grouping is title to a different entity of two or more entities, and where a valuation of each grouping meets valuation requirements for the groupings and as a whole for the financial system of a legacy asset base for augmentation. For example, the value of a title 1 grouping may be driven by the asset deconstruction elements of the assets 2, 8, and 12 while the value of a title 2 grouping may be driven by the liability deconstruction elements of assets 2, 8, 12, and others, along with a cash asset and one or more asset deconstruction elements from other assets of the acquired augmenting asset bundle. Alternatively, the title 1 grouping may include another cash asset, or any other asset including bonds etc., and/or one or more liability deconstructed elements. Further alternatively, the title 2 grouping may include shortened liability deconstructed elements, where the shortened liability deconstructed element includes a subset of a plurality of liability (e.g., payment) cash flows (e.g., 2 of n life insurance policy premium payments, a maximum of 10 years of life insurance premium payments, 75% of each remaining life insurance policy premium payment, etc.).

To predict valuations, the value of the title 1 grouping is a function of the aggregated value of each asset deconstruction element, where each asset deconstruction element has a value that's a function of a corresponding liability deconstruction element value (e.g., level of premium payments of the life insurance policy as the original asset), a credit rating associated with a custodial entity (e.g., an entity associated with a transactional server) responsible for making the series of payments of the liability deconstruction element, a credit rating of an entity issuing the original asset (e.g., the life insurance company responsible for the life insurance policy), and timing associated with future cash flow of the asset deconstruction element (e.g., timing of a death benefit payment from the life insurance policy upon death of an insured person).

The value of the title 2 grouping is a function of the expected liability payments associated with the liability deconstruction elements (e.g., life insurance policy premiums based on those insured and mortality table information), one or more asset deconstruction elements (e.g., death benefits), and a cash level or similar (e.g., any other financial instrument to add value such that a net value of the title 2 grouping is positive with respect to the life of the title 2 grouping). As an example, the cash asset may be produced by selling at least some of the asset deconstruction elements to produce cash to bundle into the title 2 grouping.

FIG. 7C is a logic diagram of an example of a method utilizing augmenting assets that includes step 270 where a deconstruction approach module identifies a transactional server associated with a custodial entity to facilitate ongoing transactions of the financial system when augmented by an acquired augmenting asset bundle. The identifying includes one or more of interpreting a request, interpreting a query response, declaring a competition winner, analyzing historical transaction information, identifying a desired risk level for an entity associated with a transactional server, and interpreting risk information associated with entities of a plurality of transactional servers.

The method continues at step 272 where the deconstruction approach module selects a deconstruction approach for each asset of the acquired augmenting asset bundle to produce asset deconstruction approach information, where an estimated value of deconstructed asset elements compares favorably to one or more of a desired cash flow and a desired valuation lift and other funding requirements of a financial system for augmentation. The selecting includes one or more of utilizing a predetermination, interpreting a request, interpreting historical results for various deconstruction approaches, analyzing data messages from a data source where the data messages include current market conditions, optimizing a level of fit for cash flow and for value for at least a portion of the assets for two or more of the deconstruction approaches to identify a presently superior deconstruction approach, where asset element valuation depends on risks associated with entities associated with one or more of a plurality of servers of a communication system, and outputting the asset deconstruction approach information to include one or more of an approach for each asset, a number of assets, identifiers of assets, and preliminary asset title transfer information.

The method continues at step 274 where a deconstruction module facilitates deconstruction of substantially each element of the acquired augmenting asset bundle utilizing the selected deconstruction approach to produce asset augmentation information. The facilitating includes performing the deconstruction or requesting that a remote server performs the deconstruction utilizing the asset deconstruction approach information.

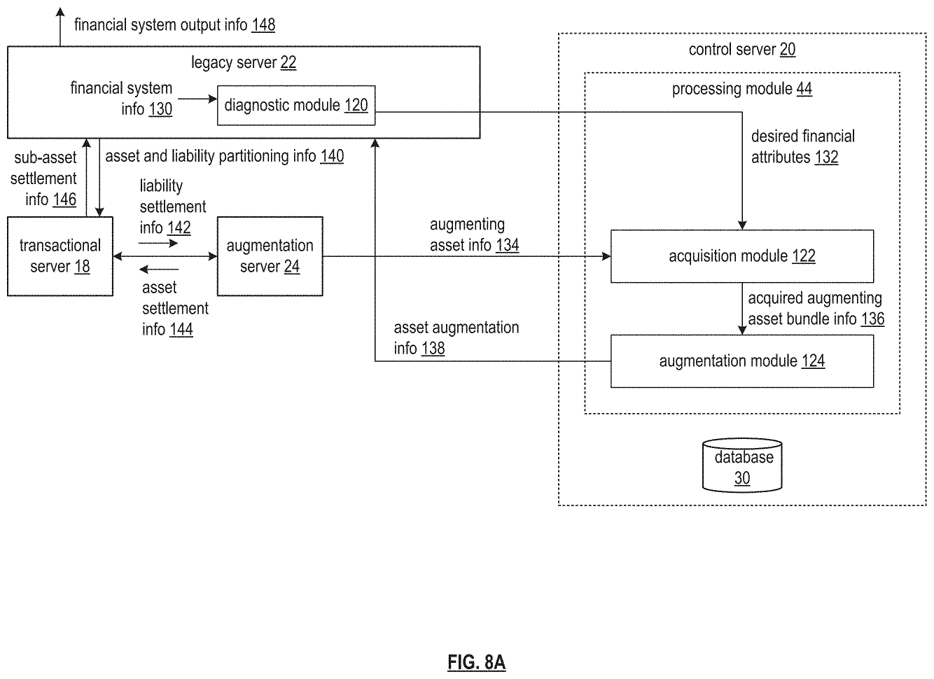

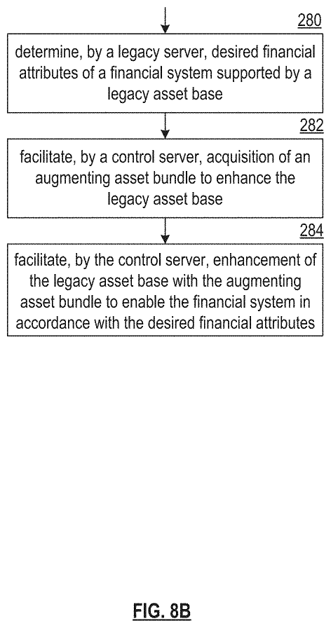

FIG. 8A is a schematic block diagram of another embodiment of a communication system that includes the legacy server 22 of FIG. 1, the transactional server 18 of FIG. 1, the augmentation server 24 of FIG. 1, and the control server 20 of FIG. 1. The legacy server 22 includes the diagnostic module 120 of FIG. 4A. The control server 20 includes the processing module 44 of FIG. 1 and the database 30 of FIG. 1. The processing module 44 includes the acquisition module 122 of FIG. 4A and the augmentation module 124 of FIG. 4A. The communication system functions to facilitate asset reconfiguration and reassignment.

In an example of operation of the facilitating asset reconfiguration and reassignment, the diagnostic module 120 determines to evaluate a financial system associated with the legacy server 22. When evaluating the financial system, the diagnostic module 120 characterizes the financial system based on financial system information 130 to produce desired financial attributes 132 that includes a desired cash flow and a desired valuation lift.

The acquisition module 122 identifies augmenting asset preferences, accesses augmenting asset information 134 to extract candidate asset characteristics, down selects candidate assets that have characteristics that compare favorably to the augmenting asset preferences and to the desired financial attributes 132, determines financial contributions of each of the down selected candidate assets, and selects an asset selection approach. The acquisition module 122 further completes selection of assets from the down selected candidate assets to produce an augmenting asset bundle utilizing the selected asset selection approach, where an estimated financial contribution of the augmenting asset bundle compares favorably to the desired cash flow and valuation lift, and summarizes the augmenting asset bundle to reveal selected asset characteristics to produce acquired augmenting asset bundle information 136.

The augmentation module 124 facilitates identification of a custodial entity and an associated transactional server 18, selects a deconstruction approach for the acquired augmenting asset bundle where an estimated value of deconstructed asset elements compares favorably to one or more of the desired cash flow, the desired valuation lift, and other funding requirements (e.g., the transactional server 18 generates an estimated value, the augmentation module 124 generates the estimated value), generates title transfer information for the deconstructed asset elements, facilitates producing of the acquired augmenting asset bundle utilizing the deconstruction approach to produce the deconstructed asset elements (e.g., perform the deconstruction or request that another entity such as the legacy server 22 perform the deconstruction by issuing a request that includes selected asset titling information and the selected asset deconstruction approach. For instance, the augmentation module 124 issues asset augmentation information 138 to the legacy server 22, where the asset augmentation information 138 includes the selected asset titling information and the selected asset deconstruction approach along with a request that the legacy server 22 perform the deconstruction.

Having received the asset augmentation information 138, the legacy server 22 performs the deconstruction of the augmenting asset bundle to produce the deconstructed asset elements in accordance with the selected asset deconstruction approach, re-bundles deconstructed asset elements to produce two or more groupings, assigns title to each of the two or more groupings in accordance with the received titling information, and issues asset and liability partitioning information 140 to the transactional server 18, where the asset and liability partitioning information 140 includes asset deconstruction results and deconstructed asset element title information. For instance, a first title group of deconstructed elements is titled to the financial system of the legacy server 22 (e.g., a pension system) and a second title group of deconstructed elements is titled to the entity associated with the custodial entity transactional server 18.

Having received the asset and liability protection information 140 the transactional server 18 issues liability settlement information 142 to the augmentation server 24 in accordance with timing associated with a particular group of deconstructed elements titled to either the transactional server 18 or the legacy server 22 (e.g., life insurance policy premium payments, life insurance death benefit claims) and receives corresponding asset settlement information 144 (e.g., life insurance death benefit payments). The transactional server 18 issues sub-asset settlement information 146 to the legacy server 22 when receiving asset settlement information 144 to satisfy compensation for asset maturation in accordance with the titling information (e.g., a portion of the life insurance death benefit payments are forwarded to the legacy server 22 for utilization in the financial system). Having received a plurality of asset maturation payments (e.g., numerous sub-asset settlement information 146), the legacy server 22 facilitates issuing of financial system output information 148 (e.g., financial transactions to satisfy pension payments in accordance with a pension schedule for each pension participant).

FIG. 8B is a logic diagram of another example of a method of enhancing a legacy asset base that includes step 280 where a legacy server determines desired financial attributes of the financial system supported by a legacy asset base. For example, the legacy server determines to evaluate the financial system and characterizes the financial system to estimate a desired cash flow and a desired valuation lift when the financial system is underperforming.

The method continues at step 282 where a control server facilitates acquisition of an augmenting asset bundle to enhance the legacy asset base. For example, the control server identifies augmenting asset preferences, accesses augmenting asset information to extract candidate asset characteristics, down selects candidate assets that have characteristics that compare favorably to the augmenting asset preferences, determines financial contributions of each of the down selected candidate assets, selects an asset selection approach, completes the selection from the down selected candidate assets to produce the augmenting asset bundle utilizing the selected asset selection approach where an estimated financial contribution of the augmenting asset bundle compares favorably to the desired cash flow and desired valuation lift, and summarizes the augmenting asset bundle to reveal selected asset characteristics.

The method continues at step 284 where the control server facilitates enhancement of the legacy asset base with the augmenting asset bundle to enable the financial system in accordance with the desired financial attributes. For example, the control server facilitates identification of a custodial entity associated with a transactional server, selects a deconstruction approach for the acquired augmenting asset bundle where an estimated value of two or more groupings of deconstructed asset elements compares favorably to one or more of the desired cash flow, the desired valuation lift, and other funding requirements, generates titling information for the two or more groupings of the deconstructed asset elements, and facilitates producing of the two or more groupings of deconstructed asset elements utilizing the deconstruction approach.

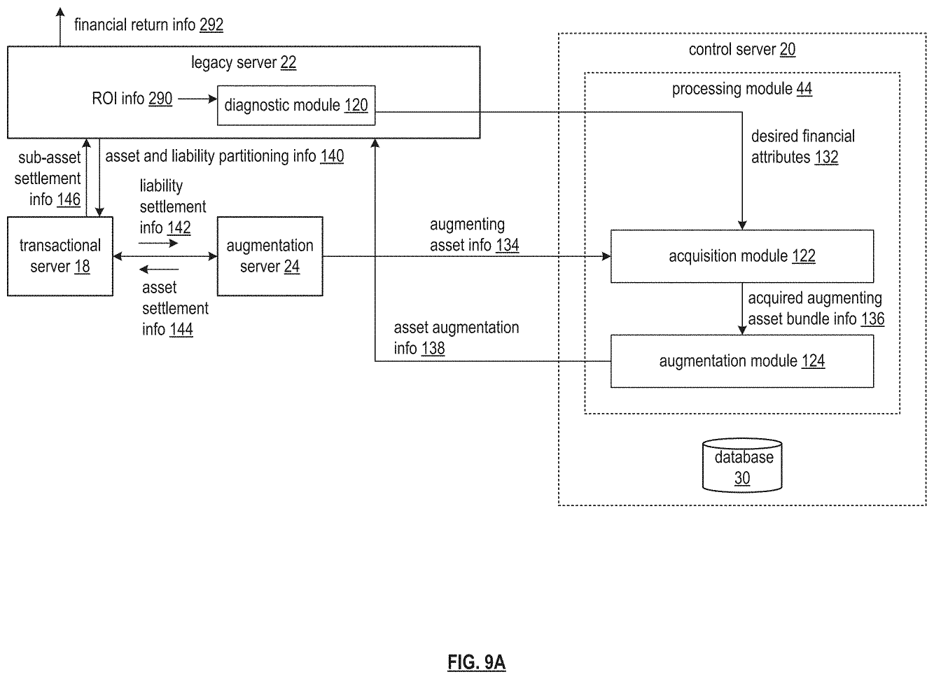

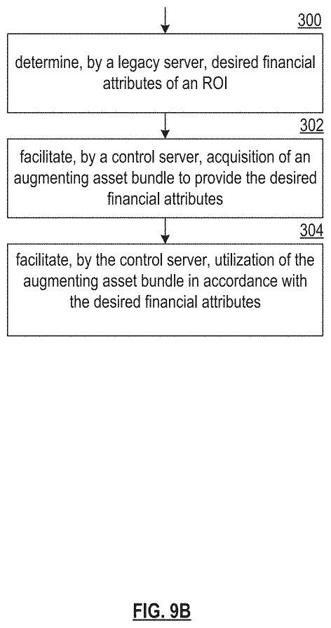

FIG. 9A is a schematic block diagram of another embodiment of a communication system that includes the legacy server 22 of FIG. 1, the transactional server 18 of FIG. 1, the augmentation server 24 of FIG. 1, and the control server 20 of FIG. 1. The legacy server 22 includes the diagnostic module 120 of FIG. 4A. The control server 20 includes the processing module 44 of FIG. 1 and the database 30 of FIG. 1. The processing module 44 includes the acquisition module 122 of FIG. 4A and the augmentation module 124 of FIG. 4A. The communication system functions to facilitate asset reconfiguration and reassignment.

In an example of operation of the facilitating asset reconfiguration and reassignment, the diagnostic module 120 determines to evaluate return on investment (ROI) information associated with the legacy server 22. Such ROI information to be associated with one or more present or future asset bases, where an investment is expected to produce a return with various minimums for financial metrics such as a minimum ROI level, a time frame to achieve various absolute returns, minimum level of magnitudes of returns, etc. The legacy asset base will eventually produce returns that are summarized by the legacy server 22 as financial return information 292 (e.g., cash flow information, balance sheet information. When evaluating the ROI, the diagnostic module 120 characterizes the one or more asset bases from ROI information 290 to produce desired financial attributes 132 that includes a desired cash flow and a desired valuation lift.

The acquisition module 122 identifies augmenting asset preferences, accesses augmenting asset information 134 to extract candidate asset characteristics, down selects candidate assets that have characteristics that compare favorably to the augmenting asset preferences and to the desired financial attributes 132, determines financial contributions of each of the down selected candidate assets, and selects an asset selection approach. The acquisition module 122 further completes selection of assets from the down selected candidate assets to produce an augmenting asset bundle utilizing the selected asset selection approach, where an estimated financial contribution of the augmenting asset bundle compares favorably to the desired cash flow and valuation lift, and summarizes the augmenting asset bundle to reveal selected asset characteristics to produce acquired augmenting asset bundle information 136.

The augmentation module 124 facilitates identification of a custodial entity and an associated transactional server 18, selects a deconstruction approach for the acquired augmenting asset bundle where an estimated value of deconstructed asset elements compares favorably to one or more of the desired cash flow, the desired valuation lift, and other funding requirements (e.g., the transactional server 18 generates an estimated value, the augmentation module 124 generates the estimated value), generates title transfer information for the deconstructed asset elements, facilitates producing of the acquired augmenting asset bundle utilizing the deconstruction approach to produce the deconstructed asset elements (e.g., perform the deconstruction or request that another entity such as the legacy server 22 perform the deconstruction by issuing a request that includes selected asset titling information and the selected asset deconstruction approach. For instance, the augmentation module 124 issues asset augmentation information 138 to the legacy server 22, where the asset augmentation information 138 includes the selected asset titling information and the selected asset deconstruction approach along with a request that the legacy server 22 perform the deconstruction.

Having received the asset augmentation information 138, the legacy server 22 performs the deconstruction of the augmenting asset bundle to produce the deconstructed asset elements in accordance with the selected asset deconstruction approach, re-bundles deconstructed asset elements to produce two or more groupings, assigns title to each of the two or more groupings in accordance with the received titling information, and issues asset and liability partitioning information 140 to the transactional server 18, where the asset and liability partitioning information 140 includes asset deconstruction results and deconstructed asset element title information. For instance, a first title group of deconstructed elements is titled to the asset base of the legacy server 22 (e.g., a general investment fund) and a second title group of deconstructed elements is titled to the entity associated with the custodial entity transactional server 18.

Having received the asset and liability protection information 140 the transactional server 18 issues liability settlement information 142 to the augmentation server 24 in accordance with timing associated with a particular group of deconstructed elements titled to either the transactional server 18 or the legacy server 22 (e.g., life insurance policy premium payments, life insurance death benefit claims) and receives corresponding asset settlement information 144 (e.g., life insurance death benefit payments). The transactional server 18 issues sub-asset settlement information 146 to the legacy server 22 when receiving asset settlement information 144 to satisfy dividend payments or similar for asset maturation in accordance with the titling information (e.g., a portion of the life insurance death benefit payments are forwarded to the legacy server 22 for utilization in the asset base). Having received a plurality of asset maturation payments (e.g., numerous sub-asset settlement information 146), the legacy server 22 facilitates issuing of the financial return information 292 (e.g., financial transactions to satisfy general investment fund payments in accordance with a dividend payment schedule for each investment fund participant).

FIG. 9B is a logic diagram of another example of a method of enhancing a legacy asset base that includes step 300 where a legacy server determines desired financial attributes of an ROI (e.g., of a general investment fund or similar). For example, the legacy server determines to evaluate the ROI of the legacy asset base and characterizes the acid-base to estimate a desired cash flow and a desired valuation lift.

The method continues at step 302 where a control server facilitates acquisition of an augmenting asset bundle to enhance the legacy asset base. For example, the control server identifies augmenting asset preferences, accesses augmenting asset information to extract candidate asset characteristics, down selects candidate assets that have characteristics that compare favorably to the augmenting asset preferences, determines financial contributions of each of the down selected candidate assets, selects an asset selection approach, completes the selection from the down selected candidate assets to produce the augmenting asset bundle utilizing the selected asset selection approach where an estimated financial contribution of the augmenting asset bundle compares favorably to the desired cash flow and desired valuation lift, and summarizes the augmenting asset bundle to reveal selected asset characteristics.

The method continues at step 304 where the control server facilitates enhancement of the legacy asset base with the augmenting asset bundle to enable the legacy asset in accordance with the desired financial attributes. For example, the control server facilitates identification of a custodial entity associated with a transactional server, selects a deconstruction approach for the acquired augmenting asset bundle where an estimated value of two or more groupings of deconstructed asset elements compares favorably to one or more of the desired cash flow, the desired valuation lift, and other funding requirements, generates titling information for the two or more groupings of the deconstructed asset elements, and facilitates producing of the two or more groupings of deconstructed asset elements utilizing the deconstruction approach to enable future results of the legacy asset base to compare favorably to the desired financial attributes.

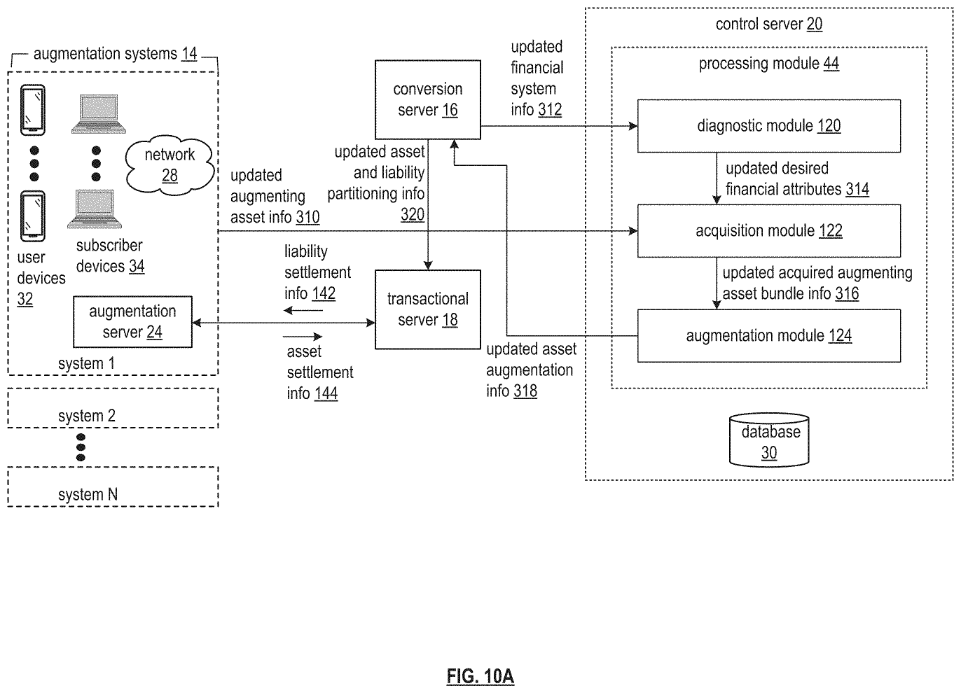

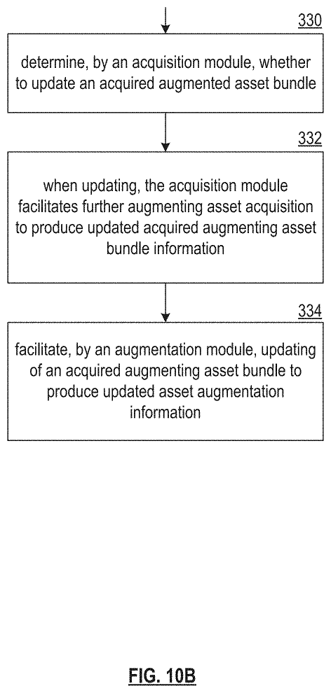

FIG. 10A is a schematic block diagram of another embodiment of a communication system that includes the plurality of N augmentation systems 14 of FIG. 1, the conversion server 16 of FIG. 1, the transactional server 18 of FIG. 1, and the control server 20 of FIG. 1. Each augmentation system 14 includes a portion of the network 28 of FIG. 1, the plurality of user devices 32 of FIG. 1, the plurality of subscriber devices 34 of FIG. 1, and the augmentation server 24 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to facilitate asset reconfiguration and reassignment.

In an example of operation of the facilitating of the asset reconfiguration and reassignment, the acquisition module 122 determines whether to update an acquired augmenting asset bundle. As a particular example, the acquisition module 122 receives updated desired financial attributes 314 from the diagnostic module 120 based on updated financial system information 312 from the conversion server 16 and detects that a change has occurred that will drive updated desired financial attributes 314 (e.g., a new desired cash flow is detected, a new desired valuation lift is detected).

As another particular example, the acquisition module 122 receives updated augmenting asset information 310 from one or more of a user device 32, a subscriber device 34, and the augmentation server 24, and detects that an attribute of an augmenting asset of the acquired augmented asset bundle compares favorably to an attribute threshold level (e.g., interpret updated augmenting asset information 310 from a user device 32 to extract the attribute, compare the attribute to a corresponding attribute threshold level, and indicate the favorable comparison when the attribute compares favorably to the attribute threshold level). Examples of attributes include user demographics, user lifestyle, user location user interests, user illness, user domicile location, user work location user career field, user family connections, user social connections user leisure time activities, user nutrition information, user DNA information, weather conditions associated with a proximal location to a user, and/or any other attribute associated with one or more users that may impact valuation of associated assets of an augmentation system. For instance, the acquisition module 122 detects a lifestyle change of a person associated with the user device 32, where the person is associated with a life insurance policy asset of the augmenting assets.

When updating the acquired augmenting asset bundle, the acquisition module 122 facilitates further augmenting asset acquisition to produce updated acquired augmenting asset bundle information 316. For example, the acquisition module 122 identifies augmenting asset preferences, accesses the updated augmenting asset information 310 to extract candidate asset characteristics, down selects candidate assets that have attributes that compare favorably to the augmenting asset preferences, determines financial contributions of each of the down selected candidate assets, and selects an asset selection approach (e.g., keep some prior assets, swaps and prior assets, add more assets, remove some assets). The selecting may be based on one or more of a predetermination, a request, a query response, and a previously utilized asset selection approach that is associated with favorable financial results.

When acquiring more assets, the acquisition module 122 completes the selection from the down selected candidate assets to produce the updated augmenting asset bundle utilizing the selected asset selection approach where an estimated financial contribution of the augmenting asset bundle compares favorably to a desired cash flow and a desired valuation lift. The acquisition module 122 summarizes the updated acquired asset bundle to reveal further selected asset characteristics included in updated acquired augmenting asset bundle information 316.

The augmentation module 124 facilitates updating of the acquired augmenting asset bundle to produce updated asset augmentation information 318. For example, the augmentation module 124 identifies a custodial entity associated with the transactional server 18, selects a deconstruction approach for the updated acquired augmenting asset bundle, where an estimated value of remaining deconstructed asset elements combined with further acquired deconstructed asset elements, when re-bundled in two or more groups, compares favorably to one or more of the desired cash flow, the desired valuation lift, and other funding requirements.

The augmentation module 124 generates updated titling information for the totality of deconstructed asset elements as a result of a new re-bundling plan and facilitates the construction of an updated acquired augmenting asset bundle utilizing the deconstruction approach to produce the further deconstructed asset elements (e.g., perform the deconstruction or request that another entity such as the conversion server 16 perform the deconstruction by issuing the updated asset augmentation information 318 to the conversion server 16). The updated asset augmentation information 318 includes one or more of the asset titling information, the selected asset deconstruction approach, and a request to perform the deconstruction.

The conversion server 16 issues updated asset and liability partitioning information 320 to the transactional server 18 based on the updated asset augmentation information 318. The transactional server 18 issues liability settlement information 142 to the augmentation server 24 from time to time and receives asset settlement information 144 from the augmentation server 24.

FIG. 10B is a logic diagram of an example of a method of updating an acquired augmenting asset bundle that includes step 330 where an acquisition module determines whether to update an acquired augmented asset bundle. The determining may be based on one or more of interpreting updated desired financial attributes based on updated financial system information and detecting that an attribute of an augmenting asset of the acquired augmenting asset bundle compares favorably to an attribute threshold level (e.g., interpret updated augmenting asset information to extract the attribute, compare the attribute to a corresponding attribute threshold level, and indicate a favorable comparison when the attribute compares favorably to the attribute threshold level).

When updating, the method continues at step 332 where the acquisition module facilitates further augmenting asset acquisition to produce updated acquired augmented asset bundle information. For example, the acquisition module identifies augmenting asset preferences, accesses updated augmenting asset information to extract candidate asset characteristics, down selects candidate assets that have attributes that compare favorably to the augmenting asset preferences, determines financial contributions of each of the down selected candidate assets, selects an asset selection approach, completes the selection from the down selected candidate assets to produce the updated augmenting asset bundle utilizing the selected asset selection approach where an estimated financial contribution of the augmenting asset bundle compares favorably to a desired cash flow and a desired valuation lift, and summarize the updated augmenting asset bundle to reveal further selected asset characteristics.

The method continues at step 334 where an augmentation module facilitates updating of an acquired augmenting asset bundle to produce updated asset augmentation information. For example, the augmentation module identifies a custodial entity of an associated transactional server, selects a deconstruction approach for the updated acquired augmented asset bundle where an estimated value of remaining deconstructed asset elements combined with further acquired deconstructed asset elements compares favorably to one or more of the desired cash flow, the desired valuation lift, and other funding requirements, generates updated titling information for the totality of deconstructed asset elements, facilitates the construction of an updated acquired augmenting asset bundle utilizing the deconstruction approach to produce further deconstructed asset elements, where the transactional server utilizes the further elements.

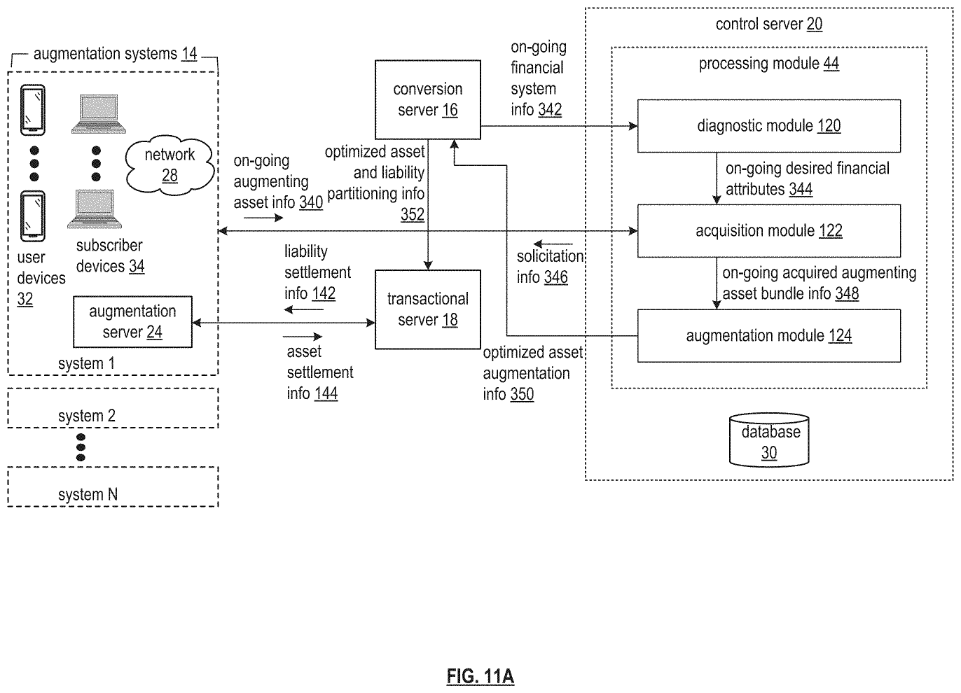

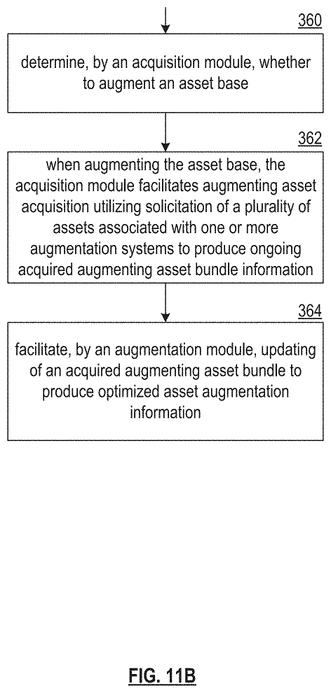

FIG. 11A is a schematic block diagram of another embodiment of a communication system that includes the plurality of N augmentation systems 14 of FIG. 1, the conversion server 16 of FIG. 1, the transactional server 18 of FIG. 1, and the control server 20 of FIG. 1. Each augmentation system 14 includes a portion of the network 28 of FIG. 1, the plurality of user devices 32 of FIG. 1, the plurality of subscriber devices 34 of FIG. 1, and the augmentation server 24 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to facilitate asset reconfiguration and reassignment.

In an example of operation of the facilitating of the asset reconfiguration and reassignment, the acquisition module 122 determines whether to update an asset base associated with the conversion server 16 (e.g., where a pension system sponsor is associated with the conversion server 16). As a particular example, the acquisition module 122 receives ongoing desired financial attributes 344 from the diagnostic module 120 based on ongoing financial system information 342 from the conversion server 16 and detects that a change has occurred that will drive ongoing desired financial attributes 344 (e.g., a new desired cash flow is detected, a new desired valuation lift is detected).

As another particular example, the acquisition module 122 receives an indication from one or more of the transactional server 18, the conversion server 16, the augmentation server 24, one or more user devices 32, and one or more subscriber devices 34, that a trigger condition has occurred associated with one or more of the asset base and or with one or more available assets associated with one or more of the augmentation systems 14. For example, the acquisition module 122 interprets ongoing augmenting asset information 340 from a first user device 32, where the interpretation indicates that an asset associated with the user of the first user device 32 has favorable attributes as compared to augmenting asset preferences and may be available for purchase.

When augmenting the asset base, the acquisition module 122 facilitates augmenting asset acquisition utilizing solicitation of a plurality of assets associated with one or more augmentation systems 14 to produce ongoing acquired augmenting asset bundle information 348. For example, the acquisition module 122 identifies the augmenting asset preferences, accesses the ongoing augmenting asset information 342 extract candidate asset characteristics, down selects candidate assets that compare favorably to the augmenting asset preferences, determines financial contributions of each of the down selected candidate assets, selects an asset selection approach, complete selection from the down selected candidate assets to produce an updated augmenting asset bundle utilizing the selected asset selection approach where an estimated financial contribution of the augmenting asset bundle compares favorably to desired cash flow and desired valuation lift, and summarizes the updated augmenting asset bundle to reveal further selected asset characteristics in ongoing acquired augmenting asset bundle information 348, where the acquisition module 122 issues solicitation information 346 to the corresponding one or more augmentation systems 14 to invoke a new agreement to sell an asset (e.g., sends a solicitation message to the first user device 32), and completes the acquiring of the selected assets.

The augmentation module 124 facilitates updating of the acquired augmenting asset bundle to produce optimized asset augmentation information 350. For example, the augmentation module 124 identifies a custodial entity associated with the transactional server 18, selects a deconstruction approach for the updated acquired augmenting asset bundle, where an estimated value of remaining deconstructed asset elements combined with further acquired deconstructed asset elements, when re-bundled in two or more groups, compares favorably to one or more of the desired cash flow, the desired valuation lift, and other funding requirements.

The augmentation module 124 generates updated titling information for the totality of deconstructed asset elements as a result of a new re-bundling plan and facilitates the construction of an updated acquired augmenting asset bundle utilizing the deconstruction approach to produce the further deconstructed asset elements (e.g., perform the deconstruction or request that another entity such as the conversion server 16 perform the deconstruction by issuing the updated asset augmentation information 318 to the conversion server 16). The optimized asset augmentation information 350 includes one or more of the asset titling information, the selected asset deconstruction approach, and a request to perform the deconstruction.

The conversion server 16 issues optimized asset and liability partitioning information 352 to the transactional server 18 based on the optimized asset augmentation information 350. The transactional server 18 issues liability settlement information 142 to the augmentation server 24 from time to time and receives asset settlement information 144 from the augmentation server 24.

FIG. 11B is a logic diagram of another example of a method of updating an acquired augmenting asset bundle that includes step 360 where an acquisition module determines whether to augment an asset base. The determining may be based on one or more of interpreting updated desired financial attributes based on on-going financial system information, detecting that an attribute of an augmenting asset of the acquired augmenting asset bundle compares favorably to an attribute threshold level (e.g., interpret on-going augmenting asset information to extract the attribute, compare the attribute to a corresponding attribute threshold level, and indicate a favorable comparison when the attribute compares favorably to the attribute threshold level), and receiving an indication of an unfavorable condition associated with the asset base.

When updating the asset base, the method continues at step 362 where the acquisition module facilitates further augmenting asset acquisition utilizing solicitation of a plurality of assets associated with one or more augmentation systems to produce on-going acquired augmented asset bundle information. For example, the acquisition module identifies augmenting asset preferences, accesses on-going augmenting asset information to extract candidate asset characteristics, down selects candidate assets that have attributes that compare favorably to the augmenting asset preferences, determines financial contributions of each of the down selected candidate assets, selects an asset selection approach, completes the selection from the down selected candidate assets to produce the updated augmenting asset bundle utilizing the selected asset selection approach where an estimated financial contribution of the augmenting asset bundle compares favorably to a desired cash flow and a desired valuation lift, summarizes the updated augmenting asset bundle to reveal further selected asset characteristics, and issues solicitation information to the corresponding one or more augmentation systems (e.g., send a solicitation message to the user device to invoke a status change when asset associated with the user device from unavailable to available for sale).

The method continues at step 364 where an augmentation module facilitates updating of an acquired augmenting asset bundle to produce optimized asset augmentation information. For example, the augmentation module identifies a custodial entity of an associated transactional server, selects a deconstruction approach for the updated acquired augmented asset bundle where an estimated value of remaining deconstructed asset elements combined with further acquired deconstructed asset elements compares favorably to one or more of the desired cash flow, the desired valuation lift, and other funding requirements, generates updated titling information for the totality of deconstructed asset elements, and facilitates the construction of an updated acquired augmenting asset bundle utilizing the deconstruction approach to produce further deconstructed asset elements, where the transactional server utilizes the further elements.

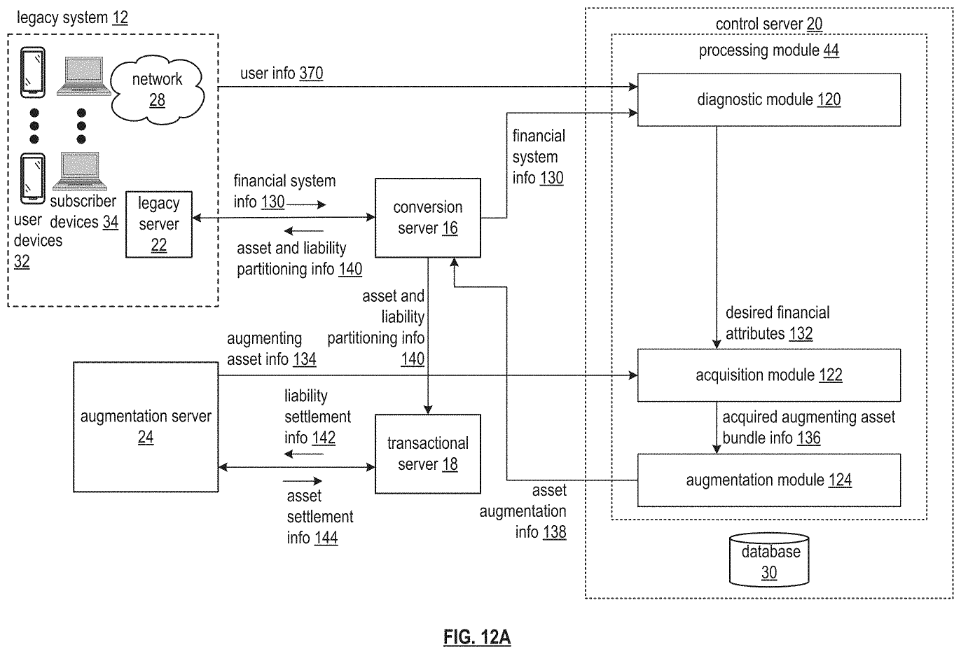

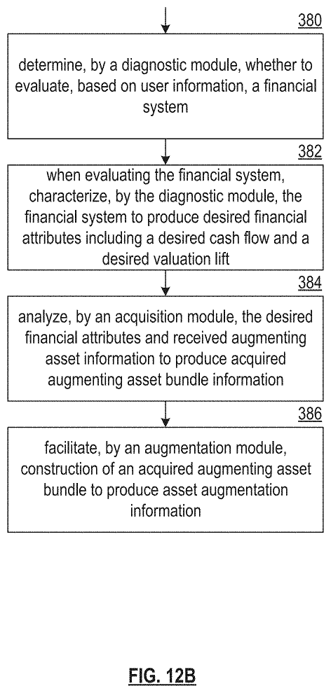

FIG. 12A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to facilitate asset reconfiguration and reassignment.

In an example of operation of the facilitating of the asset reconfiguration and reassignment, the diagnostic module 120 determines whether to evaluate a financial system associated with the legacy system 12. The determining includes interpreting user information 370 to predict viability of the financial system. For example, the diagnostic module 120 analyzes user demographic driven cash flow changes, changes in the number of users of the legacy system 12, lifestyle changes of users associated with the user devices 32 and/or the subscriber devices 34, and risk levels associated with the legacy system 12 (e.g., solvency or ability to meet financial commitments). For instance, the diagnostic module 120 receives user information 370 from a plurality of user devices 32, where the user information 370 includes data associated with a plurality of users, where the data has at least one correlation to future financial commitments of the financial system associated with the legacy system 12 (e.g., lifestyle changes affecting average expected life expectancy thus correlated to timing and amount of pension benefit payments when the financial system is a pension system). When metrics of the user information 370 compare unfavorably to desired metric ranges (e.g., implying underfunding or over funding of future financial commitments), the diagnostic module 120 indicates to evaluate the financial system.

When evaluating the financial system, the diagnostic module 120 characterizes the financial system to produce desired financial attributes 132 including a desired cash flow and a desired valuation lift based on user information 370 and financial system information 130. For example, the desired cash flow and valuation lift is raised when an interpretation of the user information 370 indicates that life expectancies are longer requiring increased future financial commitments (e.g., further pension benefit payouts when the financial system is a pension system).

The acquisition module 122 analyzes the desired financial attributes 132 and received augmenting asset information 134 to produce acquired augmenting asset bundle information 136. For example, the acquisition module 122 identifies augmenting asset preferences, accesses the augmenting asset information 134 to extract candidate asset characteristics, down selects candidate assets that compare favorably to the augmenting asset preferences, determines financial contributions of each of the down selected candidate assets, selects an asset selection approach, complete selection from the down selected candidate assets to produce the augmenting asset bundle utilizing the selected asset selection approach, where an estimated financial contribution of the augmenting asset bundle compares favorably to the desired cash flow and the desired valuation lift, and summarizes the augmenting asset bundle to reveal selected asset characteristics of the acquired augmenting asset bundle information 136.

The augmentation module 124 facilitates construction of an acquired augmenting asset bundle to produce asset augmentation information 138. For example, the augmentation module 124 identifies a custodial entity associated with the transactional server 18, selects a deconstruction approach for the acquired augmenting asset bundle, where an estimated value of deconstructed asset elements compares favorably to one or more of the desired cash flow, the desired valuation lift, and other funding requirements, generates titling information for the deconstructed asset elements (e.g., when partitioned into two or more groupings), facilitates the construction of the acquired augmenting asset bundle utilizing the deconstruction approach to produce the deconstructed asset elements (e.g., performing the deconstruction requesting that the conversion server 16, or another entity perform the deconstruction), and sending the asset augmentation information 138 to the conversion server 16.

The conversion server 16 issues asset and liability partition information 140 to the legacy server 22 and to the transactional server 18 based on the asset augmentation information 138. The transactional server 18 issues liability settlement information 142 to the augmentation server 24 in accordance with the asset and liability partition information 140. The augmentation server 24 issues asset settlement information 144 to the transactional server 18 in accordance with the liability settlement information 142 and the asset and liability partition information 140.

FIG. 12B is a logic diagram of another example of a method of updating an acquired augmenting asset bundle that includes step 380 where a diagnostic module determines whether to evaluate, based on user information, a financial system. The determining includes interpreting the user information to predict viability of the financial system (e.g., user demographic driven cash flow changes) and indicates to evaluate when metrics associated with the user information become unfavorable (e.g., when compared to desirable metrics, when compared to acceptable rate of change metrics).

When evaluating the financial system, the method continues at step 382 where the diagnostic module characterizes the financial system to produce desired financial attributes including a desired cash flow and a desired valuation lift. For example, the diagnostic module analyzes financial system information and the user information to produce the desired financial attributes (e.g., correlate user information associated with each user to a portion of the desired financial attributes, aggregate the portions to produce the desired financial attributes for the financial system).

The method continues at step 384 where an acquisition module analyzes the desired financial attributes and received augmenting asset information to produce acquired augmenting asset bundle information. For example, the acquisition module identifies augmenting asset preferences, accesses augmenting asset information to extract candidate asset characteristics, down selects candidate assets having attributes that compare favorably to the augmenting asset preferences, determines financial contributions of each of the down selected candidate assets, selects an asset selection approach, completes selection from the down selected candidate assets to produce the augmenting asset bundle utilizing the selected asset selection approach where an estimated financial contribution of the augmenting asset bundle compares favorably to the desired cash flow and valuation lift, and summarizes the augmenting asset bundle to reveal selected asset characteristics.

The method continues at step 386 where an augmentation module facilitates construction of an acquired augmenting asset bundle to produce asset augmentation information. For example, the augmentation module identifies a custodial entity, selects a deconstruction approach for the acquired augmenting asset bundle where an estimated value of particularly grouped deconstructed asset elements compares favorably to one or more of the desired cash flow, the desired valuation lift, and other funding requirements, generates titling information for two or more groupings of the deconstructed asset elements, facilitates the construction of the acquired augmenting asset bundle utilizing the deconstruction approach to produce the deconstructed asset elements for grouping into the two or more groupings, where at least one of the groupings is utilized to augment the financial system.

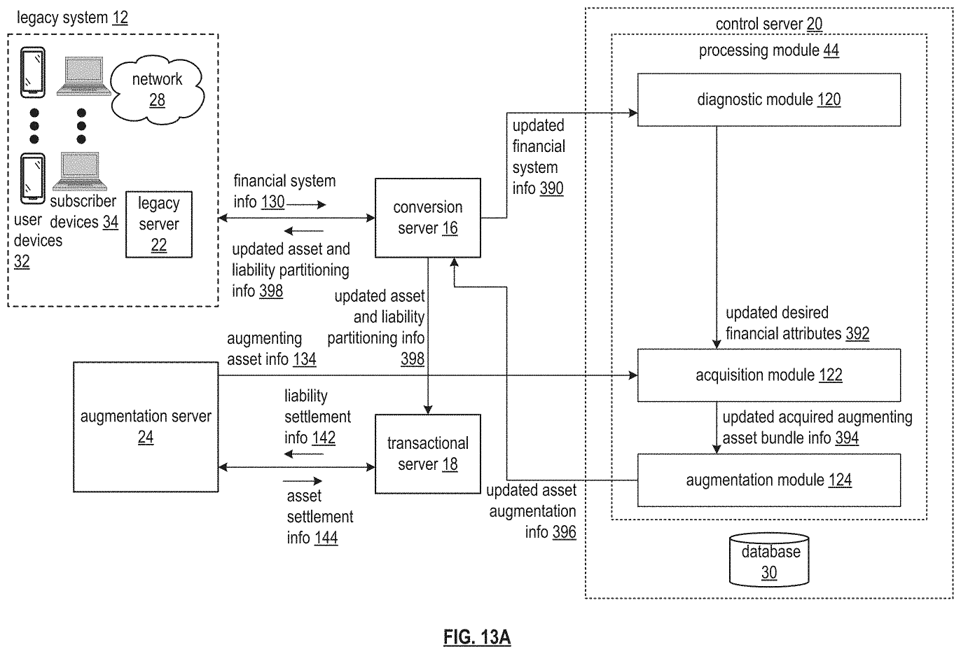

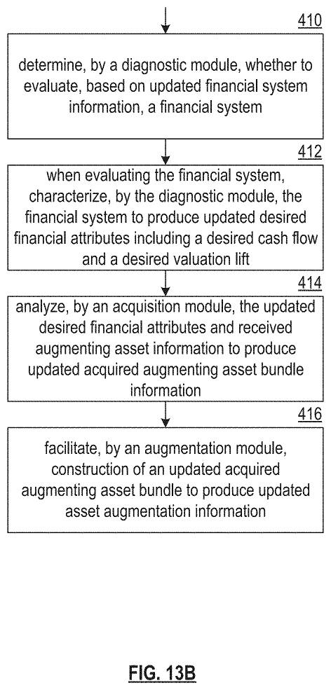

FIG. 13A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to facilitate asset reconfiguration and reassignment.

In an example of operation of the facilitating of the asset reconfiguration and reassignment, the diagnostic module 120 determines whether to evaluate a financial system associated with the legacy system 12. The determining includes interpreting user information 370 to predict viability of the financial system. For example, the diagnostic module 120 analyzes updated financial system information 390 received from the conversion server 16, where the conversion server 16 receives financial system information 130 from the legacy system 12 and indicates to evaluate the financial system when metrics of the updated financial system information 390 compares unfavorably to desired metric ranges (e.g., risk levels associated with the legacy system 12, solvency of the financial system, ability to meet financial commitments).

When evaluating the financial system, the diagnostic module 120 characterizes the financial system to produce updated desired financial attributes 392 including a desired cash flow and a desired valuation lift based on the updated financial system information 390. For example, the desired cash flow and valuation lift are raised when an interpretation of the updated financial system information 390 indicates that unexpected high levels of commitment payouts are requiring increased future financial commitments (e.g., further pension benefit payouts when the financial system is a pension system).

The acquisition module 122 analyzes the updated desired financial attributes 392 and received augmenting asset information 134 to produce updated acquired augmenting asset bundle information 394. For example, the acquisition module 122 identifies augmenting asset preferences, accesses the augmenting asset information 134 to extract candidate asset characteristics, down selects candidate assets that compare favorably to the augmenting asset preferences, determines financial contributions of each of the down selected candidate assets, selects an asset selection approach, completes selection from the down selected candidate assets to produce the augmenting asset bundle utilizing the selected asset selection approach, where an estimated financial contribution of the augmenting asset bundle compares favorably to the desired cash flow and the desired valuation lift, and summarizes the augmenting asset bundle to reveal selected asset characteristics of the updated acquired augmenting asset bundle information 394.

The augmentation module 124 facilitates construction of an acquired augmenting asset bundle to produce updated asset augmentation information 396. For example, the augmentation module 124 identifies a custodial entity associated with the transactional server 18, selects a deconstruction approach for the acquired augmenting asset bundle, where an estimated value of a particular grouping of deconstructed asset elements compares favorably to one or more of the desired cash flow, the desired valuation lift, and other funding requirements, generates titling information for one or more groupings of the deconstructed asset elements (e.g., when partitioned into the two or more groupings), facilitates the construction of the acquired augmenting asset bundle utilizing the deconstruction approach to produce the deconstructed asset elements (e.g., performing the deconstruction or requesting that the conversion server 16, or another entity perform the deconstruction), and sending the updated asset augmentation information 396 to the conversion server 16.

The conversion server 16 issues updated asset and liability partition information 398 to the legacy server 22 and to the transactional server 18 based on the updated asset augmentation information 396. The transactional server 18 issues liability settlement information 142 to the augmentation server 24 in accordance with the updated asset and liability partition information 398 and the augmentation server 24 issues asset settlement information 144 to the transactional server 18 in accordance with the liability settlement information 142 and the updated asset and liability partition information 398.

FIG. 13B is a logic diagram of another example of a method of updating an acquired augmenting asset bundle that includes step 410 where a diagnostic module determines whether to evaluate, based on updated financial system information, a financial system. The determining includes interpreting the financial system information to predict viability of the financial system (e.g., estimated future cash flow changes) and indicates to evaluate when metrics associated with the financial system information become unfavorable (e.g., when compared to desirable metrics, when compared to acceptable rate of change metrics).

When evaluating the financial system, the method continues at step 412 where the diagnostic module characterizes the financial system to produce desired financial attributes including a desired cash flow and a desired valuation lift. For example, the diagnostic module analyzes the financial system information to produce the desired financial attributes (e.g., interpret updated aspects of the financial system information to look for required variances of a previously determined desired cash flow and a previously determined desired valuation lift).

The method continues at step 414 where an acquisition module analyzes the updated desired financial attributes and received augmenting asset information to produce updated acquired augmenting asset bundle information. For example, the acquisition module identifies augmenting asset preferences, accesses augmenting asset information to extract candidate asset characteristics, down selects candidate assets having attributes that compare favorably to the augmenting asset preferences, determines financial contributions of each of the down selected candidate assets, selects an asset selection approach, completes selection from the down selected candidate assets to produce the augmenting asset bundle utilizing the selected asset selection approach where an estimated financial contribution of the augmenting asset bundle compares favorably to the desired cash flow and valuation lift, and summarizes the augmenting asset bundle to reveal selected asset characteristics.

The method continues at step 416 where an augmentation module facilitates construction of an updated acquired augmenting asset bundle to produce updated asset augmentation information. For example, the augmentation module identifies a custodial entity, selects a deconstruction approach for the updated acquired augmenting asset bundle where an estimated value of particularly grouped deconstructed asset elements compares favorably to one or more of the desired cash flow, the desired valuation lift, and other funding requirements, generates titling information for two or more groupings of the deconstructed asset elements, facilitates the construction of the updated acquired augmenting asset bundle utilizing the deconstruction approach to produce the deconstructed asset elements for grouping into the two or more groupings, where at least one of the groupings is utilized to augment the financial system.

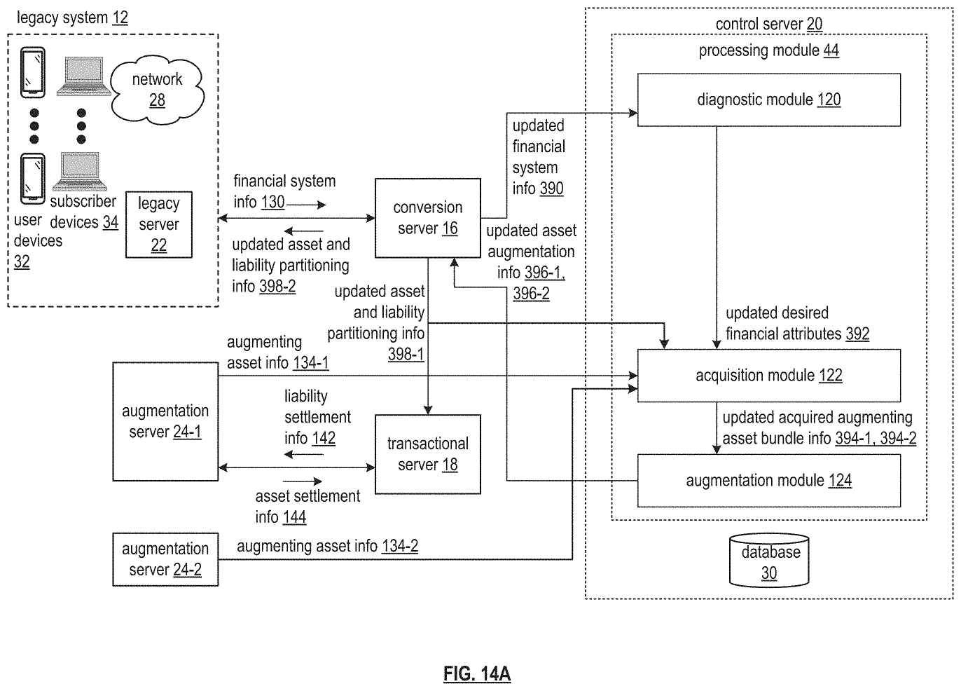

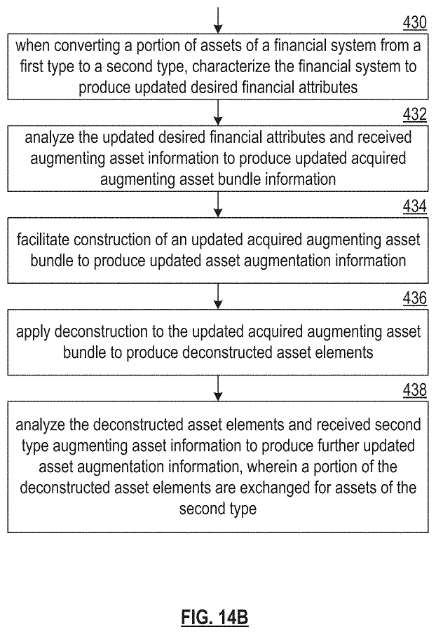

FIG. 14A is a schematic block diagram of another embodiment of a communication system that includes the legacy system 12 of FIG. 1, the conversion server 16 of FIG. 1, the transactional server 18 of FIG. 1, augmentation servers 24-1 and 24-2, and the control server 20 of FIG. 1. The augmentation servers 24-1 and 24-2 may be implemented utilizing the augmentation server 24 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to convert a financial system from a first type to a second type.

In an example of operation of the converting of the financial system, the diagnostic module 120 characterizes the financial system of the legacy system 12 to produce updated desired financial attributes 392, where the attributes include requirements of the second type. For example, the legacy system 12 issues financial system info 130 to the conversion server 16 and the conversion server 16 issues updated financial system info 390 to the diagnostic module 120, where the updated financial system info 390 is based on the financial system info 130.

The acquisition module 122 analyzes the updated desired financial attributes 392 and received augmenting asset information 134-1 to produce updated acquired augmenting asset bundle information 394-1. The producing includes one or more of identifying augmenting asset preferences, accessing augmenting asset information to extract candidate asset characteristics, down selecting candidate assets that compare favorably to the augmenting asset preferences, determining financial contributions of each of the down selected candidate assets, selecting an asset selection approach, completing selection from the down selected candidate assets to produce the augmenting asset bundle utilizing the selected asset selection approach, where an estimated financial contribution of the augmenting asset bundle compares favorably to a desired cash flow in valuation lift, and summarizing the augmenting asset bundle to reveal selected asset characteristics.

The augmentation module 124 facilitates construction of updated asset augmentation information 396-1. The facilitating includes one or more of identifying the transactional server 18 (e.g., custodial entity), selecting a deconstruction approach for the updated acquired augmenting asset bundle, where an estimated value of deconstructed asset elements compares favorably to one or more of the desired cash flow, the desired valuation lift, and other funding requirements (e.g., value to be generated associated with the transactional server 18), generating title transfer information for the deconstructed asset elements, facilitating the construction of the updated acquired augmenting asset bundle utilizing the deconstruction approach to produce the deconstructed asset elements (e.g., deconstruct or request that another entity such as the transactional server 18 perform the deconstruction by issuing a request that includes selected asset title transfer information and the selected asset deconstruction approach) to enable the conversion server 16 to issue updated asset and liability partitioning information 398-1 to the transactional server 18, where the transactional server 18 exchanges liability settlement information 142 and asset settlement information 144 with the augmentation server 24-1 and the conversion server 16 receives financial system information 130 from the legacy server 22.

The acquisition module 122 analyzes the updated asset and liability partitioning information 398-1 and augmenting asset information 134-2 of the second type to produce updated acquired augmenting asset bundle information 394-2. The producing includes selecting a portion of the augmenting asset bundle to utilize when acquiring assets of the selected second type. The augmentation module 124 facilitates construction of a further updated acquired augmenting asset bundle to produce updated asset augmentation information 396-2. The facilitating includes converting a portion of the further updated acquired augmenting asset bundle to the second type, where the conversion server 16 issues updated asset and liability partitioning information 398-2 to the legacy system 12.

FIG. 14B is a logic diagram of an example of a method of converting the financial system from a first type to a second type within a communication system. In particular, a method is presented for use in conjunction with one or more functions and features described in conjunction with FIGS. 1-7C, 14A and also FIG. 14B. The method includes step 430 where a processing module of one or more computing devices (e.g., of one or more servers), when converting a portion of assets of a financial system from a first type to a second type, characterize the financial system to produce updated desired financial attributes. For example, the processing module analyzes updated financial system information to produce the updated desired financial attributes.

The method continues at step 432 for the processing module analyzes the updated desired financial attributes and received augmenting asset information to produce updated acquired augmenting asset bundle information. For example, the processing module identifies augmenting asset preferences, accesses augmenting asset information and extracts candidate asset characteristics, down selects candidate assets that compare favorably to the augmenting asset preferences, determines financial contributions of each of the down selected candidate assets, selects an asset selection approach, completes selection from the down selected candidate assets to produce the augmenting asset bundle utilizing the selected asset selection approach, where an estimated financial contribution of the augmenting asset bundle compares favorably to a desired cash flow and valuation lift associated with the desired financial attributes, and summarizes the augmenting asset bundle to reveal selected asset characteristics.

The method continues at step 434 for the processing module facilitates construction of an updated acquired augmenting asset bundle to produce updated asset augmentation information. For example, the processing module selects a deconstruction approach and generates title transfer information for the deconstructed asset elements. The method continues at step 436 for the processing module applies deconstruction to the updated acquired augmenting asset bundle to produce deconstructed asset elements. For example, the processing module constructs the updated acquired augmenting asset bundle utilizing the deconstruction approach to produce the deconstructed asset elements to enable issuing of updated asset and liability partitioning information, where liability settlement information and asset settlement information may be subsequently exchanged.

The method continues at step 438 where the processing module analyzes the deconstructed asset elements and received second type augmenting asset information to produce further updated asset augmentation information, wherein a portion of the deconstructed asset elements are exchanged for assets of the second type. For example, the processing module selects a portion of the augmenting asset bundle to utilize to acquire assets of the selected second type.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

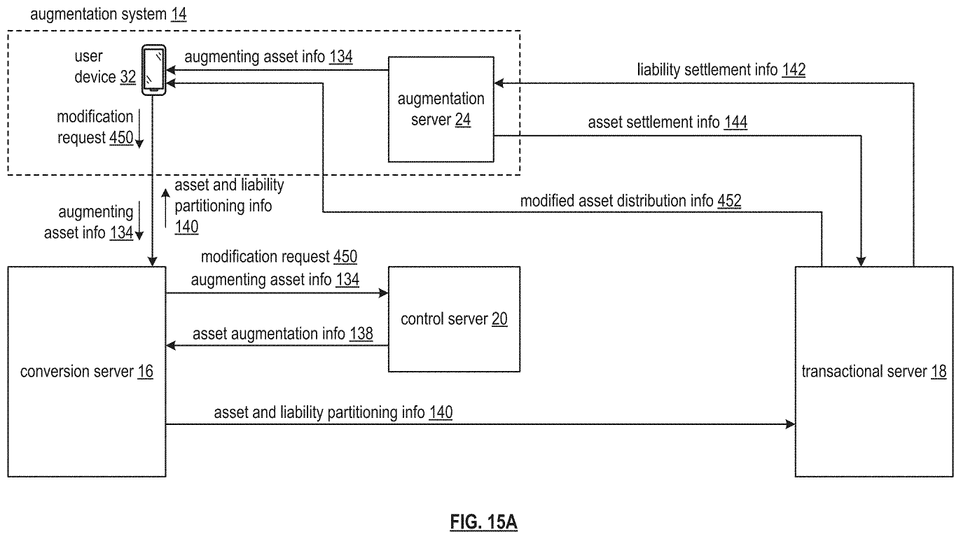

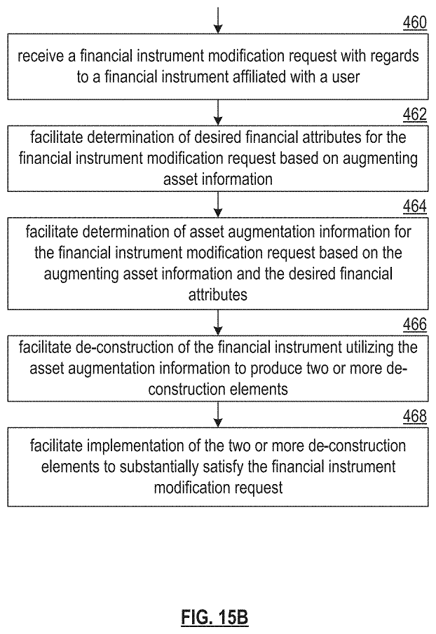

FIG. 15A is a schematic block diagram of another embodiment of a communication system that includes the augmentation system 14 of FIG. 1, the conversion server 16 of FIG. 1, the transactional server 18 of FIG. 1, and the control server 20 of FIG. 1. The augmentation system 14 includes the user device 32 of FIG. 1 and the augmentation server 24 of FIG. 1. The communication system functions to modify terms of a financial instrument.

In an example of operation of the modifying of the terms of the financial instrument, the conversion server 16 facilitates determination of desired financial attributes for a received financial instrument modification request 450 based on augmenting asset information 134. For example, the conversion server 16 forwards the modification request 450 and the augmenting asset information 134 received from the user device 32 to the control server 22 caused the control server 22 characterize financial information associated with the user device 32 to generate desired yield characteristics (e.g., dividends, similar payouts, payout timing, schedule of payments, financial holder demographics, mortality charts when applicable, instrument holder lifestyle information, etc.). As another example, the conversion server 16 performs the characterization of the financial information.

The conversion server 16 facilitates determination of asset augmentation information 138 based on the modification request 450 and the augmenting asset information 134. For example, the conversion server 16 causes the control server 22 identify a potential financial contribution of a financial instrument for modification, compares a contribution to the desired yield characteristics, identifies any additional required assets to combine with the financial instrument for modification to address a potential gap between the contribution and the desired yield characteristics, and selects a de-construction approach to enable a favorable de-construction with regards to the desired yield characteristics. As another example, the conversion server 16 directly determines the asset augmentation information 138.

Having produced the asset augmentation information 138, the control server facilitates de-construction of the financial instrument utilizing the asset augmentation information 138. For example, the conversion server 16 generates asset and liability partitioning information 140 to include asset title transfer information for utilization (e.g., by the transactional server 18) to enable any liability payments to an affiliate of the augmentation server 24 (e.g., associated with liability settlement information 142), and to facilitate distribution of funds to the user device 32 in accordance with received asset settlement information 144 and the asset and liability partitioning information 140 (e.g., the transactional server 18 issues modified asset distribution information 452 to the user device 32). The modified asset distribution information 452 includes one or more of payment terms, a one-time payment, an initial payment, a payment stream, a final payment, and sub-asset settlement information.

FIG. 15B is a logic diagram of an example of a method of modifying terms of a financial instrument within a communication system. In particular, a method is presented for use in conjunction with one or more functions and features described in conjunction with FIGS. 1-7C, 15A and also FIG. 15B. The method includes step 460 where a processing module of one or more computing devices (e.g., of one or more servers) receives a financial instrument modification request with regards to a financial instrument affiliated with a user. The receiving includes one or more of issuing a solicitation request, receiving a solicitation response that includes the financial instrument modification request, and receiving an unsolicited modification request.

The method continues at step 462 where the processing module facilitates determination of desired financial attributes for the financial instrument modification request based on augmenting asset information. For example, the processing module causes characterization of financial information associated with the request and characterization of the augmenting asset information to generate the desired financial attributes.

The method continues at step 464 for the processing module facilitates determination of asset augmentation information for the financial instrument modification request based on the augmenting asset information and the desired financial attributes. For example, the processing module identifies a potential financial contribution of the financial instrument for modification, compares the contribution to the desired financial characteristics, identifies any additional required assets to combine with the financial instrument for modification to address a potential gap between the contribution and the desired financial characteristics, and selects a de-construction approach to enable a favorable de-construction of the financial instrument and potentially more assets with regards to the desired financial characteristics.

The method continues at step 466 where the processing module facilitates de-construction of the financial instrument utilizing the asset augmentation information to produce two or more de-construction elements. The facilitating includes one or more of causing selection of a de-construction approach and causing an obligation (e.g., contractual) between parties to affect de-construction of the financial instrument in accordance with the asset augmentation information to produce the two or more de-construction elements (e.g., an affiliate of a transactional server is associated with a series of premium payments and a portion of a final payout and the users affiliated with one or more payments associated with the present value of another portion of the final payout).

The method continues at step 468 where the processing module facilitates implementation of the two or more de-construction elements to substantially satisfied the financial instrument modification request. The facilitating includes one or more of causing payment to the user utilizing value associated with at least one of the de-construction elements and causing a custodial entity to make any payment commitments associated with another de-construction element (e.g., a series of life insurance premium payments).

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

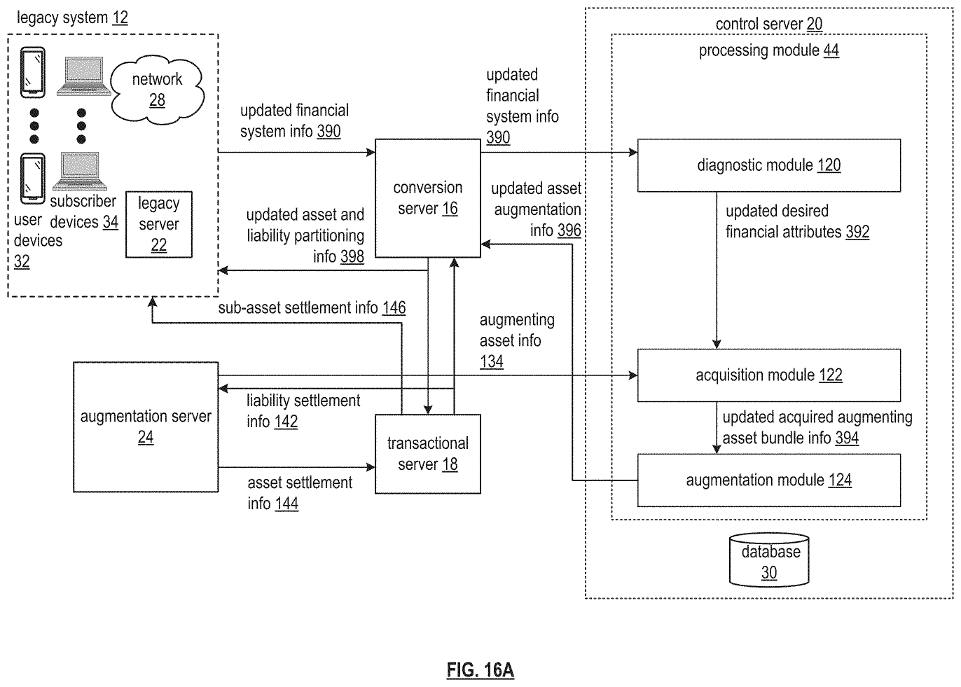

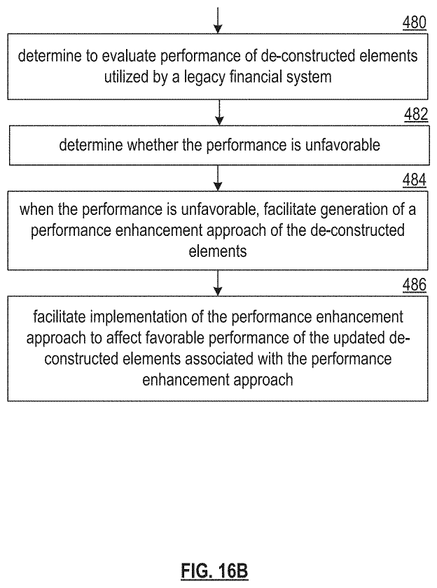

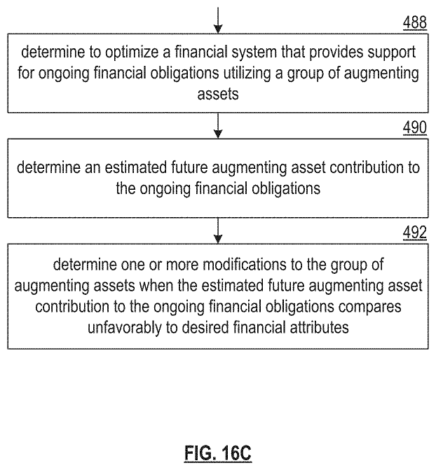

FIG. 16A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to evaluate performance of a financial system bundle.

In an example of operation of the evaluating of the performance of the financial system bundle, the conversion server 16 determines to evaluate performance of de-constructed elements utilized by the legacy system 12. The determining includes one or more of detecting expiration of an evaluation timeframe, interpreting updated financial system information 390 as unfavorable, and detecting an unfavorable the of liability settlement information 142 when the performance does not meet performance goals of the legacy system 12.

When the performance is unfavorable, the conversion server 16 facilitates generation of a performance enhancement approach of the de-constructive elements. The facilitating includes one or more of causing the control server 20 to produce updated asset augmentation information 396 based on the updated financial system information 390 and augmenting asset information 134 by sending the updated financial system information 390 to the diagnostic module 120, where the diagnostic module 120 generates updated desired financial attributes 392 (e.g., identify current assets, characterized performance), causing the acquisition module 122 to generate updated acquired augmenting asset bundle information 394 based on the updated desired financial attributes 392 and the augmenting asset information 134 received from the augmentation server 24 (e.g., extracting candidate asset characteristics, selecting a combination of new and present assets to address the unfavorable forms), and causing the augmentation module 124 to generate the updated asset augmentation information 396 based on the updated acquired augmenting asset bundle information 394 (e.g., design a new augmentation bundle, generating title transfer information including selling one or more current assets in acquiring one or more new assets).

The control server 16 facilitates implementation of the performance enhancement approach to affect favorable formants of updated de-constructed elements associated with the performance enhancement approach. The facilitating includes one or more of issuing updated asset and liability partitioning information 398 based on the updated asset augmentation information 396 to the transactional server 18, where the transactional server 18 issues further sub-asset settlement information 146 to the legacy system 12 based on received asset settlement information 144 from the augmentation server 24.

FIG. 16B is a logic diagram of an example of a method of evaluating performance of the financial system bundle within a communication system. In particular, a method is presented for use in conjunction with one or more functions and features described in conjunction with FIGS. 1-7C, 16A and also FIG. 16B. The method includes step 480 where a processing module of one or more computing devices (e.g., of one or more servers) determines to evaluate performance of de-constructed elements utilized by a legacy financial system. The determining includes one or more of detecting expiration of an evaluation timeframe, interpreting updated financial system information as unfavorable, and detecting an unfavorable payment information associated with the de-constructed elements to the legacy financial system.

The method continues at step 482 where the processing module determines whether the performance is unfavorable. The determining includes identifying an unfavorable gap between actual performance of the de-constructed elements and financial goals of the updated financial system information. When the performance is unfavorable, the method continues at step 484 where the processing module facilitates generation of a performance enhancement approach of the de-constructed elements. For example, the processing module causes generation of updated asset augmentation information based on the updated financial system information and augmenting asset information, causes generation of updated desired financial attributes, causes generation of updated acquired augmenting asset bundle information based on the updated desired financial attributes in the augmenting asset information, causes a selection of a combination of new assets and present assets to address the unfavorable performance, and causes generation of the performance enhancement approach to include updated asset augmentation information (e.g., combination of old and new assets) and asset title transfer information (e.g., sell, buy).

The method continues at step 486 where the processing module facilitates implementation of the performance enhancement approach to affect favorable performance of the updated de-constructed elements associated with the performance enhancement approach. For example, the processing module issues updated asset and liability partitioning information based on the updated asset augmentation information to cause issuing of further sub-asset settlement information to the legacy financial system based on received asset settlement information.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

FIG. 16C is a logic diagram of an example of a method of optimizing performance of a financial system within a communication system. In particular, a method is presented for use in conjunction with one or more functions and features described in conjunction with FIGS. 1-7C, 16A and also FIG. 16B. The method includes step 488 where a processing module of one or more computing devices (e.g., of one or more servers) determines to optimize a financial system. The financial system is to provide favorable support for ongoing financial obligations in accordance with desired financial attributes. For instance, providing monthly pension benefit payments with certainty to retirees associated with a pension system.

The financial system includes an augmenting asset bundle to augment other investments of the financial system. For instance, the augmenting asset bundle includes a pool of life settlement policies and the other investments includes various investment types including stocks, bonds, real estate, etc. The augmenting asset bundle includes a group of augmenting assets (i.e., a pool of life settlement policies). Each augmenting asset is associated with a corresponding future time-estimated benefit payment (e.g., a life settlement death benefit) and with a corresponding series of time-certain obligated payments (e.g., a series of life settlement premium payments).

A first percentage of an aggregate of future time-estimated benefit payments provides an augmenting asset contribution to the ongoing financial obligations. For example, cash thrown off from death benefits of the pool of life settlement policies help support the ongoing financial obligations.

A second percentage of the aggregate of the future time-estimated benefit payments provides an offset for an aggregate of each series of time-certain obligated payments. For example, a pension sponsor receives the second percentage of the benefit payments to help offset their commitment to pay premium payments for the pool of life settlement policies.

A remaining percentage of the aggregate of the future time-estimated benefit payments provides coverage for additional expenses. The additional expenses include one or more services to optimize performance of the pool of life settlement policies and facilitating payments when a death benefit occurs.

The desired financial attributes include one or more of a desired cash flow level associated with the ongoing financial obligations, a desired timing of the desired cash flow, a current valuation of the financial system, a desired valuation of the financial system, a desired valuation enhancement of the financial system, a desired minimum rate of return for the financial system, and a maximum risk level for the financial system. For example, the desired cash flow level associated with the ongoing financial obligations includes an aggregate of monthly pension payments. As another example, the desired timing of the desired cash flow includes a sufficient number of death benefit payments occurring at regular intervals.

The processing module selects the group of augmenting assets from available augmenting assets to produce the augmenting asset bundle by a variety of approaches. A first approach includes identifying the group of augmenting assets associated with favorable support of a desired cash flow level for the plurality of ongoing financial obligations (e.g., provide enough cash to pay the pension benefits). A second approach includes identifying the group of augmenting assets associated with a desired timing of the desired cash flow level for the ongoing financial obligations. For example, selecting the best available life settlement policies.

A third approach to select the group of augmenting assets includes identifying the group of augmenting assets associated with a desired valuation of the financial system. For instance, adding up the expected valuations of the life settlement policies to determine if a favorable impact on the valuation of the financial system can be achieved. A fourth approach includes identifying the group of augmenting assets associated with a desired minimum rate of return for the augmenting asset contribution to the plurality of ongoing financial obligations (e.g., meeting a target return on investment level). A fifth approach includes identifying the group of augmenting assets associated with a desired maximum risk level for the augmenting asset bundle. For example, identifying life settlement policies from highly rated life insurance companies.

The processing module determines the first percentage of the aggregate of future time-estimated benefit payments by one or more of a variety of approaches. A first approach includes selecting a number of augmenting assets of the augmenting asset bundle such that a sum of fair market values of the selected augmenting assets compares favorably to a desired valuation enhancement of the financial system. For example, selecting the number of augmenting assets of the augmenting asset bundle such that such that a sum of fair market values of each remaining augmenting asset of remaining augmenting assets compares favorably to a sum of an aggregate of each of the series of time-certain obligated payments associated with the augmenting asset bundle.

The processing module determines to optimize the financial system by one or more approaches. A first approach includes detecting unfavorable performance of the financial system with regards to the desired financial attributes. For example, the processing module detects an inability to pay the monthly pension payments. As another example, the processing module detects that the death benefits are occurring later than expected. A second approach includes detecting that an optimization timeframe has expired. For example, the processing module detects that a weekly timer has expired indicating that it is time to reevaluate the financial system. The third approach includes interpreting an optimization request. For example, the processing module receives a manual request to begin the optimization of the financial system.

The method continues at step 490 where the processing module determines an estimated future augmenting asset contribution to the ongoing financial obligations based on an estimated first percentage of the aggregate of future time-estimated benefit payments. The determining of the contribution includes a series of steps. A first step includes obtaining operational parameters associated with an augmenting asset of the group of augmenting assets. The operational parameters, i.e., facts, includes one or more of age of an insured party, previous life expectancy of the insured party, face value of a life insurance policy, associated obligated payments, past and current medical status of the insured party, terms of the life insurance policy, and demographics of the insured party.

A second step of determining the contribution includes estimating a timing aspect of the corresponding future time-estimated benefit payment of the augmenting asset based on the operational parameters. For example, the processing module reevaluates the life expectancy of the insured party based on one or more of historical timing information of past time estimated benefit payments versus originally forecasted, current medical status of injured party, the previous life expectancy of insured party, an input from a medical expert, an input from a life settlement expert, and updated life expectancy estimations based on current medical practices. For instance, the processing module determines to add six months to the life expectancy of the insured party based on the current medical status and input from the medical expert.

A third step of determining the contribution includes determining an estimated contribution value (e.g., future value, present value) of the corresponding future time-estimated benefit payment of the augmenting asset based on the timing aspect (e.g., estimated future date of the benefit payment) of the corresponding future time-estimated benefit payment of the augmenting asset, the first percentage, and the operational parameters associated with the augmenting asset (e.g., face value) to produce the estimated future augmenting asset contribution. For example, the processing module determines to lower the present value based on the increased life expectancy.

The method continues at step 492 where the processing module determines one or more modifications to the augmenting asset bundle when the estimated future augmenting asset contribution to the plurality of ongoing financial obligations compares unfavorably to the desired financial attributes. The determining includes a variety of approaches. A first approach includes detecting that the estimated future augmenting asset contribution to the plurality of ongoing financial obligations is less than a desired cash flow level of the desired financial attributes (e.g., generating less cash than desired). For example, the processing module detects that the augmenting asset is underperforming.

A second approach to determining modifications includes detecting that a timing aspect of the estimated future augmenting asset contribution to the plurality of ongoing financial obligations compares unfavorably to a desired timing profile of the desired financial attributes (e.g., too late too often). For example, the processing module determines that the extended life expectancy has a negative impact on paying the monthly pension payments.

A third approach to determining modifications includes modifying the first percentage of the aggregate of future time-estimated benefit payments to produce an updated estimated future augmenting asset contribution to the ongoing financial obligations that is greater than or equal to the desired cash flow level of the desired financial attributes. For example, the processing module raises the percentage to raise the augmenting asset contribution.

A fourth approach to determining modifications includes selecting an undesired augmenting asset for removal from the group of augmenting assets when an estimated value of the corresponding future time-estimated benefit payment of the undesired augmenting asset compares unfavorably to a desired asset value. For example, the processing module removes the undesired augmenting asset from the augmenting asset bundle when the value of the undesired augmenting asset is too high or too low.

A fifth approach to determining modifications includes modifying the group of augmenting assets to include an incremental augmenting asset when an estimated value of the corresponding future time-estimated benefit payment of the incremental augmenting asset compares favorably to the desired asset value. For example, the processing module replaces an augmenting asset with another augmenting asset to bolster the value of the augmenting asset bundle.

Alternatively, or in addition to, the determining the modifications further includes detecting availability of a first future time-estimated benefit payment of the first percentage of the aggregate of future time-estimated benefit payments. For example, the processing module receives a death benefit notification. When detecting the availability, the processing module facilitates a payment transaction of the first future time-estimated benefit payment from an associated payer to the financial system. For example, the processing module requests an electronic payment from a corresponding life insurance company and initiates an electronic payment of the first percentage of the payment to the pension system and another electronic payment of the second percentage of the payment to the pension sponsor.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

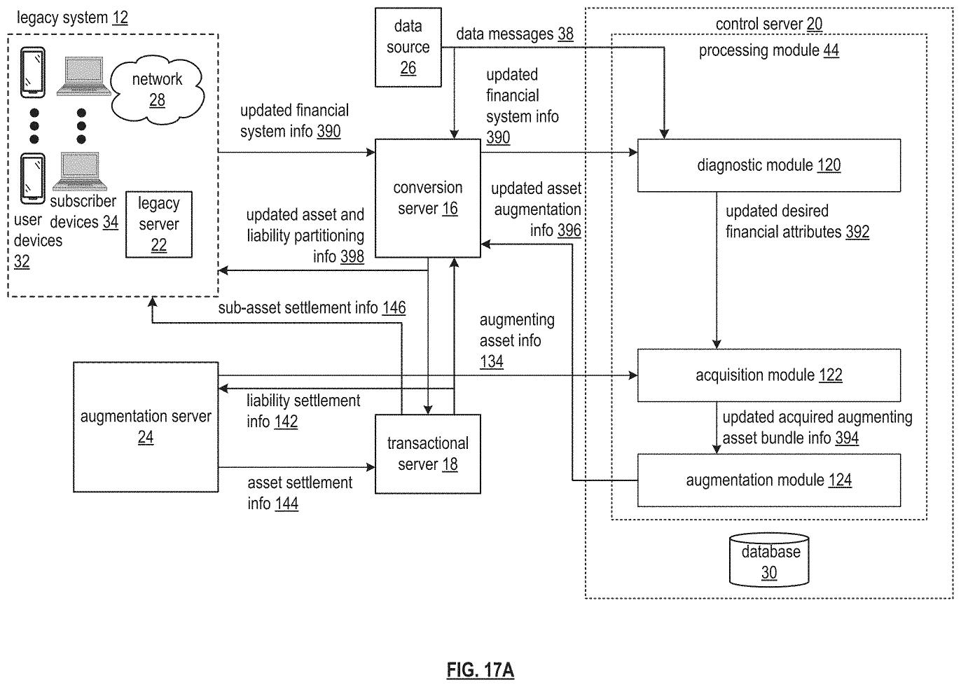

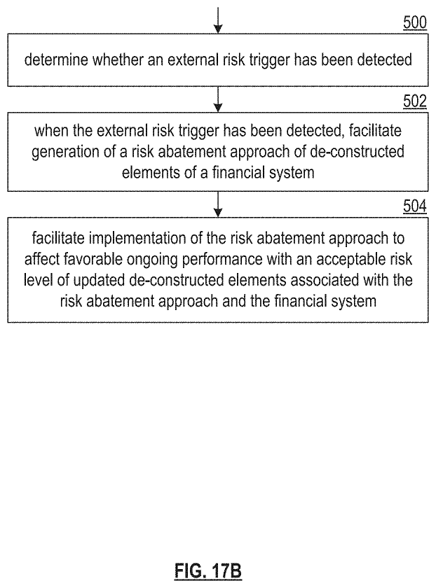

FIG. 17A is a schematic block diagram of another embodiment of a communication system that includes the legacy system 12 of FIG. 1, the conversion server 16 of FIG. 1, the transactional server 18 of FIG. 1, the augmentation server 24 of FIG. 1, the data source 26 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to detect a shift in a financial system.

In an example of operation of the detecting of the shift in the financial system, the conversion server 16 determines whether an external risk trigger has been detected. For example, the conversion server 16 obtains data messages 38 from the data source 26, analyzes the data messages 38, compares analysis of the data messages to one or more risk threshold levels, and indicates the external risk trigger when the comparison is unfavorable (e.g., performance of an associated life insurance company has dropped below a minimum performance threshold level).

When the external risk trigger has been detected, the conversion server 16 facilitates generation of a risk abatement approach of de-constructed elements associated with a financial system to support the legacy system 12. For example, the conversion server 16 causes the control server 20 to produce updated asset augmentation information 396 based on one or more of the data messages 38, updated financial system information 390, and augmenting asset information 134 by sending the updated financial system information 390 received from the legacy system 12 to the diagnostic module 120, where the diagnostic module 120 generates updated desired financial attributes 392 (e.g., identify current assets, characterized performance), causes the acquisition module 122 to generate updated acquired augmenting asset bundle information 394 based on the updated desired financial attributes 392 and the augmenting asset information 134 received from the augmentation server 24 (e.g., extract candidate asset characteristics select a combination of new and present assets to address the external trigger), and causes the augmentation module 124 to generate the updated asset augmentation information 396 based on the updated acquired augmenting asset bundle information 394 (e.g., design a new augmenting asset bundle, generate title transfer information including selling one or more current assets in acquiring one or more new assets).

The conversion server 16 facilitates implementation of the risk abatement approach to affect favorable on-going performance within acceptable risk level of updated de-constructed elements associated with the risk abatement approach. For example, the conversion server 16 issues updated asset and liability partitioning information 398, based on the updated asset augmentation information 396, to the transactional server 18, where the transactional server 18 issues further sub-asset settlement information 146 to the legacy system 12 based on received asset settlement information 144 from the augmentation server 24, where the transactional server 18 issues liability settlement information 142 to the augmentation server 24.

FIG. 17B is a logic diagram of an example of a method of detecting a shift in a financial system within a communication system. In particular, a method is presented for use in conjunction with one or more functions and features described in conjunction with FIGS. 1-7C, 17A and also FIG. 17B. The method includes step 500 where a processing module of one or more computing devices (e.g., of one or more servers) determines whether an external risk trigger has been detected for a financial system. For example, the processing module obtains data messages associated with potential external risks, analyzes the data messages, compares the analysis of the data messages to one or more risk threshold levels, and indicates the external risk trigger when the comparison is unfavorable (e.g., performance associated financial custodian company has dropped below a minimum performance threshold level expected by the financial system).

When the external risk trigger has been detected, the method continues at step 502 where the processing module facilitates generation of a risk abatement approach of de-constructed elements of the financial system. For example, the processing module causes generation of updated asset augmentation information based on one or more of the data messages, updated financial system information, and augmenting asset information, causes generation of updated desired financial attributes, causes generation of updated acquired augmenting asset bundle information based on the updated desired financial attributes and the augmenting asset information (e.g., extract candidate asset characteristics, select a combination of new and present assets to address the external risk trigger), and causes generation of the updated asset augmentation information based on the updated acquired augmenting asset bundle information (e.g., design a new augmenting asset bundle, generate title transfer information which may include selling one or more current assets in acquiring one or more new assets).

The method continues at step 504 where the processing module facilitates implementation of the risk abatement approach to affect favorable ongoing performance with an acceptable risk level of updated de-constructed elements associated with the risk abatement approach and the financial system. For example, the processing module issues updated asset and liability partitioning information based on the updated asset augmentation information, causes issuance of further sub-asset settlement information based on received asset settlement information, and further causes issuance of liability settlement information.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

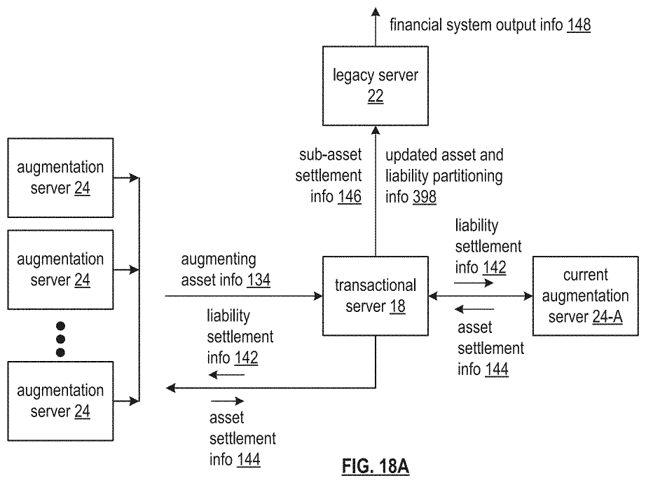

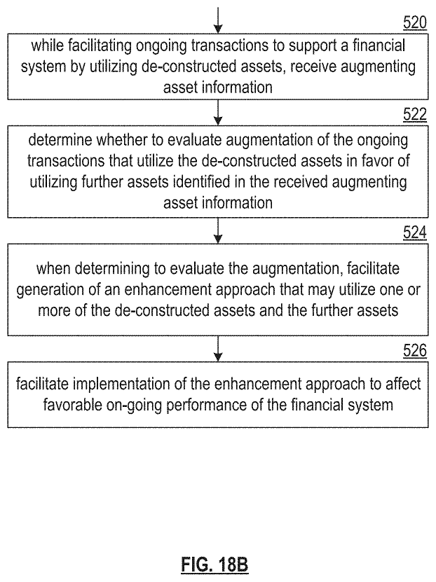

FIG. 18A is a schematic block diagram of another embodiment of a communication system that includes a plurality of augmentation servers 24 of FIG. 1, the legacy server 22 of FIG. 1, the transactional server 18 of FIG. 1, and a current augmentation server 24-A. The current augmentation server 24-A may be implemented utilizing the augmentation server 24 of FIG. 1. The communication system functions to update an acquired augmenting asset bundle.

In an example of operation of the updating of the acquired augmenting asset bundle, the transactional server 18, while facilitating ongoing transactions to support a legacy financial system associated with the legacy server 22 by utilizing de-constructed assets, receives augmenting asset information 134 from one or more of the plurality of augmentation servers 24. The facilitating of the ongoing transactions includes the transactional server 18 issuing liability settlement information 142 to the current augmentation server 24-A, receiving asset settlement information 144 from the current augmentation server 24-A, and issuing sub-asset settlement information 146 to the legacy server 22, where the legacy server 22 issues financial system output information 148 to support the legacy financial system cash flow requirements. The receiving of the augmenting asset information 134 includes receiving the augmenting asset information 134 in response to one or more of a query, an unsolicited request, expiration of a timeframe, detection of unfavorable performance, and detection of an unfavorable level of risk for the financial system.

The transactional server 18 determines whether to evaluate augmentation of the utilization of the de-constructed assets in favor of utilizing further or other assets identified in the received augmenting asset information 134. The determining may be based on one or more of detecting that an evaluation time frame has expired, detecting an unfavorable level of performance, detecting an unfavorable level of risk, and detecting that new financial goals associated with the legacy financial system have been introduced.

When evaluating augmentation, the transactional server 18 facilitates generation of an enhancement approach of the de-constructed elements. For example, the transactional server 18 produces updated asset augmentation information based on one or more of updated financial system information and the augmenting asset information 134, generates updated desired financial attributes (e.g., identify current assets, characterize performance), generates updated acquired augmenting asset bundle information based on the updated desired financial attributes and the augmenting asset information 134 received from the plurality of augmentation servers 24 (e.g., extract candidate asset characteristics, select a combination of new and present assets to address the external trigger, select a prepackaged bundle), and generates the updated asset augmentation information based on the updated acquired augmenting asset bundle information (design a new augmenting asset bundle, generate title transfer information including selling one or more current assets and acquiring one or more new assets).

The transactional server 18 facilitates implication of the enhancement approach to affect favorable un-going performance. For example, the transactional server 18 issues updated asset and liability partitioning information 398 to the legacy server 22 based on the updated asset augmentation information, and issues further sub-asset settlement information 146 to the legacy server 22 based on received asset settlement information 144 from another augmentation server 24 of the plurality of augmentation servers 24, where the transactional server 18 issues liability settlement information 142 to the other augmentation server 24.

FIG. 18B is a logic diagram of another example of a method of updating an acquired augmenting asset bundle within a communication system. In particular, a method is presented for use in conjunction with one or more functions and features described in conjunction with FIGS. 1-7C, 18A and also FIG. 18B. The method includes step 520 where a processing module of one or more computing devices (e.g., of one or more servers), while facilitating ongoing transactions to support a financial system by utilizing de-constructed assets, receives augmenting asset information. The issuing includes one or more of issuing liability settlement information, receiving asset settlement information, and issuing sub-asset settlement information. The receiving includes one or more of receiving the augmenting asset information in response to one or more of a query, an unsolicited request, upon detection of expiration of a timeframe, upon detection of an unfavorable performance level, and upon detection of an unfavorable level of risk associated with the financial system.

The method continues at step 522 where the processing module determines whether to evaluate augmentation of the ongoing transactions that utilize the de-constructed assets in favor of utilizing further assets identified in the received augmenting asset information. The determining includes one or more of detecting that an evaluation time frame is expired, detecting an unfavorable level of performance, detecting an unfavorable level of risk, and receiving updated financial goals associated with the legacy financial system.

When determining to evaluate the augmentation, the method continues at step 524 for the processing module facilitates generation of an enhancement approach that may utilize one or more of the de-constructed assets and further assets. The facilitating includes one or more of producing updated asset augmentation information based on one or more of the updated financial system information and the augmenting asset information, generating updated desired financial attributes, generating updated acquired augmenting asset bundle information based on the updated desired financial attributes and the augmenting asset information (e.g., extract candidate asset characteristics, select a combination of new and present assets to address the present financial needs of the financial system, select a prepackaged bundle), and generating the updated asset augmentation information based on the updated acquired augmenting asset bundle information (e.g., design a new augmenting asset bundle, generate title transfer information including selling one or more current assets and acquiring one or more new assets).

The method continues at step 526 where the processing module facilitates implementation of the enhancement approach to affect favorable ongoing performance of the financial system. For example, the processing module issues updated asset and liability partitioning information based on the updated asset augmentation information, issues further sub-asset settlement information based on received asset settlement information from another augmentation server, and issues liability settlement information to the other augmentation server.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

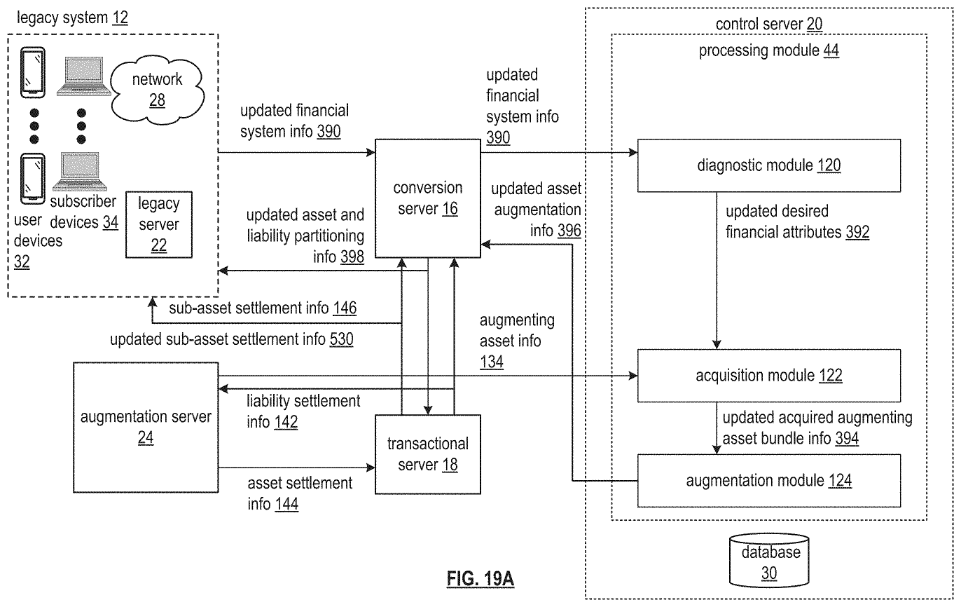

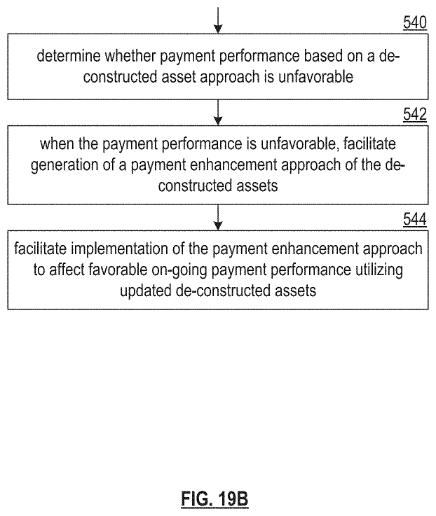

FIG. 19A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to enhance payments of the financial system.

In an example of operation of the enhancing of the payments, the conversion server 16 determines whether a payment performance to the legacy system 12 is unfavorable, where payments are based on a de-constructed asset approach. The determining includes comparing sub-asset settlement information 146 to expected payment levels, and indicating unfavorable when the comparison is unfavorable (e.g., payments shrinking too fast, payments taking too long, underpayments, etc.).

When the payment performance is unfavorable, the conversion server 16 facilitates generation of a payment enhancement approach of the de-constructed assets. The facilitating includes one or more of causing the control server 20 to produce updated asset augmentation information 396 based on one or more of the sub-asset settlement information 146, updated financial system information 390 (e.g., received from the legacy system 12), and augmenting asset information 134, by sending the updated financial system information 390 to the diagnostic module 120, where the diagnostic module 128 generates updated desired financial attributes 392, causing the acquisition module 122 to generate updated acquired augmenting asset bundle information 394 based on the updated desired financial attributes 392 and the augmenting asset information 134 received from the augmentation server 24 (e.g., extract candidate asset characteristics, select a combination of new and present assets to address the unfavorable performance), and causing the augmentation module 124 to generate the updated asset augmentation information 396 based on the updated acquired augmenting asset bundle information 394 (e.g., design a new augmenting asset bundle, generate title transfer information including selling one or more current assets and acquiring one or more new assets).

The conversion server 16 facilitates and limitation of the payment enhancement approach to affect favorable ongoing payment performance utilizing updated de-constructed elements associated with the payment enhancement approach. The facilitating includes the conversion server 16 issuing updated asset and liability partitioning information 398 based on the updated asset augmentation information 396, where the conversion server 16 sends the updated asset and liability partitioning information 398 to the transactional server 18, and where the transactional server 18 issues updated sub-asset settlement information 530 to the legacy system 12 based on received asset settlement information 144 from the augmentation server 24 in response to liability settlement information 142 issued by the transactional server 18 to the augmentation server 24.

FIG. 19B is a logic diagram of an example of a method of enhancing payments of a financial system within a communication system. In particular, a method is presented for use in conjunction with one or more functions and features described in conjunction with FIGS. 1-7C, 19A and also FIG. 19B. The method includes step 540 where a processing module of one or more computing devices (e.g., of one or more servers) determines whether payment performance based on a de-constructed asset approach is unfavorable. The determining includes comparing sub-asset settlement information associated with payments to expected payment levels and indicating unfavorable when the comparison is unfavorable (e.g., shrinking payments, payments taking too long, etc.).

When the payment performance is unfavorable, the method continues at step 542 where the processing module facilitates generation of a payment enhancement approach of the de-constructed assets. For example, the processing module produces updated asset augmentation information based on one or more of the sub-asset settlement information, updated financial system information, and augmenting asset information, where desired financial attributes are generated based on the updated financial system information, causes generation of updated acquired augmenting asset bundle information based on the updated desired financial attributes and the augmenting asset information, and causes generation of the updated asset augmentation information based on the updated acquired augmenting asset bundle information.

The method continues at step 544 where the processing module facilitates implementation of the payment enhancement approach to affect favorable ongoing payment performance utilizing updated de-constructed assets. The facilitating includes issuing updated asset and liability partitioning information based on the updated asset augmentation information, causing issuing of updated sub-asset settlement information based on asset settlement information, and causing issuing of liability settlement information.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

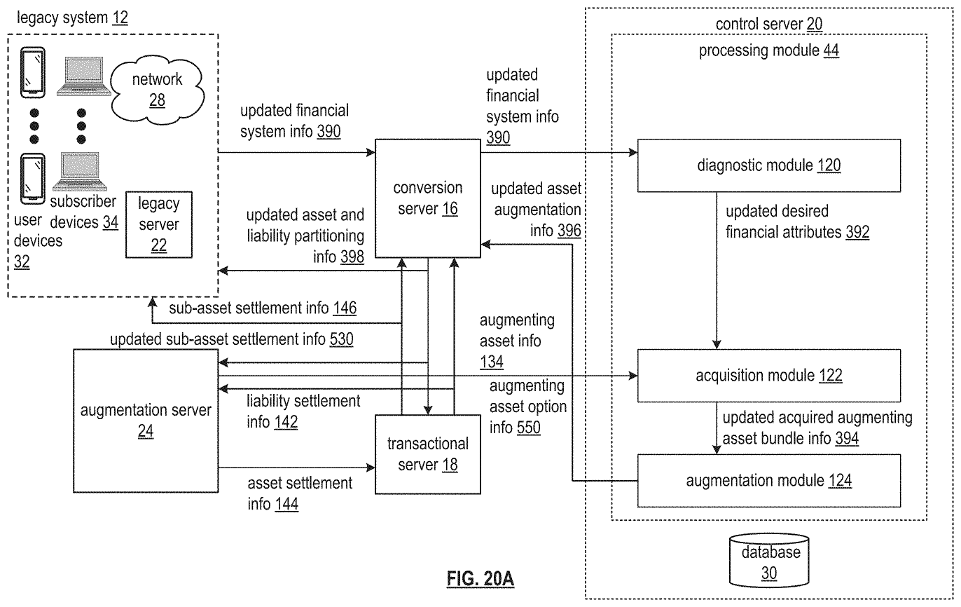

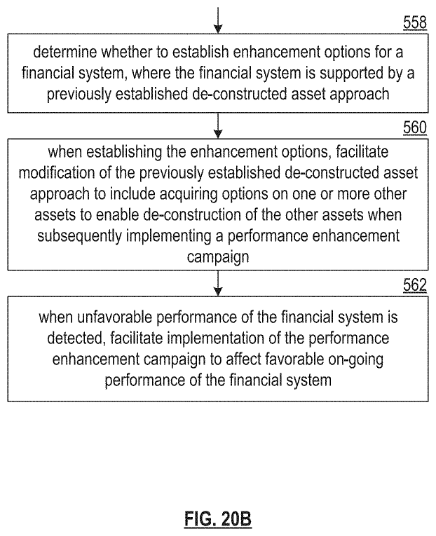

FIG. 20A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to acquire augmenting assets.

In an example of operation of the acquiring of the augmenting assets, the conversion server 16 determines whether to establish enhancement options for financial system, where the financial system is supported by a previously established de-constructed asset approach. The determining includes one or more of detecting that a reevaluation time frame has expired, detecting unfavorable performance of the financial system, and receiving an enhancement option solicitation (e.g., from the augmentation server 24).

When establishing the enhancement options, the conversion server 16 facilitates modification of the previously established de-constructed asset approach to include acquiring options on one or more other assets to enable subsequent de-construction of the other assets when implementing a performance enhancement campaign. In an example of the facilitating, the conversion server 16 causes the control server 20 to produce updated asset augmentation information 396 based on one or more of sub-asset settlement information 146, updated financial system information 390, and augmenting asset option information 550 by sending the updated financial system information 392 the diagnostic module 120, where the diagnostic module 120 generates updated desired financial attributes 392 (e.g., identify current assets, characterized performance), the acquisition module 122 generates updated acquired augmenting asset bundle information 394 based on the updated desired financial attributes 392 and the augmenting asset option information 550 received from the augmentation server 24 (e.g., extract candidate asset options characteristics, select a combination of new options and present assets to address subsequent potential and favorable performance), and the augmentation module 124 generates the updated asset augmentation information 396 based on the updated acquired augmenting asset bundle information 394 (e.g., designing new augmentation bundle, generate title transfer information should the options be exercised including selling one or more current assets and exercising purchasing options to acquire one or more new assets). The augmenting asset option information 550 includes one or more of the augmenting asset information 134, options pricing, options availability, asset bundles associated with various options, etc. Alternatively, or in addition to, the control server 23 issues further updates to the updated asset augmentation information 396 to the conversion server 16 in accordance with a schedule (e.g., substantially continuously, at predetermined time frames, etc.).

When unfavorable performance of the financial system is detected, the conversion server 16 facilitates implementation of the performance enhancement campaign to affect favorable ongoing performance of the financial system. For example, the conversion server 16 indicates unfavorable performance when detecting that a difference between actual performance and desired performance is greater than a performance gap threshold level, issues updated asset and liability partitioning information 398 to the legacy system 12 based on the updated asset augmentation information 396 and causes exercising the one or more options of the one or more assets by sending the updated asset and liability partitioning information 398 to the transactional server 18 and the augmentation server 24, where the augmentation server 24 receives liability settlement information 142 from the transactional server and issues asset settlement information 144 to the transactional server 18, and where the transactional server 18 issues updated sub-asset settlement information 530 to legacy system 12 based on the asset settlement information 144 (e.g., where the updated sub-asset settlement information 530 is based on exercising of one or more of the options).

FIG. 20B is a logic diagram of another example of a method of acquiring augmenting assets within a communication system. In particular, a method is presented for use in conjunction with one or more functions and features described in conjunction with FIGS. 1-7C, 20A and also FIG. 20B. The method includes step 558 where a processing module of one or more computing devices (e.g., of one or more servers) determines whether to establish enhancement options for a financial system, where the financial system is supported by a previously established de-constructed asset approach. The determining may include one or more of detecting that a reevaluation time frame has expired, detecting unfavorable performance of the financial system, and receiving an enhancement option solicitation.

When establishing the enhancement options, the method continues at step 560 where the processing module facilitates modification of the previously established de-constructed asset approach to include acquiring options on one or more other assets to enable de-construction of the other assets when subsequently implementing a performance enhancement campaign. For example, the processing module causes production of updated asset augmentation information based on one or more of sub-asset settlement information updated financial system information, and augmenting asset option information, causes generation of updated desired financial attributes, causes generation of updated acquired augmenting asset bundle information based on the updated desired financial attributes and the augmenting asset option information (e.g., extract candidate asset options characteristics, select a combination of new options and present assets to address subsequent potential unfavorable performance), and causes generation of the updated asset augmentation information based on the updated acquired augmenting asset bundle information (e.g., designing new augmenting bundle, generate title transfer information should the options be exercised including selling one or more current assets and exercising purchase options to acquire one or more new assets).

When unfavorable performance of the financial system is detected, the method continues at step 562 where the processing module facilitates implementation of the performance enhancement campaign to affect favorable ongoing performance of the financial system. The facilitating includes one or more of indicating unfavorable performance when detecting that a difference between actual performance and desire performance is greater than a performance gap threshold level, causing issuing of updated asset and liability partitioning information based on the updated asset augmentation information to cause exercising the one or more options on the one or more other assets, causing sending of the updated asset augmentation information to cause issuing of updated sub-asset settlement information to the financial system based on received asset settlement information, and causing issuing of liability settlement information to enable generation and sending of the updated sub-asset settlement information

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

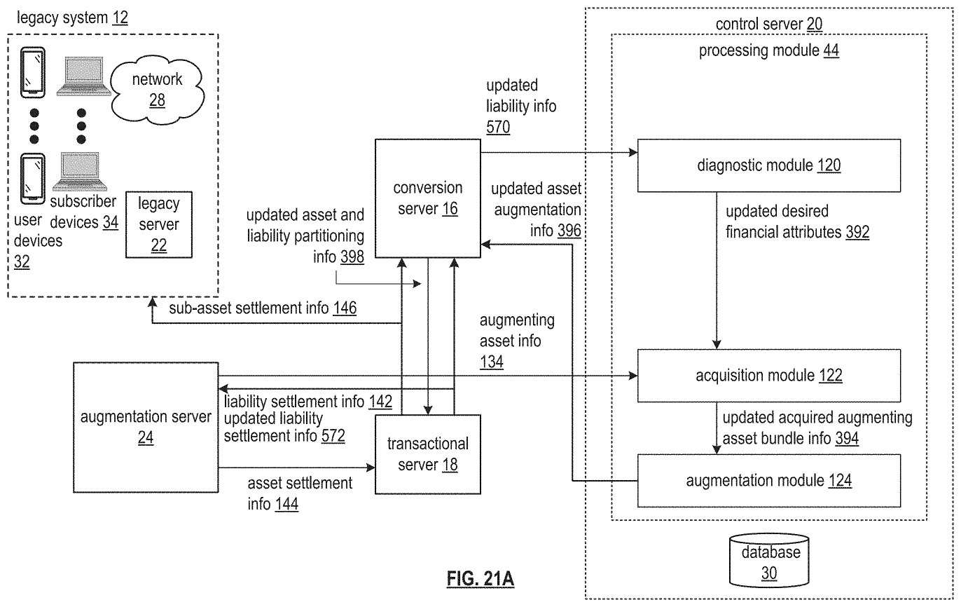

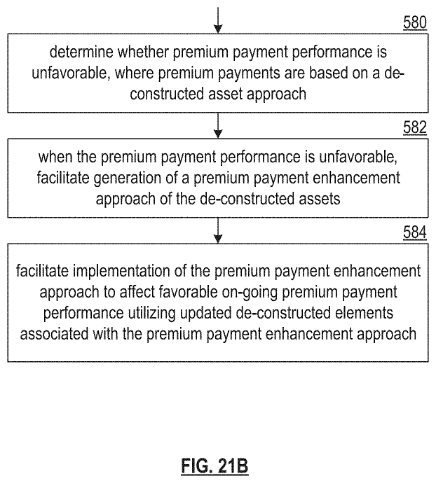

FIG. 21A is a schematic block diagram of another embodiment of a communication system that includes the legacy system 12 of FIG. 1, the conversion server 16 of FIG. 1, the transactional server 18 of FIG. 1, the augmentation server 24 of FIG. 1, and the control server 20 of FIG. 1. The legacy system 12 includes a portion of the network 28 of FIG. 1, the plurality of user devices 32 of FIG. 1, the plurality of subscriber devices 34 of FIG. 1, and the legacy server 22 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to fund a financial system.

In an example of operation of the funding of the financial system, the conversion server 16 determines whether premium payment performance to the augmentation server 24 is unfavorable, where premium payments are based on a de-constructed asset approach. The determining includes one or more of comparing liability settlement information 142 to expected premium payment levels, indicating unfavorable when the comparison is unfavorable, and indicating unfavorable when an unfavorable risk factor is detected (e.g., premium payments shrinking, premium payments to taking too long, asset settlement information 144 inadequate to support the premium payments, etc.).

When the payment performance is unfavorable, the conversion server 16 facilitates generation of a premium payment enhancement approach of the de-constructed assets. For example, the conversion server 16 causes the control server 20 to produce updated asset augmentation information 396 (e.g., by sending updated liability information 570 to the diagnostic module 120) based on one or more of the liability settlement information 142 and augmenting asset information 134, where the diagnostic module 120 generates updated desired financial attributes 392 (e.g., identify current assets, characterize premium payment performance), causes the acquisition module 122 to generate updated acquired augmenting asset bundle information 394 based on the updated desired financial attributes 392 and the augmenting asset information 134 received from the augmentation server 24 (e.g., extract candidate asset characteristics, select a combination of new and present assets to address the unfavorable premium payment performance), and causes the augmentation module 124 to generate the updated asset augmentation information 396 based on the updated acquired augmenting asset bundle information 394 (e.g., designing new augmenting asset bundle for all or just the premium payments, generate title transfer information including selling one or more current assets and acquiring one or more new assets). The updated liability information 570 includes one or more of an underperformance of premium payment indicator, a required level indicator of actual premium payment information, and historical premium payment records.

Having generated the premium payment enhancement approach, the conversion server 16 facilitates implementation of the premium payment enhancement approach to affect favorable ongoing payment performance utilizing updated de-constructed elements associated with the premium payment enhancement approach. For example, the conversion server 16 issues updated asset and liability partitioning information 398 based on the updated asset augmentation information 396 to the transactional server 18, where the transactional server 18 issues updated liability settlement information 572 based on received asset settlement information 144 from the augmentation server 24.

FIG. 21B is a logic diagram of an example of a method of funding a financial system within a communication system. In particular, a method is presented for use in conjunction with one or more functions and features described in conjunction with FIGS. 1-7C, 21A and also FIG. 21B. The method includes step 580 where a processing module of one or more computing devices (e.g., of one or more servers) determines whether premium payment performance is unfavorable, where premium payments are based on a de-constructed asset approach. The determining includes one or more of comparing liability settlement information associated with premium payments to expected premium payment levels, indicating unfavorable when the comparison is unfavorable, indicating unfavorable when an unfavorable risk factor is detected (e.g., premium payments less than a desired premium payment level, premium payment timing longer than desired premium payment timing, and asset settlement information inadequate to support the premium payments, etc.).

When the premium payment performance is unfavorable, the method continues at step 582 where the processing module facilitates generation of a premium payment enhancement approach of the de-constructed assets. For example, the processing module causes producing of updated asset augmentation information based on one or more of the liability settlement information and augmenting asset information, causes generation of updated desired financial attributes (e.g., identify current assets, characterize premium payment performance), causes generation of updated acquired augmenting asset bundle information based on the updated desired financial attributes in the augmenting asset information (e.g., extract candidate asset characteristics, select a combination of new and present assets to address the unfavorable premium payment performance), and causes generation of the updated asset augmentation information based on the updated acquired augmenting asset bundle information (e.g., designing new augmenting asset bundle for all or just the premium payments, generate title transfer information including selling one or more current assets and acquiring one or more new assets).

The method continues at step 584 where the processing module facilitates implementation of the premium payment enhancement approach to affect favorable ongoing premium payment performance utilizing updated de-constructed elements associated with the premium payment enhancement approach. For example, the processing module issues updated asset and liability partitioning information based on the updated asset augmentation information and causes issuance of updated liability settlement information based on received asset settlement information.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

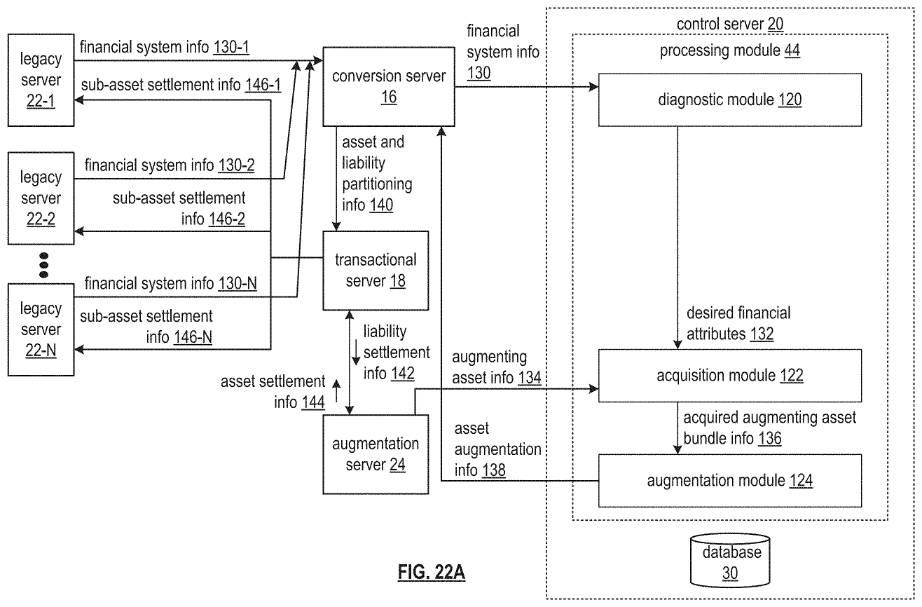

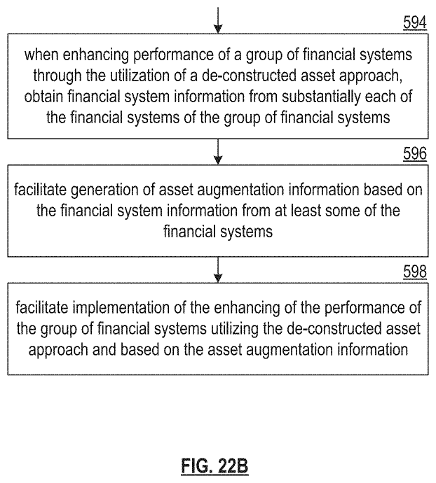

FIG. 22A is a schematic block diagram of another embodiment of a communication system that includes a plurality of legacy servers 22-1 through 22-N, the conversion server 16 of FIG. 1, the transactional server 18 of FIG. 1, the augmentation server 24 of FIG. 1, and the control server 20 of FIG. 1. Each of the plurality of legacy servers 22-1 through 22-N may be implemented utilizing the legacy server 22 of FIG. 1 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to enhance performance of a plurality of financial systems.

In an example of operation of the enhancing of the performance of the plurality financial systems, when enhancing the performance of the group of financial systems through the utilization of a de-constructed asset approach, the conversion server 16 obtains financial system information from each of the plurality of financial systems. For example, the conversion server 16 receives financial system information 130-1 from the legacy server 22-1 of a first financial system, receives financial system information 130-2 from the legacy server 22-2 of a second financial system, etc. The obtaining may further include interpreting a response to a query, interpreting a performance enhancement request, and performing a lookup.

Having obtained the financial system information, the conversion server 16 facilitates generation of asset augmentation information 138 based on the financial system information from at least some of the financial systems. For example, the conversion server 16 causes the diagnostic module 120 to produce desired financial attributes 132 based on financial system information 130 (e.g., an aggregate of the financial system information 130-1 through 130-N), where the diagnostic module 120 characterizes current performance and assets.

Having caused production of the desired financial attributes 132, the conversion server 16 causes the acquisition module 122 to generate acquired augmenting asset bundle information 136 based on the desired financial attributes 132 and augmenting asset information 134 (e.g., the acquisition module 122 extracts candidate asset characteristics, selects a combination of assets to meet the needs of the plurality of financial systems). Having caused the generation of the acquired augmenting asset bundle information 136, the conversion server 16 causes the augmentation module 124 to produce the asset augmentation information 138 based on the acquired augmenting asset bundle information 136 (e.g., the augmentation module 124 designs an augmenting asset bundle, generates title transfer information, and invokes acquisition of the selected assets).

Having facilitated the generation of the asset augmentation information 138, the conversion server 16 facilitates implementation of the enhancing of the performance of the group of financial systems. For example, the conversion server 16 issues asset and liability partitioning information 140 to the transactional server 18, where the conversion server 16 generates the asset and liability partitioning information 140 based on the asset augmentation information 138. The transactional server 18 issues liability settlement information 142 to the augmentation server 24 and receives asset settlement information 144 in response. Having received the asset settlement information 144, the transactional server 18 issues sub-asset settlement information to the plurality of legacy servers based on received asset settlement information 144. For example, the transactional server 18 issues sub-asset settlement information 146-1 to the legacy server 22-1, issues sub-asset settlement information 146-2 to the legacy server 22-2, etc.

FIG. 22B is a logic diagram of an example of a method of enhancing performance of a plurality of financial systems within a communication system. In particular, a method is presented for use in conjunction with one or more functions and features described in conjunction with FIGS. 1-7C, 22A and also FIG. 22B. The method includes step 594 where a processing module of one or more computing devices (e.g., of one or more servers), when enhancing performance of a group of financial systems through the utilization of a de-constructive asset approach, obtains financial system information from substantially each of the financial systems of the group of financial systems. The obtaining includes one or more of interpreting a response to a query, interpreting a performance enhancement request, and performing a lookup.

The method continues at step 596 where the processing module facilitates generation of asset augmentation information based on the financial system information from at least some of the financial systems. For example, the processing module causes producing desired financial attributes based on financial system information, causes producing acquired augmenting asset bundle information based on the desired financial attributes and augmenting asset information (e.g., extract candidate asset characteristics, select a combination of assets to meet needs of the group of financial systems), and causes producing asset augmentation information based on the acquired augmenting asset bundle information (e.g., design and augmenting asset bundle, generate title transfer information, invoke acquisition of selected assets).

The method continues at step 598 where the processing module facilitates implementation of the enhancing of the performance of the group of financial systems utilizing the de-constructed asset approach and based on the asset augmentation information. For example, the processing module issues asset and liability partitioning information based on the asset augmentation information to cause issuing of sub-asset settlement information to each of the group of legacy financial systems (e.g., to legacy servers) by causing issuing a liability settlement information and receiving of asset settlement information to generate the sub-asset settlement information.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

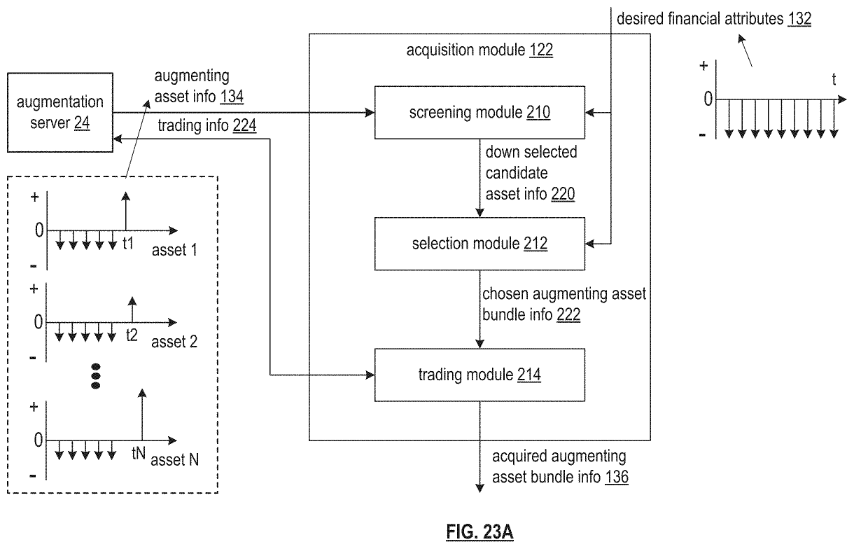

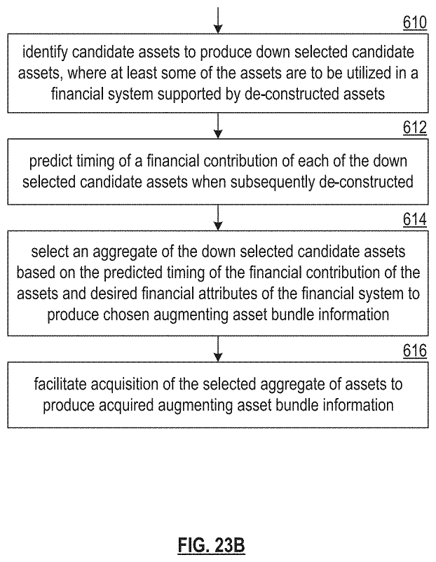

FIG. 23A is a schematic block diagram of another embodiment of a communication system that includes the augmentation server 24 of FIG. 1 and the acquisition module 122 of FIG. 4A. the acquisition module 122 includes the screening module 210 of FIG. 6A, the selection module 212 of FIG. 6A, and the trading module 214 of FIG. 6A. The communication system functions to match augmenting assets to payment commitments.

In an example of operation of the matching of the augmenting assets to the payment commitments, screening module 210 of the acquisition module 122 identifies candidate assets to produce down selected candidate assets 220. For example, the screen module 210 interprets augmenting asset information 134 to identify estimated time of payout characteristics of the candidate assets identifies required payout timing based on received desired financial attributes 132, and identifies down selected candidate assets when estimated payout timing of the candidate assets compares favorably to a portion of the required payout timing. For instance, the screening module 210 matches a group of assets from the augmenting asset information 134 by identifying required liabilities (e.g., premium payments as modeled by negative cash flows over time) and estimated asset benefits (e.g., estimated policy payouts at varying times over times t1, t2, through tN) to a series of payouts associated with the desired financial attributes 132 (e.g., negative cash flow payouts such as pension benefits) to produce the down selected candidate asset information 220.

Having identified the down selected candidate assets 220, the acquisition module 122 causes prediction of timing of a financial contribution of each of the down selected candidate assets when subsequently de-constructed. For example, the selection module 212 further identifies timing of the required liabilities and timing of the estimated asset benefits of each of the down selected assets of the candidate assets 1-N to produce the prediction of timing of the financial contributions of each of the down selected candidate assets, and estimates the financial contributions themselves based on one or more of current pricing, fair market evaluation (e.g., interpreting a data message from a data source), and historical information. Having identified the timing and the evaluation, the selection module 212 further matches aggregate timing of the assets to require timing of payouts of the desired financial attributes 132 over a varying range of timing and payout benefits (e.g., when the asset is a life insurance policy and the payout benefits are associated with a pension system).

Having predicted the timing of the financial contribution of each of the down selected candidate assets, the selection module 212 selects an aggregate of the down selected candidate assets based on the predicted timing of the financial contribution of the assets and the desired financial attributes 132 to produce chosen augmenting asset bundle information 222. For example, the selection module 212 selects assets where estimated financial contributions of the aggregate augmenting asset bundle compares favorably to the desired timing of cash flow of the required payout timing of the desired financial attributes 132.

Having selected the assets, the trading module 214 of the acquisition module and 22 facilitates acquisition (e.g., purchase) of the selected aggregate of assets of the augmenting asset bundle to produce acquired augmenting asset bundle information 136. The facilitating includes sending and receiving trading information 224 with the augmentation server 24 to confirm purchase pricing, pass-through funding in accordance with the purchase pricing, and confirm receipt and proper title to the newly acquired assets.

FIG. 23B is a logic diagram of an example of a method of matching augmenting assets to payment commitments within a communication system. In particular, a method is presented for use in conjunction with one or more functions and features described in conjunction with FIGS. 1-7C, 23A and also FIG. 23B. The method includes step 610 where a processing module of one or more computing devices (e.g., of one or more servers) identifies candidate assets to produce down selected candidate assets, where at least some of the assets are to be utilized in a financial system supported by de-constructed assets. The identifying includes one or more of interpreting augmenting asset information to identify estimated time of payout characteristics of the candidate assets, identifying required payout timing based on received desired financial attributes, identifying down selected candidate assets when estimated payout timing of the candidate assets compare favorably to a portion of the required payout timing.

The method continues at step 612 where the processing module protects timing of a financial contribution of each of the down selected candidate assets when subsequently de-constructed. The predicting may be based on one or more of actual pricing, fair market value estimation, and matching to the desired financial attributes over a varying range of timing of payout benefits when the asset is a financial instrument with payout benefits.

The method continues at step 614 where the processing module selects an aggregate of the down selected candidate assets based on the predicted timing of the financial contribution of the assets and desired financial attributes of the financial system to produce chosen augmenting asset bundle information, where estimated financial contributions of the aggregate augmenting asset bundle compares favorably to the desired timing of cash flows of the required payout timing. The method continues at step 616 where the processing module facilitates acquisition of the selected aggregate of assets to produce acquired augmenting asset bundle information. For example, the processing module sends and receives trading information to confirm purchase pricing and passes through funding in accordance with the purchase pricing followed by confirmation of receipt and title.

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

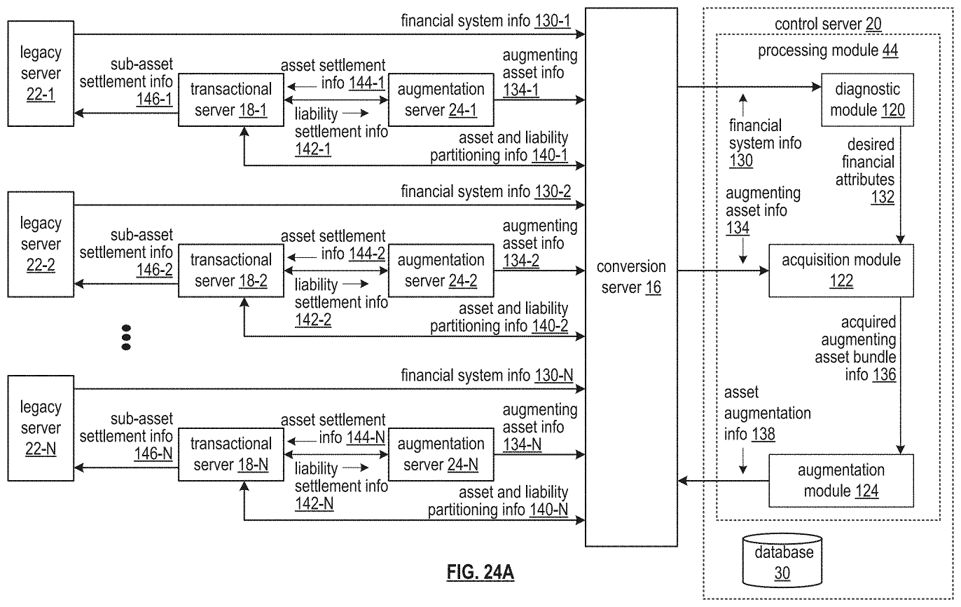

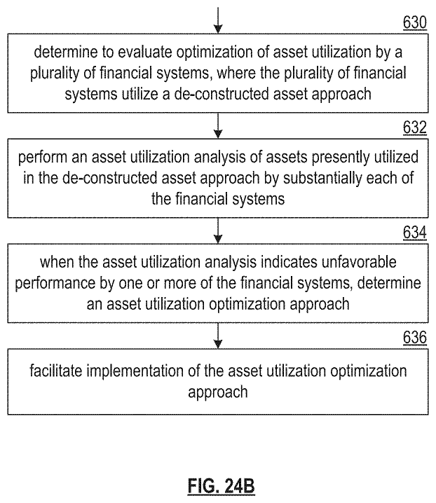

FIG. 24A is a schematic block diagram of another embodiment of a communication system that includes a plurality of legacy servers 22-1 through 22-N, a plurality of transactional servers 18-1 through 18-N, a plurality of augmentation servers 24-1 through 24-N, the conversion server 16 of FIG. 1, and the control server 20 of FIG. 1. Each of the legacy servers 22-1 through 22-N may be implemented utilizing the Legacy server 22 of FIG. 1, each of the transactional servers 18-1 through 18-N may be implemented utilizing the transactional server 18 of FIG. 1, and the plurality of augmentation servers 24-1 through 24-N may be implemented utilizing the augmentation server 24 of FIG. 1. The control server 20 includes the processing module 44 FIG. 1 and the database 30 of FIG. 1. The processing module 44 includes the diagnostic module 120 of FIG. 4A, the acquisition module 122 of FIG. 4A, and the augmentation module 124 of FIG. 4. The communication system functions to trade assets between a plurality of financial systems (e.g., a first financial system includes the legacy server 22-1, the transactional server 18-1, and the augmentation server 24-1, etc.).

In an example of operation of the trading of the assets between the plurality of financial systems, the conversion server 16 determines to evaluate optimization of asset utilization by the plurality of financial systems, where the plurality of financial systems utilize a de-constructed asset approach. The determining includes one or more of detecting an unfavorable performance of at least one financial system (e.g., based on financial system information 130, identifying newly available assets (e.g., augmenting asset information 134), receiving an evaluation request, and detecting expiration of an evaluation time frame.

When evaluating the optimization of the asset utilization, the conversion server 16 facilitates performing an asset utilization analysis of assets presently utilized in the de-constructed asset approach by substantially each of the financial systems. For example, the conversion server 16 aggregates financial system information 130 by obtaining financial system information 130-1 through 130-N from the legacy servers 22-1 through 22-N, obtains asset and liability partitioning information 140-1 through 140 N from the plurality of transactional servers 18-1 through 18-N, and, for each financial system, compares actual performance to desired performance to produce the asset utilization analysis.

When the asset utilization analysis indicates unfavorable performance by one or more of the financial systems, the conversion server 16 determines an asset utilization optimization approach. The determining includes one or more of listing an inventory of assets based on the financial system information 130, aggregating augmenting asset information 134-1 through 134-N obtained from the plurality of augmentation servers 24-1 through 24-N to produce augmenting asset information 134, causing the diagnostic module 122 produce desired financial attributes 132 based on the financial system information 130, causing the acquisition module 122 to produce acquired augmenting asset bundle information 136 based on the desired financial attributes 132 and the augmenting asset information 134, and causing the augmentation module 124 to produce asset augmentation information 138 based on the acquired augmenting asset bundle information 136.

Having produced the asset utilization optimization approach, the conversion server 16 facilitates implementation of the asset utilization optimization approach. For example, the conversion server 16 debtor issues asset and liability partitioning information 140-1 through 140-N on a as required basis (e.g., to those affected) to the transactional servers 18-1 through 18-N based on the asset augmentation information 138) to cause issuing of sub-asset settlement information 146-1 through 146-N to the plurality of legacy servers 22-1 through 22-N, where the transactional servers 18-1 through 18-N issue corresponding liability settlement information 142-1 through 142-N to corresponding augmentation servers 24-1 through 24-N causing the plurality of augmentation servers 24-1 through 24-N to issue asset settlement information 144 1 through 140 4N to cause the transactional servers 18-1 through 18-N to issue the sub-asset settlement information 146-1 through 146-N to the legacy servicers 22-1 through 22-N.

FIG. 24B is a logic diagram of an example of a method of trading assets within a communication system. In particular, a method is presented for use in conjunction with one or more functions and features described in conjunction with FIGS. 1-7C, 24A and also FIG. 24B. The method includes step 630 where a processing module of one or more computing devices (e.g., of one or more servers) determines to evaluate optimization of asset utilization by a plurality of financial systems, where the plurality of financial systems utilize a de-constructed asset approach. The determining includes one or more of detecting an unfavorable performance of at least one of the financial systems (e.g., based on financial system information from one or more of the financial systems), identifying newly available assets (e.g., augmenting asset information from one or more augmentation servers), receiving an evaluation request, and detecting expiration of an evaluation time frame.

The method continues at step 632 where the processing module performance and asset utilization analysis of assets presently utilized in the de-constructed asset approach by substantially each of the financial systems. For example, the processing module gathers financial system information, gathers asset and liability petition information from one or more the financial systems, and, for each financial system, compares actual performance to desired performance to produce the asset utilization analysis.

When the asset utilization analysis indicates unfavorable performance by one or more of the financial systems, the method continues at step 634 where the processing module determines an asset utilization optimization approach. For example, the processing module aggregates the financial system information from the plurality of financial systems to produce financial system information, lists and inventory of presently utilized assets to produce augmenting asset information, generates asset augmentation information to produce the asset utilization optimization approach, causes producing desired financial attributes based on the financial system information, causes producing acquired augmenting asset bundle information based on the desired financial attributes and the augmenting asset information, and causes producing asset augmentation information based on the acquired augmenting asset bundle information.

The method continues at step 636 for the processing module facilitates implementation of the asset utilization optimization approach. For example, the processing module issues asset and liability partitioning information to affected financial systems based on the asset augmentation information (e.g., sends to transactional servers) to cause issuing of sub-asset settlement information to the affected financial systems (e.g., to legacy servers) of the plurality financial systems (e.g., causing issuing of liability settlement information to a corresponding augmentation server and causing receipt of asset settlement information from a corresponding augmentation server to cause generation of the sub-asset some information).

The method described above in conjunction with the processing module can alternatively be performed by other modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the method steps described above.

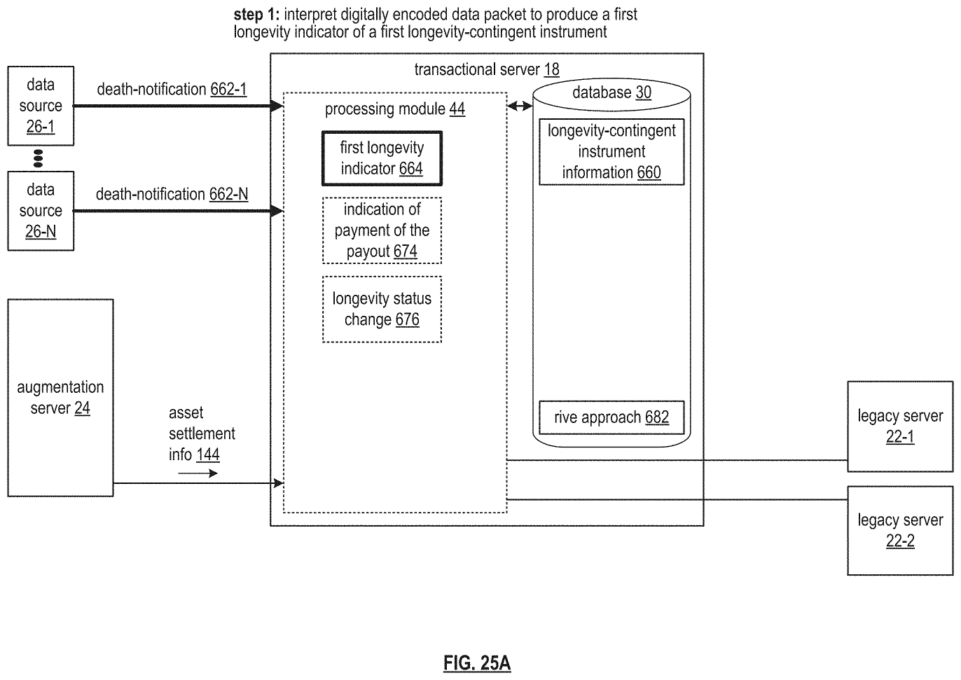

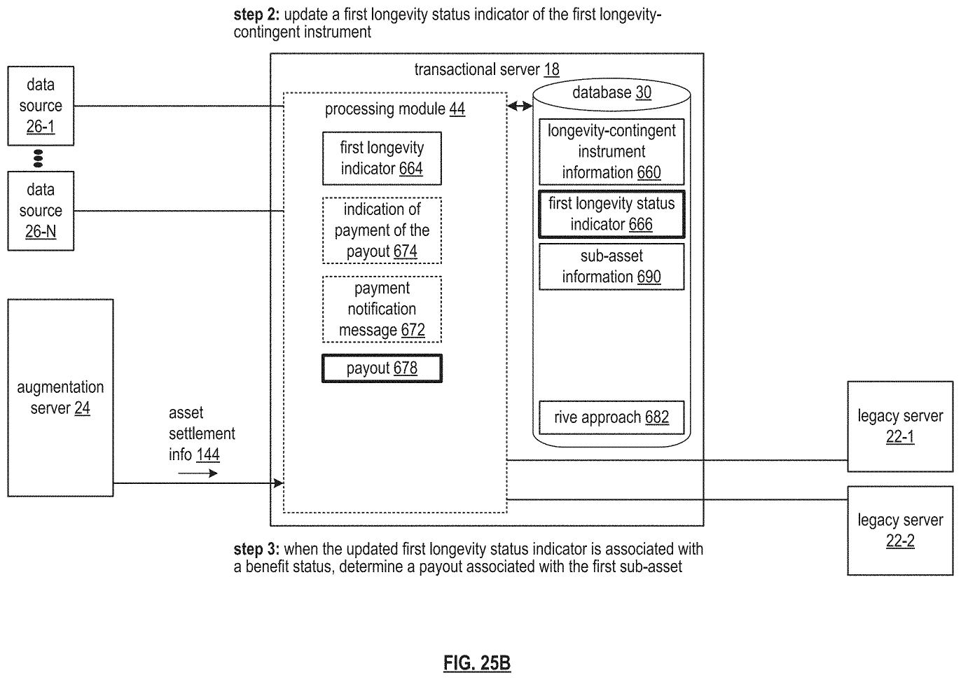

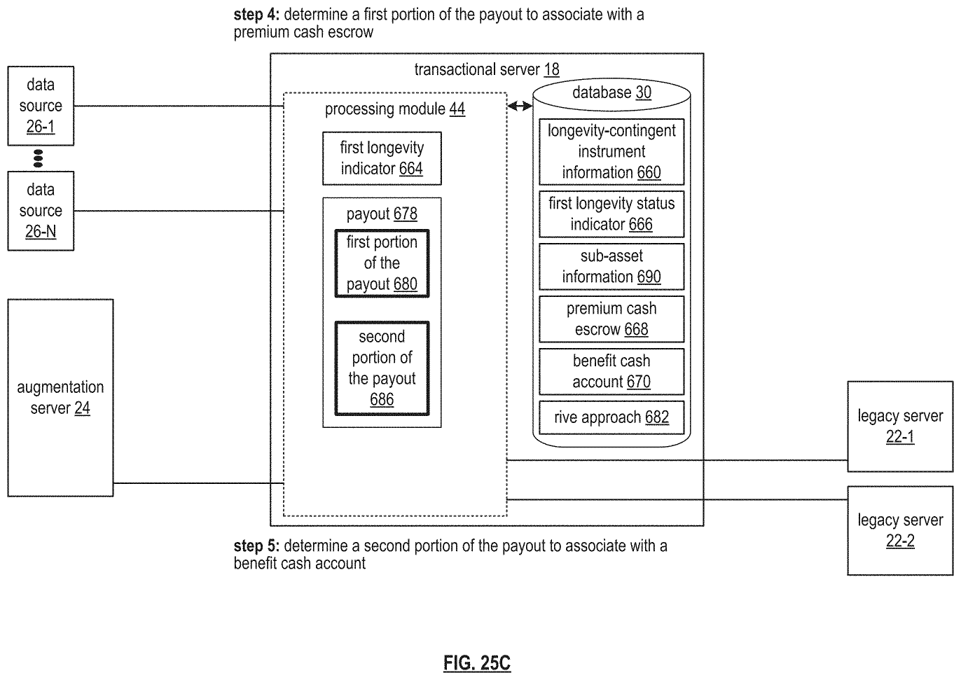

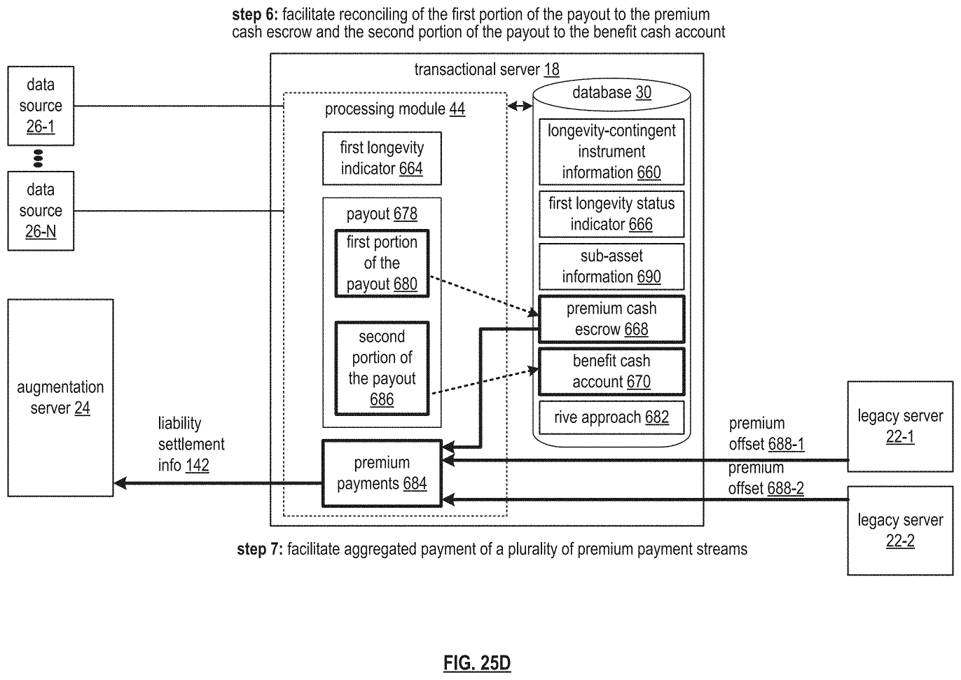

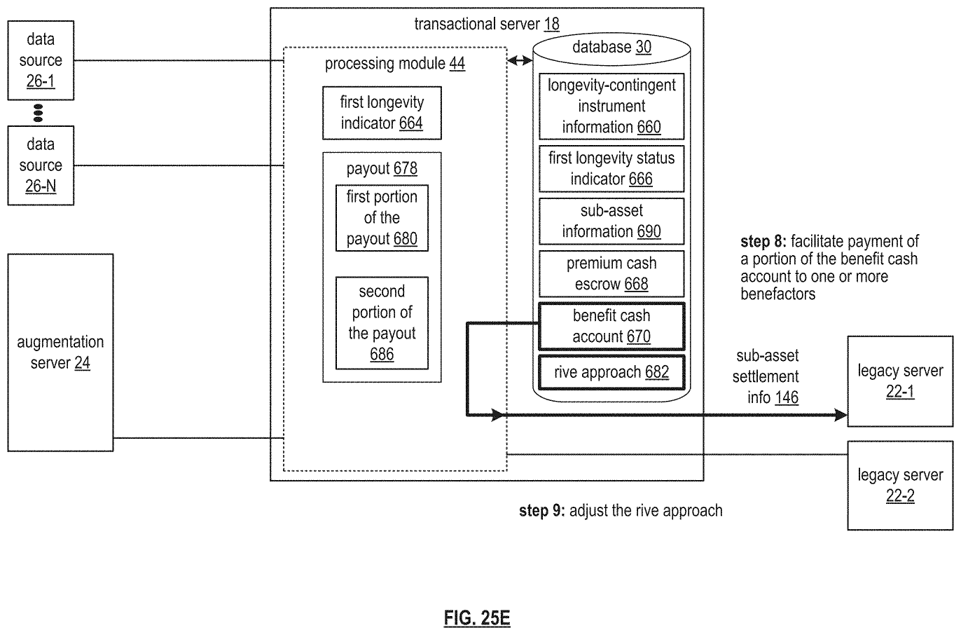

FIGS. 25A-25E are schematic block diagrams of another embodiment of a communication system illustrating an embodiment of a method for servicing a plurality of rived longevity-contingent instruments within a computing system. The computing system includes data sources 26-1 through 26-N, the augmentation server 24 of FIG. 1, the transactional server 18 of FIG. 1, and legacy servers 22-1 through 22-2. In an embodiment, the data sources 26-1 through 26-N are implemented utilizing the data source 26 of FIG. 1. In an embodiment, the legacy servers 22-1 through 22-2 are implemented utilizing the legacy server 22 of FIG. 1, where legacy server 22-1 is associated with a pension system and legacy server 22-2 is associated with one or more sponsors associated with the pension system. The transactional server 18 includes the processing module 44 of FIG. 1 and the database 30 of FIG. 1.

The plurality of rived longevity-contingent instruments includes a pool of life insurance policies (e.g., the instruments), where the policies have been rived (e.g., split of benefit ownership from premium liability responsibility). Each longevity-contingent instrument is associated with a premium payment stream (e.g., series of premium payments). For example, an insurance company of a first life insurance policy requires a monthly premium payment to maintain the first life insurance policy in force. Together, the pool of life insurance policies is associated with a plurality of premium payment streams.

A financial offering that includes the pool of life insurance policies requires an aggregated payment of the plurality of premium payment streams associated with the pool of life insurance policies. In an embodiment, the one or more sponsors associated with the legacy servers 22-1 through 22-2 are liable for the aggregated payment of the plurality of periodic premium payments in accordance with a rive approach 682. The rive approach 682 is discussed in greater detail with regards to FIG. 25C.

Each longevity-contingent instrument is further associated with a payout (e.g., death benefit) when a longevity status changes, e.g., a death of an insured person associated with the life insurance policy of the longevity-contingent instrument. For example, when the insured person passes, the life insurance company of the first life insurance policy provides payment of the payout to an entity associated with ownership of the first life insurance policy.

Riving of the policies splits the policy to associate liability of periodic premium payments with one or more debtors (e.g., sponsors) and to associate the policy payout with one or more benefactors (e.g., a pension and a sponsor). For example, the riving results in associating multiple sponsors of a common union pension with the liability of periodic premium payments. As another example, the riving results in associating the multiple sponsors of the common union pension and the common union pension with the policy payout.

The servicing of the plurality of longevity-contingent instrument includes steps associated with both the payouts upon longevity status change and the payment of the premium payment streams. The method of the servicing is discussed in greater detail with reference to FIGS. 25A-25E.

FIG. 25A illustrates an example of operation of steps of a method for the servicing of the plurality of longevity-contingent instruments where, in a first step, the processing module 44 interprets a digitally encoded data packet from another computing device to produce a first longevity indicator of a first longevity-contingent instrument of a plurality of longevity-contingent instruments. The first longevity-contingent instrument is rived in accordance with the rive approach 682 to produce a first sub-asset of a plurality of sub-assets and a first sub-liability of a plurality of sub-liabilities. The first sub-liability is associated with a first premium payment stream of a plurality of premium payment streams of the plurality of sub-liabilities.

A first death-notification of a multitude of death-notifications is encoded to produce the digitally encoded data packet. For example, the processing module 44 receives a multitude of death-notifications 662-1 through 662-N from data sources 26-1 through 26-N. The processing module 44 decodes the multitude of death-notifications to produce death-notification information. The processing module 44 accesses the database 30 to extract a plurality of insured person identifiers of the plurality of longevity-contingent instruments from longevity-contingent instrument information 660. A first insured person identifier of the plurality of insured person identifiers is associated with the first longevity-contingent instrument. The processing module 44 generates the first longevity indicator 664 to indicate a deceased status when the death-notification information includes a deceased person identifier that substantially matches the first insured person identifier of the first longevity-contingent instrument.

In another example, the processing module 44 interprets asset settlement information 144 to produce an indication of payment of the payout 674. The processing module 44 generates the first longevity indicator 664 when the payment of the payout 674 includes the deceased person identifier that substantially matches the first insured person identifier of the first longevity-contingent instrument.

In yet another example, the processing module 44 interprets either of the asset settlement information 144 and a corresponding death-notification 662-1 to produce a longevity status change 676. The processing module 44 generates the first longevity indicator 664 when the longevity status change 676 includes the deceased person identifier that substantially matches the first insured person identifier of the first longevity-contingent instrument.

FIG. 25B further illustrates the example of the servicing of the plurality of longevity-contingent instruments where, having produced the first longevity indicator 664, in a second step, the processing module 44 updates a first longevity status indicator 666 for the first longevity-contingent instrument within the database 30 utilizing the first longevity indicator to produce an updated first longevity status indicator. For example, the processing module 44 produces the updated first longevity status indicator to indicate a benefit status when the first longevity indicator 664 indicates that the insured person has deceased.

Having updated the first longevity status indicator 666, when the updated first longevity status indicator is associated with the benefit status, in a third step, the processing module 44 determines a payout 678 associated with the first sub-asset. The determining the payout 678 includes a variety of approaches. A first approach includes interpreting a payment notification message 672. For example, the processing module 44 interprets the asset settlement information 144 to produce the payment notification message 672, where the payment notification message 672 includes the payout 678. In another example, the processing module 44 interprets the asset settlement information 144 to produce the indication of payment of the payout 674, where the indication of payment of the payout 674 includes the payout 678.

A second approach to determine the payout 678 includes accessing the database 30 to extract a face value of the first longevity-contingent instrument. For example, the processing module 44 accesses the longevity-contingent instrument information 660 to extract the face value (e.g., a stated value of an associated life insurance policy).

A third approach to determine the payout 678 includes accessing the database 30 to extract a benefit value (e.g., an agreed to value) of the first sub-asset. For example, the processing module 44 accesses sub-asset information 690 to extract the benefit value.

Alternatively, or in addition to, the processing module 44 indicates that the first sub-asset has matured. For example, the processing module updates the sub-asset information 690 to indicate that the sub-asset has matured (e.g., to benefit payout).

FIG. 25C further illustrates the example of the servicing of the plurality of longevity-contingent instruments where the processing module 44, having identified the payout 678, in a fourth step determines a first portion of the payout 680 to associate with a premium cash escrow 668 in accordance with the rive approach 682. The association enables subsequent utilization of the premium cash escrow 668 to fund the aggregated payment of the plurality of premium payment streams on behalf of the one or more debtors.

The rive approach includes a variety of approaches. The approaches include a surplus approach where a balance associated with the premium cash escrow 668 is maintained at a level that is more than enough to make the aggregated premium payment streams. The approaches further include a deficit approach where the balance associated with the premium cash escrow 668 is maintained at a level that is less than enough to make the aggregated premium payment streams (e.g., another party such as a pension sponsor is liable to make up differences).

The approaches further include a breakeven approach where the balance associated with the premium cash escrow 668 is maintained at a level that is just enough to make the aggregated premium payment streams. The approaches further include a pro rata approach where the first portion is in accordance with a negotiated percentage of the payout (e.g., always 50% or even 40%). The approaches further include a consistency approach where the balance associated with the premium cash escrow 668 receives a stream of constant inflows to support the aggregated premium payment streams.

When the rive approach 682 includes the surplus approach, the determining of the first portion of the payout 680 includes calculating the first portion of the payout such that a sum of a plurality of first portion payouts within a first time frame is greater than a sum of a subset of the plurality of premium payment streams for the first time frame. When the rive approach 682 includes the deficit approach, the determining of the first portion of the payout 680 includes calculating the first portion of the payout such that the sum of the plurality of first portion payouts within the first time frame is less than the sum of the subset of the plurality of premium payment streams for the first time frame.

When the rive approach 682 includes the break-even approach, the determining of the first portion of the payout 680 includes calculating the first portion of the payout such that the sum of the plurality of first portion payouts within the first time frame is substantially the same as the sum of the subset of the plurality of premium payment streams for the first time frame. When the rive approach 682 includes the pro rata approach, the determining of the first portion of the payout 680 includes establishing the first portion of the payout in accordance with a pre-determined percentage of the payout. When the rive approach 682 includes the consistency approach, the determining of the first portion of the payout 680 includes establishing the first portion of the payout in accordance with a pre-determined first portion level (e.g., a default constant amount).

Having determined the first portion of the payout 680, the processing module 44, in a fifth step determines a second portion of the payout 686 to associate with a benefit cash account 670 based on the first portion of the payout 680 and in accordance with the rive approach 682. The benefit cash account 670 is associated with the one or more benefactors. The determining of the second portion of the payout 686 includes a variety of approaches. The approaches include the pro rata approach, the consistency approach, and a difference approach.

When the rive approach includes the pro rata approach, the determining of the second portion of the payout 686 includes establishing the second portion of the payout 686 in accordance with a pre-determined percentage of the payout. For example, the processing module 44 multiplies the predetermined percentage by the payout 678 to produce the second portion of the payout 686 (e.g., 60% of the payout).

When the rive approach includes the consistency approach, the determining of the second portion of the payout 686 includes establishing the second portion of the payout 686 in accordance with a pre-determined second portion level (e.g., a constant amount). For example, the processing module 44 sets the second portion of the payout 686 to be a fixed number based on the predetermined second portion level (e.g., a flat $100,000).

When the rive approach includes the difference approach, the determining of the second portion of the payout 686 includes establishing the second portion of the payout in accordance with a difference between the payout and the first portion of the payout (e.g., what's leftover). For example, the processing module 44 subtracts the first portion of the payout 680 from the payout 678 to produce the second portion of the payout 686 (e.g., $1 million payout minus $480,000 first portion equals $520,000).

Alternatively, or in addition to, the processing module 44 determines a third portion of the payout. For instance, the payout 678 equals the sum of the first through third portions, where the third portion is a service fee. In yet another alternative, the processing module determines further portions of the payout when more than one benefactor directly receives a portion of the payout 678 (e.g., multiple pensions associated with the plurality of longevity-contingent assets).

FIG. 25D further illustrates the example of the servicing of the plurality of longevity-contingent instruments where the processing module 44, in sixth step, facilitates reconciling of the first portion of the payout 680 to the premium cash escrow 668 and the second portion of the payout 686 to the benefit cash account 670. For example, the processing module 44 increments the premium cash escrow 668 of the database 30 by an amount of the first portion of the payout 680. Alternatively, or in addition to, the processing module 44 issues a payment message to another server associated with the premium cash escrow 668 (e.g., a debtor). As another example, the processing module 44 increments the benefit cash account 670 of the database 30 by an amount of the second portion of the payout 686. Alternatively, or in addition to, the processing module 44 issues a payment message to another server associated with the benefit cash account 670 (e.g., a benefactor).

Having facilitated the reconciling of the first portion of the payout 680 and the second portion of the payout 686, in a seventh step the processing module 44 facilitates the aggregated payment of the plurality of premium payment streams utilizing the premium cash escrow 668 and one or more premium offsets 688-1 and 688-2 from the one or more debtors (e.g., via their legacy servers 22-1 and 22-2). For example, the processing module 44 accrues premium payments 684 utilizing a portion of the premium cash escrow 668, determines a level of a required payment of the premium payment streams, calculates a difference between the accrued premium payment 684 and the level of required payment to produce a supplementing level, and obtains the supplementing level of funds from the legacy servers 22-1 and 22-2 via premium offsets 688-1 and 688-2.

Having obtained the portion of the premium cash escrow 668, the premium offsets 688-1, and the premium offsets 688-2, the processing module 44 sums the portion of the premium cash escrow 668, the premium offset 688-1, and the premium offset 688-2 to produce the premium payments 684. Having produced the premium payments 684, the processing module 44 issues liability settlement information 142 to the augmentation server 24, where the liability settlement information 142 pertains to the premium payments 684.

FIG. 25E further illustrates the example of the servicing of the plurality of longevity-contingent instruments where, in an eight step the processing module 44 facilitates payment from the benefit cash account 670 to the one or more benefactors. For example, the processing module 44 issues sub-asset settlement information 146 to the legacy server 22-1 that is associated with the pension system, where the sub-asset settlement information 146 includes a portion of the benefit cash account 670 (e.g., the second portion of the payout 686). Alternatively, or in addition to, the processing module 44 issues the second portion of the payout 686 to another server associated with one or more other benefactors.

Having facilitated the payment of the benefit cash account 670, the processing module 44, from time to time in a nineth step, adjusts the rive approach 682 to favor increasing the second portion of the payout when a first sum of a first plurality of second portion payouts within a first time frame is less than a first sum of a first subset of the plurality of premium payment streams for the first time frame. For example, the processing module 44 increases the percentage of the second portion of the payout to bolster the premium payments.

Alternatively, the processing module 44, from time to time in the nineth step, adjusts the rive approach to favor decreasing the second portion of the payout when a second sum of a second plurality of second portion payouts within a second time frame is greater than a second sum of a second subset of the plurality of premium payment streams for the second time frame. For example, the processing module 44 decreases the percentage of the payout 686 to not overfund the premium payments.

The method described above module can alternatively be performed by various modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the steps described above.

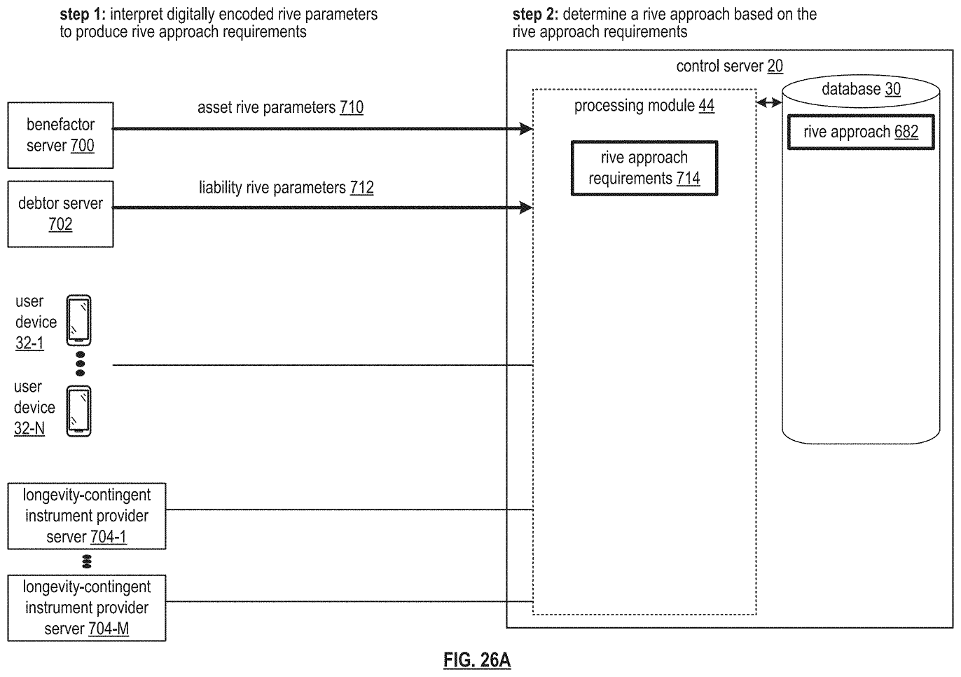

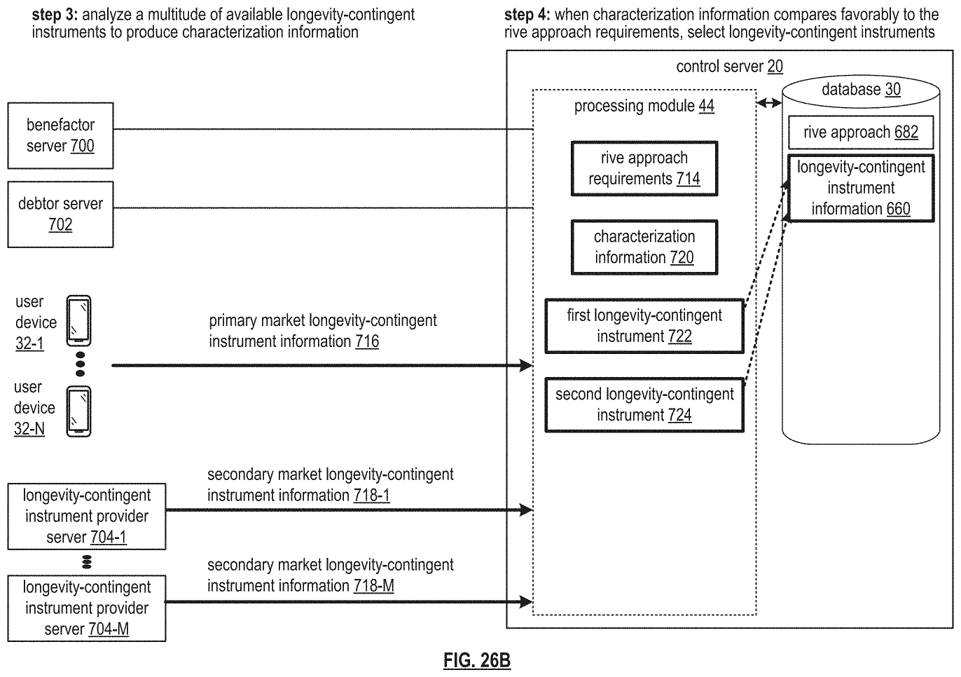

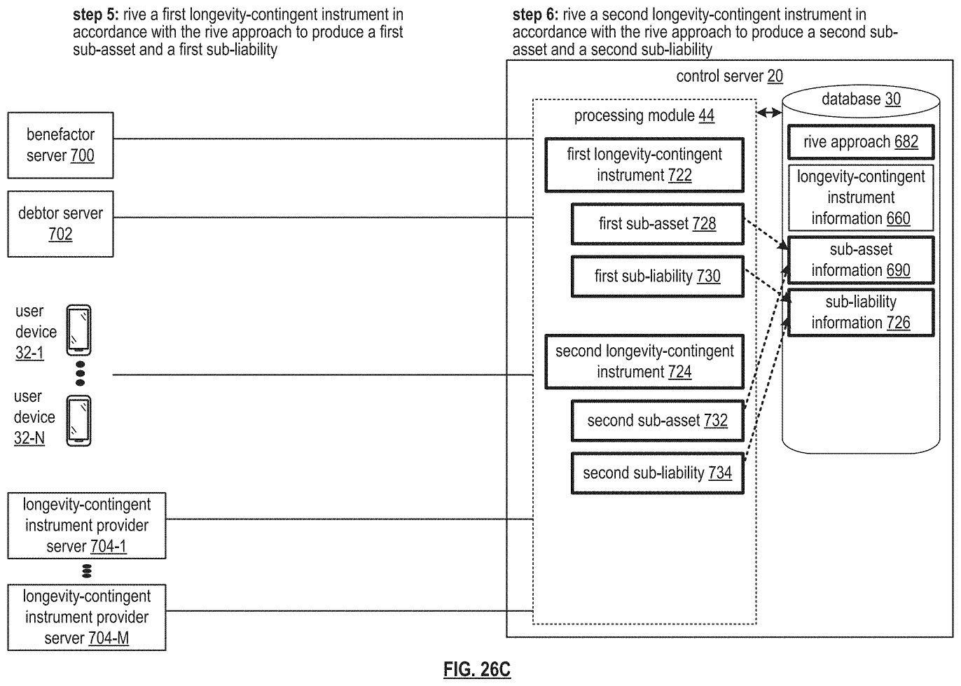

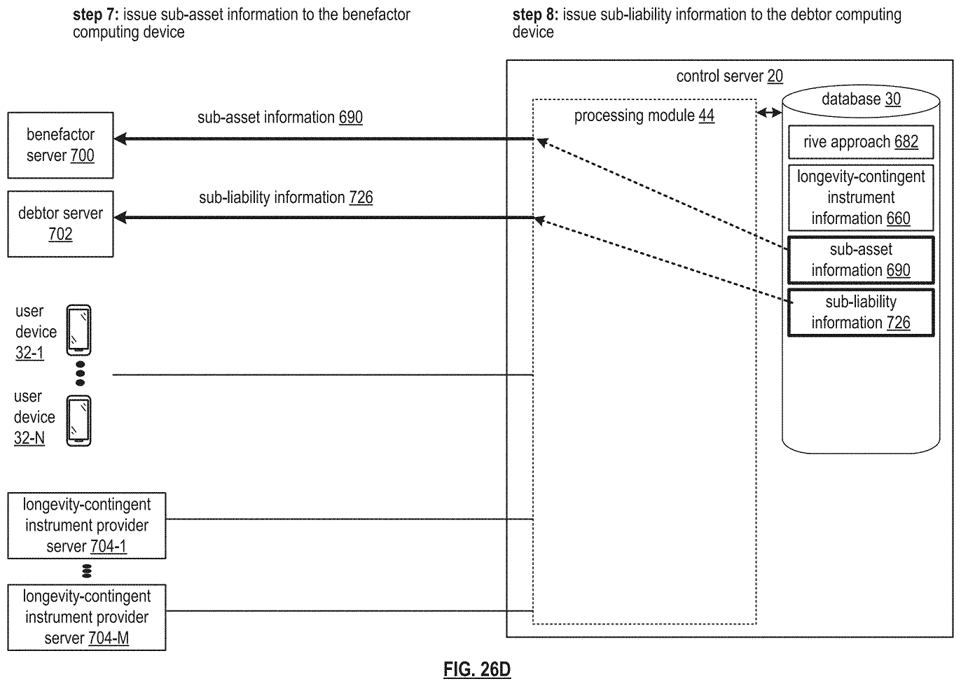

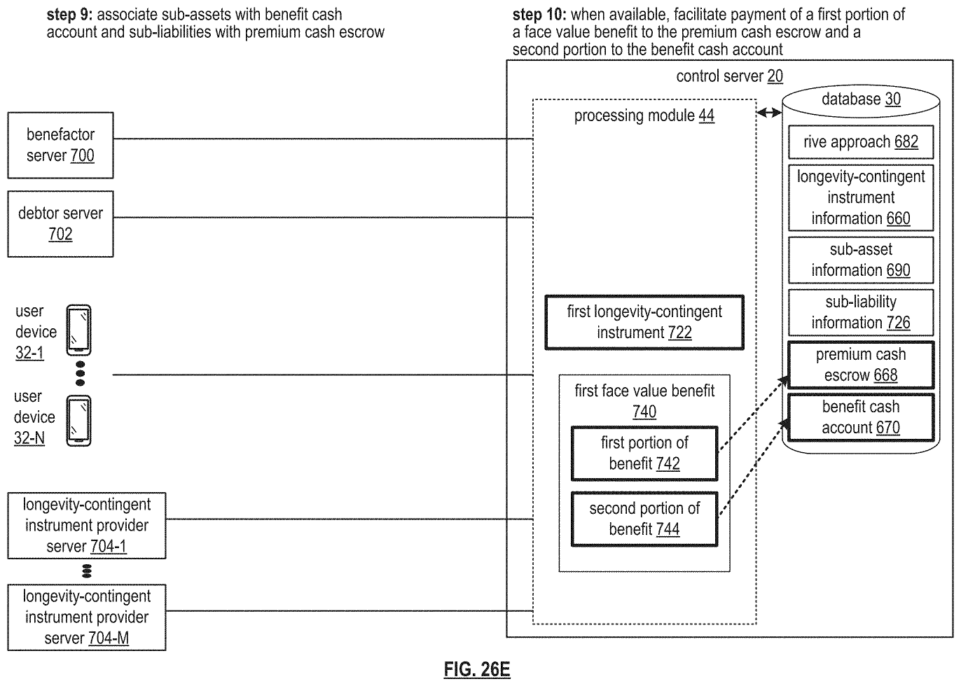

FIGS. 26A-26E are schematic block diagrams of another embodiment of a communication system illustrating an embodiment of a method for riving longevity-contingent instruments within a computing system. The computing system includes a benefactor server 700, a debtor server 702, user devices 32-1 through 32-N, longevity-contingent instrument provider servers 704-1 through 704-M, and the control server 20 of FIG. 1. In an embodiment, the benefactor server 700 and the debtor server 702 are implemented utilizing the legacy server 22 of FIG. 1, where the benefactor server 700 is associated with at least one pension system and the debtor server 702 is associated with at least one sponsor associated with the at least one pension system. In an embodiment, the user devices 32-1 through 32-N are implemented utilizing the user devices 32 of FIG. 1. In an embodiment, the longevity-contingent instrument provider servers 704-1 through 704-M are implemented utilizing the augmentation server 24 of FIG. 1. The control server 20 includes the processing module 44 of FIG. 1 and the database 30 of FIG. 1.

FIG. 26A illustrates an example of operation of steps of a method for the riving of the longevity-contingent instruments where, in a first step, the processing module 44 interprets digitally encoded rive parameters from one or more of a benefactor computing device (e.g., the benefactor server 700) and a debtor computing device (e.g., the debtor server 702) to produce rive approach requirements 714. The interpreting includes a series of operations. A first operation includes decoding a first subset of the digitally encoded rive parameters received from the benefactor computing device to produce asset rive parameters. For example, the processing module 44 decodes digitally encoded rive parameters from the benefactor server 700 to produce asset rive parameters 710. The asset rive parameter 710 includes one or more of a required net cash flow pattern, a target investment yield rate, and a maximum initial benefactor contribution level.

A second operation includes decoding a second subset of the digitally encoded rive parameters received from the debtor computing device to produce liability rive parameters. For example, the processing module 44 decodes digitally encoded rive parameters from the debtor server 702 to produce liability rive parameter 712. The liability rive parameters 712 includes one or more of a maximum contribution cash flow pattern and a maximum initial debtor contribution level. A third operation includes aggregating the asset rive parameters 710 and the liability rive parameters 712 to produce the rive approach requirements 714.

Having produced the rive approach requirements 714, in a second step, the processing module 44 determines a rive approach 682 for riving a set of longevity-contingent instruments of a multitude of available longevity-contingent instruments based on the rive approach requirements 682. A first longevity-contingent instrument of the set of longevity-contingent instruments includes a first face value benefit (e.g., death benefit) and a first premium payment stream. A second longevity-contingent instrument of the set of longevity-contingent instruments includes a second face value benefit and a second premium payment stream. When available (e.g., when an insured person passes and the death benefit is provided), a first portion of the first face value benefit is utilized to fund at least some of the second premium payment stream in accordance with the rive approach 682. The premium payment stream includes series of time-certain obligated payments to maintain the corresponding longevity-contingent instrument (e.g., with a corresponding provider, i.e. insurance company).

The determining of the rive approach 682 includes one of a variety of ways. A first way, when the rive approach requirements indicate that a first allocated portion of the plurality of sub-assets is to be greater than the plurality of sub-liabilities, includes establishing the rive approach as a surplus approach. A second way, when the rive approach requirements indicate that the first allocated portion of the plurality of sub-assets is to be less than the plurality of sub-liabilities includes establishing the rive approach as a deficit approach. A third way, when the rive approach requirements indicate that the first allocated portion of the plurality of sub-assets is to be substantially the same as the plurality of sub-liabilities includes establishing the rive approach as a break-even approach.

A fourth way of determining the rive approach 682, when the rive approach requirements indicate that the first allocated portion of the plurality of sub-assets is to be a pre-determined percentage of the plurality of sub-assets includes establishing the rive approach as a pro rata approach. A fifth way, when the rive approach requirements indicate that the first allocated portion of the plurality of sub-assets is to be a pre-determined first portion level includes establishing the rive approach as a consistency approach.

FIG. 26B further illustrates the example of the riving of the longevity-contingent instruments where, having determined the rive approach 682, in a third step, the processing module 44 analyzes a subset of the multitude of available longevity-contingent instruments to produce characterization information 720. The subset of the multitude of available longevity-contingent instruments includes the first longevity-contingent instrument 722 and the second longevity-contingent instrument 724. The characterization information 720 includes first characterization information for the first longevity-contingent instrument 722 and second characterization information for the second longevity-contingent instrument 724.

The multitude of available longevity-contingent instruments are generally available from one or both of a primary market and a secondary market. Accessing the primary market includes obtaining the longevity-contingent instruments directly from initial policyholders (e.g., the originally insured). Accessing the secondary market includes obtaining the longevity-contingent instruments from brokers and providers, where the longevity-contingent instruments have changed hands from the initial policyholders to one or more intermediaries (e.g., the brokers, etc.).

The analyzing of the subset of the multitude of available longevity-contingent instruments to produce the characterization information includes several sub-steps. A first sub-step includes accessing the multitude of available longevity-contingent instruments. For example, the processing module 44 receives primary market longevity-contingent instrument information 716 from one or more of the user devices 32-1 through 32-N. A first instance includes the user device 32-1 issuing the primary market longevity-contingent instrument information 716 to the control server 20 in an unsolicited fashion when desiring to offer a life insurance policy for sale. A second instance includes the control server 20 receiving the primary market longevity-contingent instrument information 716 from the user device 32-2 in response to a solicitation message from the control server 20.

As another example of accessing a multitude of available longevity-contingent instruments, the processing module 44 receives one or more of secondary market longevity-contingent instrument information 718-1 through 718-M from one or more of the longevity-contingent instrument provider servers 704-1 through 704-M. The receiving includes receiving the information in an unsolicited fashion and receiving the information in response to the control server 20 issuing a solicitation.

Having accessed the multitude of available longevity-contingent instruments, a second sub-step to analyze the subsets of the multitude of available longevity-contingent instruments includes determining the first characterization information to include one or more elements. A first element includes a first estimated timeframe for payout of the first face value benefit (e.g., generate a life expectancy based on one or more of insured age, gender, smoker, health impairments, historical life expectancy data, etc.). A second element includes a present value of the first face value benefit utilizing the first estimated timeframe (e.g., generate a present value range for a range of discounted cash flow analysis interest rates and for a range around the first estimate timeframe, i.e., dither the life expectancy). A third element includes a present value of the first premium payment stream.

A third sub-step to analyze the subsets of the multitude of available longevity-contingent instruments includes determining the second characterization information to include one or more further elements. A first further element includes a second estimated timeframe for payout of the second face value benefit. A second further element includes a present value of the second face value benefit utilizing the second estimated timeframe. A third further element includes a present value of the second premium payment stream.

A fourth sub-step to analyze the subsets of the multitude of available longevity-contingent instruments includes aggregating the first characterization information and the second characterization information to produce the characterization information 720. The characterization information 720 further includes insured age, gender, smoker, insured health record, historical life expectancy data, a requested purchase price, an offered purchase price, etc.).

Having analyzed the multitude of available longevity-contingent instruments to produce the characterization information 720, in a fourth step, when the first characterization information and the second characterization information compare favorably to the rive approach requirements 714, the processing module 44 selects the first longevity-contingent instrument 722 and the second longevity-contingent instrument 724 to include in the set of longevity-contingent instruments. For example, the processing module 44 identifies the first and second longevity-contingent instruments, causes title transfer (e.g., purchase via a transaction with the user device 32-1 and/or longevity-contingent instrument provider servers 704-1), and lists the first and second longevity-contingent instruments in the longevity-contingent instrument information 660 of the database 30.

FIG. 26C further illustrates the example of the riving of the longevity-contingent instruments where, having selected the longevity-contingent instruments, in a fifth step, the processing module 44 rives the first longevity-contingent instrument 722 based on the first face value benefit, the first premium payment stream and in accordance with the rive approach 682 to produce a first sub-asset 728 of a plurality of sub-assets of the set of longevity-contingent instruments and a first sub-liability 730 of a plurality of sub-liabilities of the set of longevity-contingent instruments. The first sub-liability 730 is associated with the first premium payment stream.

The riving of the first longevity-contingent instrument 722 includes generating beneficiary ownership of the first face value benefit to be associated with the first sub-asset 728. For example, the processing module 44 facilitates listing a legal entity of the first sub-asset as a partial beneficiary of the first longevity-contingent instrument and updates the sub-asset information 690 with the first sub-asset 728. As another example, the processing module 44 facilitates listing another legal entity of the first sub-liability as one of another partial beneficiary of the first longevity-contingent instrument and updates the sub-liability information 726 with the first sub-liability 730.

The riving of the first longevity-contingent instrument 722 further includes generating fiduciary responsibility of the first premium payment stream to be associated with the first sub-liability. For example, the processing module 44 facilitates listing the other legal entity of the first sub-liability as having fiduciary responsibility of the first premium payment stream of the first longevity-contingent instrument 722.

Having rived the first longevity-contingent instrument 722, in a sixth step, the processing module 44 rives the second longevity-contingent instrument 724 based on the second face value benefit, the second premium payment stream and in accordance with the rive approach 682 to produce a second sub-asset 732 of the plurality of sub-assets and a second sub-liability 734 of the plurality of sub-liabilities. The second sub-liability 734 is associated with the second premium payment stream. The processing module 44 further updates the sub-asset information 690 with the second sub-asset 732 and updates the sub-liability information 726 with the second sub-liability 734.

FIG. 26D further illustrates the example of the riving of the longevity-contingent instruments where, having rived the longevity-contingent instruments, in a seventh step, the processing module 44 issues sub-asset information 690 to the benefactor computing device (e.g., to the benefactor server 700). The sub-asset information 690 is based on the plurality of sub-assets and the rive approach 682. The issuing includes generating the sub-asset information 690 from all of the sub-assets and sending, via the network 28 of FIG. 1, the sub-asset information 690 to the benefactor server 700.

Having issued the sub-asset information, in an eight step, the processing module 44 issues sub-liability information 726 to the debtor computing device (e.g., to the debtor server 702). The sub-liability information 726 is based on the plurality of sub-liabilities and the rive approach 682. The issuing includes generating the sub-liability information 726 from all of the sub-liabilities and sending, via the network 28 of FIG. 1, the sub-liability information 726 to the debtor server 702.

FIG. 26E further illustrates the example of the riving of the longevity-contingent instruments where, having issued the sub-liability information to the debtor computing device, in a ninth step, the processing module 44 associates the plurality of sub-assets with a benefit cash account 670 and associates the plurality of sub-liabilities with a premium cash escrow 668. The benefit cash account 670 is associated with the benefactor computing device and the premium cash escrow 668 is associated with the debtor computing device.

Having associated the sub-assets and the sub-liabilities, in a tenth step, the processing module 44, when available (e.g., upon payment of a death benefit), facilitates payment of a first portion of the first face value benefit 742 to the premium cash escrow 668 in accordance with the first sub-liability. The first portion of the first face value benefit is determined in accordance with the rive approach 682. The tenth step further includes the processing module 44, when available, facilitating payment of a second portion of the first face value benefit 744 to the benefit cash account 670 in accordance with the first sub-asset. The second portion of the first face value benefit is determined in accordance with the rive approach 682 and the first portion of the first face value benefit. Alternatively, or in addition to, the processing module 44 facilitates payment of a portion of the second premium payment stream utilizing one or more of the premium cash escrow 668 and a premium offset from the debtor computing device.

The method described above module can alternatively be performed by various modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the steps described above.

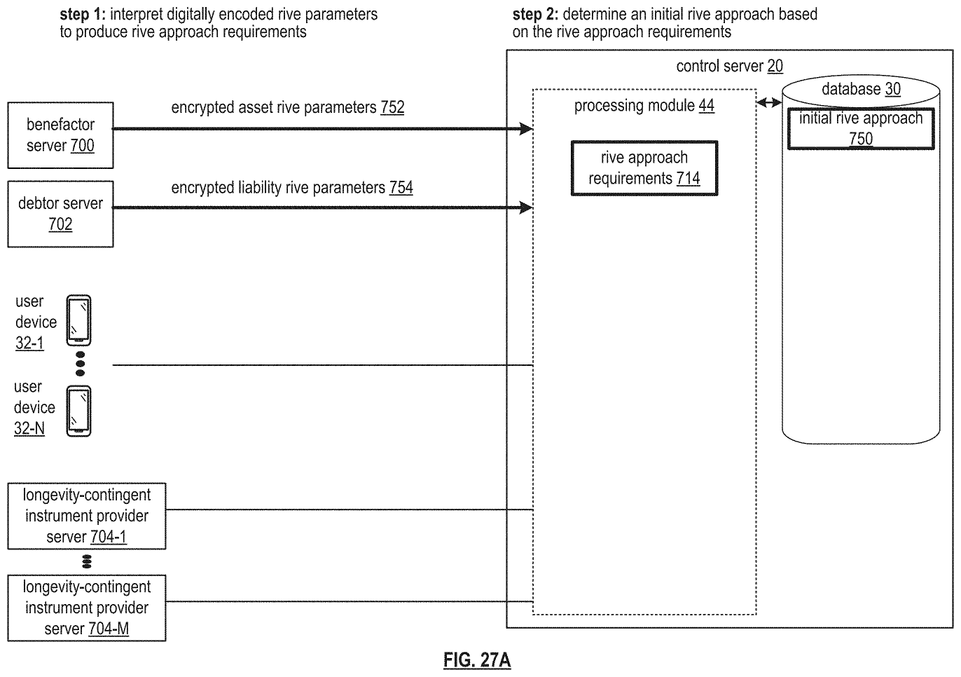

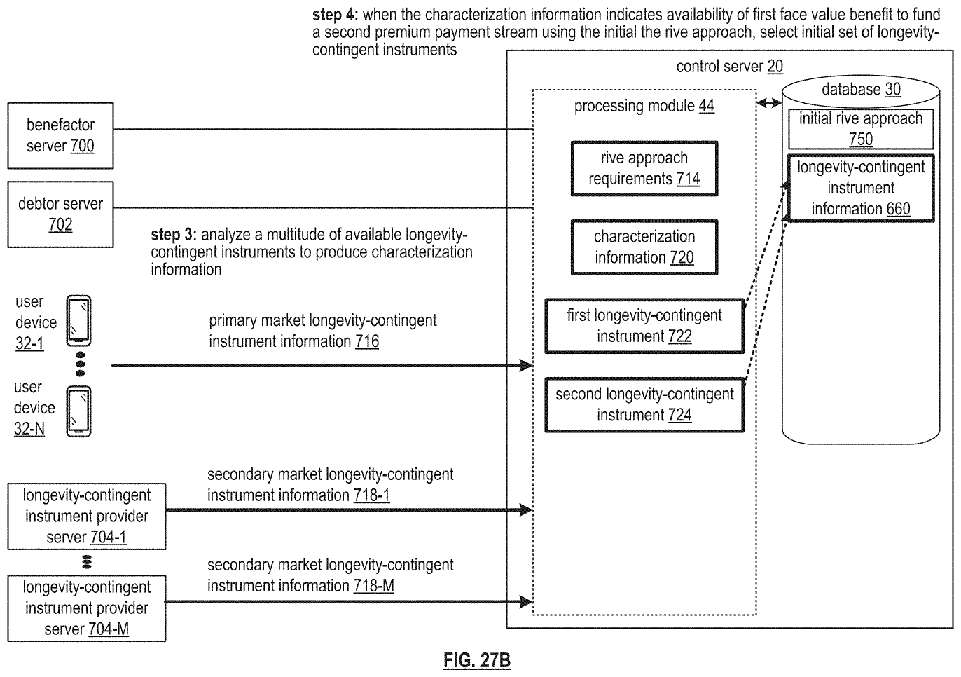

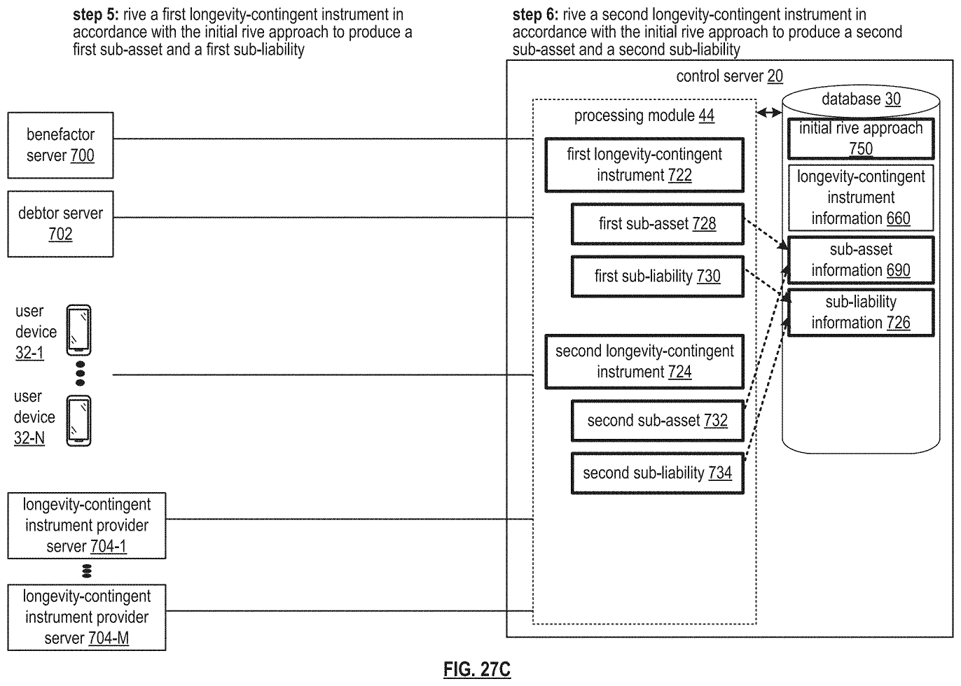

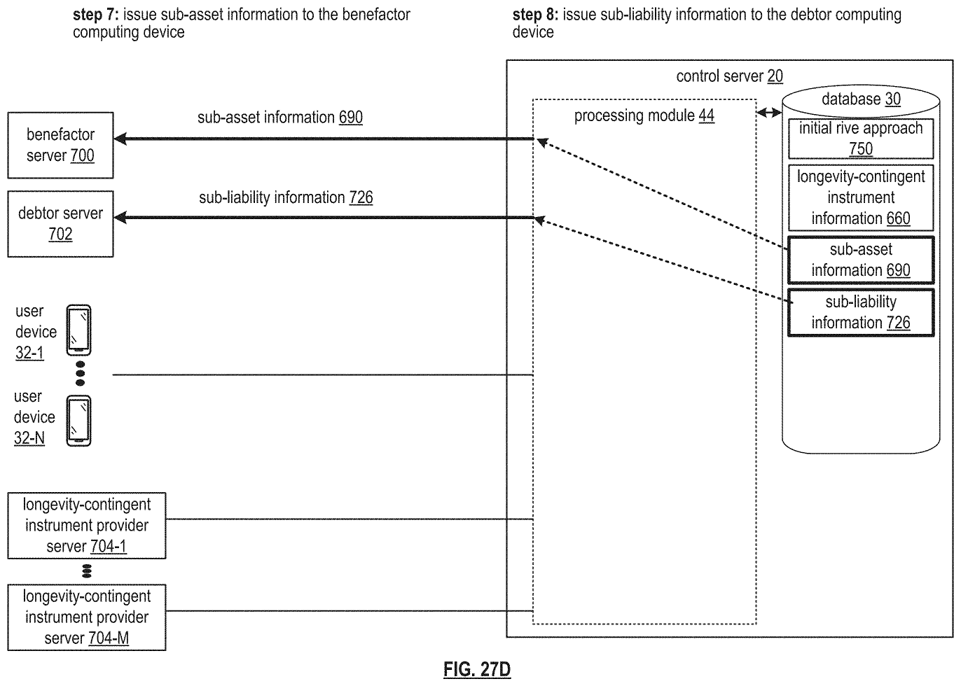

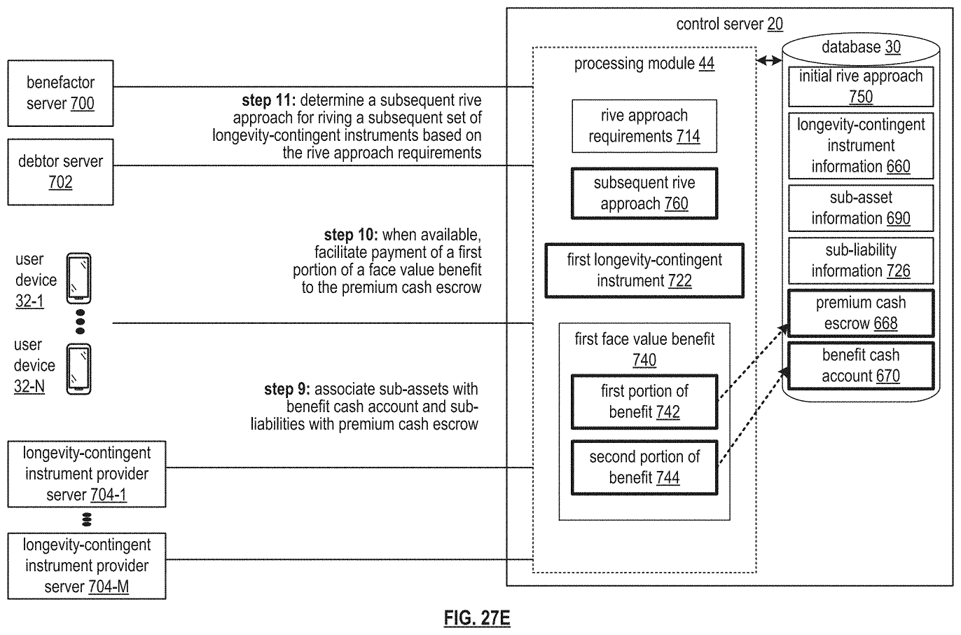

FIGS. 27A-27E are schematic block diagrams of another embodiment of a communication system illustrating an embodiment of another method for riving longevity-contingent instruments within a computing system. The computing system includes a benefactor server 700, a debtor server 702, user devices 32-1 through 32-N, longevity-contingent instrument provider servers 704-1 through 704-M, and the control server 20 of FIG. 1. In an embodiment, the benefactor server 700 and the debtor server 702 are implemented utilizing the legacy server 22 of FIG. 1, where the benefactor server 700 is associated with at least one pension system and the debtor server 702 is associated with at least one sponsor associated with the at least one pension system. In an embodiment, the user devices 32-1 through 32-N are implemented utilizing the user devices 32 of FIG. 1. In an embodiment, the longevity-contingent instrument provider servers 704-1 through 704-M are implemented utilizing the augmentation server 24 of FIG. 1. The control server 20 includes the processing module 44 of FIG. 1 and the database 30 of FIG. 1.

FIG. 27A illustrates an example of operation of steps of a method for the riving of the longevity-contingent instruments where, in a first step, the processing module 44 interprets digitally encoded rive parameters from one or more of a benefactor computing device (e.g., the benefactor server 700) and a debtor computing device (e.g., the debtor server 702) to produce rive approach requirements 714. The interpreting includes a series of one or more operations. A first operation includes decrypting encrypted asset rive parameters 752 received from the benefactor server 700 to produce a first subset of the digitally encoded rive parameters. A second operation includes decoding the first subset of the digitally encoded rive parameters to produce asset rive parameters.

A third operation includes decrypting encrypted liability rive parameters 754 received from the debtor server 702 to produce a second subset of the digitally encoded rive parameters. A fourth operation includes decoding the second subset of the digitally encoded rive parameters to produce liability rive parameters. A fifth operation includes aggregating the asset rive parameters and the liability rive parameters to produce the rive approach requirements 714.

Having produced the rive approach requirements 714, in a second step, the processing module 44 determines an initial rive approach 750 for riving an initial set of longevity-contingent instruments of a multitude of available longevity-contingent instruments based on the rive approach requirements 714. A first longevity-contingent instrument of the initial set of longevity-contingent instruments includes a first face value benefit (e.g., death benefit) and a first premium payment stream. A second longevity-contingent instrument of the initial set of longevity-contingent instruments includes a second face value benefit and a second premium payment stream. When an insured person passes and a death benefit is provided, availability of the first face value benefit is to fund a first sequential portion of the second premium payment stream in accordance with the initial rive approach 750.

The determining of the initial rive approach 750 includes one of a variety of ways. A first way, when the rive approach requirements 714 indicate that the plurality of sub-assets of the initial set of longevity-contingent instruments is to be greater than a sum of the plurality of sub-liabilities of the initial set of longevity-contingent instruments and initial sequential portions of a plurality of subsequent premium payment streams of another plurality of sub-liabilities of a subsequent set of longevity-contingent instruments, includes establishing the initial rive approach 750 as an initial surplus approach.

A second way, when the rive approach requirements 714 indicate that the plurality of sub-assets of the initial set of longevity-contingent instruments is to be less than the sum of the plurality of sub-liabilities of the initial set of longevity-contingent instruments and the initial sequential portions of the plurality of subsequent premium payment streams of the other plurality of sub-liabilities of the subsequent set of longevity-contingent instruments, includes establishing the initial rive approach 750 as an initial deficit approach. A third way, when the rive approach requirements 714 indicate that the plurality of sub-assets of the initial set of longevity-contingent instruments is to be substantially the same as the sum of the plurality of sub-liabilities of the initial set of longevity-contingent instruments and the initial sequential portions of the plurality of subsequent premium payment streams of the other plurality of sub-liabilities of the subsequent set of longevity-contingent instruments, includes establishing the initial rive approach 750 as an initial break-even approach;

A fourth way, when the rive approach requirements 714 indicate that the plurality of sub-assets of the initial set of longevity-contingent instruments is to be a pre-determined percentage of the sum of the plurality of sub-liabilities of the initial set of longevity-contingent instruments and the initial sequential portions of the plurality of subsequent premium payment streams of the other plurality of sub-liabilities of the subsequent set of longevity-contingent instruments, includes establishing the initial rive approach 750 as an initial pro rata approach. A fifth way, when the rive approach requirements 714 indicate that the plurality of sub-assets of the initial set of longevity-contingent instruments is to be a pre-determined initial level, includes establishing the initial rive approach 750 as an initial consistency approach.

FIG. 27B further illustrates the example of operation of steps of the method for the riving of the longevity-contingent instruments where, having determined the initial rive approach 750, in a third step, the processing module 44 analyzes a subset of the multitude of available longevity-contingent instruments to produce characterization information 720. The subset of the multitude of available longevity-contingent instruments includes the first longevity-contingent instrument 722 and the second longevity-contingent instrument 724. The characterization information 720 includes first characterization information for the first longevity-contingent instrument 722 and second characterization information for the second longevity-contingent instrument 724.

The multitude of available longevity-contingent instruments are generally available from one or both of a primary market and a secondary market. Accessing the primary market includes obtaining the longevity-contingent instruments directly from initial policyholders (e.g., the originally insured). Accessing the secondary market includes obtaining the longevity-contingent instruments from brokers and providers, where the longevity-contingent instruments have changed hands from the initial policyholders to one or more intermediaries (e.g., the brokers, etc.).

The analyzing of the subset of the multitude of available longevity-contingent instruments to produce the characterization information includes several sub-steps. A first sub-step includes accessing the multitude of available longevity-contingent instruments. For example, the processing module 44 receives primary market longevity-contingent instrument information 716 from one or more of the user devices 32-1 through 32-N. A first instance includes the user device 32-1 issuing the primary market longevity-contingent instrument information 716 to the control server 20 in an unsolicited fashion when desiring to offer a life insurance policy for sale. A second instance includes the control server 20 receiving the primary market longevity-contingent instrument information 716 from the user device 32-2 in response to a solicitation message from the control server 20.

As another example of accessing a multitude of available longevity-contingent instruments, the processing module 44 receives one or more of secondary market longevity-contingent instrument information 718-1 through 718-M from one or more of the longevity-contingent instrument provider servers 704-1 through 704-M. The receiving includes receiving the information in an unsolicited fashion and receiving the information in response to the control server 20 issuing a solicitation.

Having accessed the multitude of available longevity-contingent instruments, a second sub-step to analyze the subsets of the multitude of available longevity-contingent instruments includes determining the first characterization information to include one or more elements. A first element includes a first estimated timeframe for payout of the first face value benefit (e.g., generate a life expectancy based on one or more of insured age, gender, smoker, health impairments, historical life expectancy data, etc.). A second element includes a present value of the first face value benefit utilizing the first estimated timeframe (e.g., generate a present value range for a range of discounted cash flow analysis interest rates and for a range around the first estimate timeframe, i.e., dither the life expectancy). A third element includes a present value of the first premium payment stream.

A third sub-step to analyze the subsets of the multitude of available longevity-contingent instruments includes determining the second characterization information to include one or more further elements. A first further element includes a second estimated timeframe for payout of the second face value benefit. A second further element includes a present value of the second face value benefit utilizing the second estimated timeframe. A third further element includes a present value of the second premium payment stream.

A fourth sub-step to analyze the subsets of the multitude of available longevity-contingent instruments includes aggregating the first characterization information and the second characterization information to produce the characterization information 720. The characterization information 720 further includes insured age, gender, smoker, insured health record, historical life expectancy data, a requested purchase price, an offered purchase price, etc.).

Having analyzed the multitude of available longevity-contingent instruments to produce the characterization information 720, in a fourth step, when the first characterization information and the second characterization information indicates availability of the first face value benefit to fund the first sequential portion of the second premium payment stream in accordance with the initial rive approach 750, the processing module 44 selects the first longevity-contingent instrument 722 and the second longevity-contingent instrument 724 to include in the initial set of longevity-contingent instruments. For example, the processing module 44 identifies the first and second longevity-contingent instruments, causes title transfer (e.g., purchase via a transaction with the user device 32-1 and/or longevity-contingent instrument provider server 704-1), and lists the first and second longevity-contingent instruments in the longevity-contingent instrument information 660 of the database 30.

FIG. 27C further illustrates the example of operation of steps of the method for the riving of the longevity-contingent instruments where, having selected the initial set of longevity-contingent instruments, in a fifth step, the processing module 44 rives the first longevity-contingent instrument 722 based on the first face value benefit, the first premium payment stream and in accordance with the initial rive approach 750 to produce a first sub-asset 728 of a plurality of sub-assets of the initial set of longevity-contingent instruments and a first sub-liability 730 of a plurality of sub-liabilities of the initial set of longevity-contingent instruments. The first sub-liability 730 is associated with the first premium payment stream.

The riving of the first longevity-contingent instrument 722 includes generating beneficiary ownership of the first face value benefit to be associated with the first sub-asset 728. For example, the processing module 44 facilitates listing a legal entity of the first sub-asset as a partial beneficiary of the first longevity-contingent instrument and updates the sub-asset information 690 with the first sub-asset 728. As another example, the processing module 44 facilitates listing another legal entity of the first sub-liability as one of another partial beneficiary of the first longevity-contingent instrument and updates the sub-liability information 726 with the first sub-liability 730.

The riving of the first longevity-contingent instrument 722 further includes generating fiduciary responsibility of the first premium payment stream to be associated with the first sub-liability. For example, the processing module 44 facilitates listing the other legal entity of the first sub-liability as having fiduciary responsibility of the first premium payment stream of the first longevity-contingent instrument 722.

Having rived the first longevity-contingent instrument 722, in a sixth step, the processing module 44 rives the second longevity-contingent instrument 724 based on the second face value benefit, the second premium payment stream and in accordance with the initial rive approach 750 to produce a second sub-asset 732 of the plurality of sub-assets and a second sub-liability 734 of the plurality of sub-liabilities. The second sub-liability 734 is associated with the second premium payment stream. The processing module 44 further updates the sub-asset information 690 with the second sub-asset 732 and updates the sub-liability information 726 with the second sub-liability 734.

FIG. 27D further illustrates the example of operation of steps of the method for the riving of the longevity-contingent instruments where, having rived the longevity-contingent instruments, in a seventh step, the processing module 44 issues sub-asset information 690 to the benefactor computing device (e.g., to the benefactor server 700). The sub-asset information 690 is based on the plurality of sub-assets and the initial rive approach 750. The issuing includes generating the sub-asset information 690 from all of the sub-assets and sending, via the network 28 of FIG. 1, the sub-asset information 690 to the benefactor server 700.

Having issued the sub-asset information, in an eight step, the processing module 44 issues sub-liability information 726 to the debtor computing device (e.g., to the debtor server 702). The sub-liability information 726 is based on the plurality of sub-liabilities and the initial rive approach 750. The issuing includes generating the sub-liability information 726 from all of the sub-liabilities and sending, via the network 28 of FIG. 1, the sub-liability information 726 to the debtor server 702.

FIG. 27E further illustrates the example of operation of steps of the method for the riving of the longevity-contingent instruments where, having issued the sub-liability information to the debtor computing device, in a ninth step, the processing module 44 associates the plurality of sub-assets with a benefit cash account 670 and associates the plurality of sub-liabilities with a premium cash escrow 668. The benefit cash account 670 is associated with the benefactor computing device and the premium cash escrow 668 is associated with the debtor computing device.

Having associated the sub-assets and the sub-liabilities, in a tenth step, the processing module 44, when available (e.g., upon payment of a death benefit), facilitates payment of a first portion of the first face value benefit 742 to the premium cash escrow 668 in accordance with the first sub-liability. The first portion of the first face value benefit is determined in accordance with the initial rive approach 750.

Having facilitated payment of a first portion of the first face value benefit 742 to the premium cash escrow 668, in an eleventh step, the processing module 44 determines a subsequent rive approach 760 for riving a subsequent set of longevity-contingent instruments of the multitude of available longevity-contingent instruments based on the rive approach requirements 714. For example, when a gap occurs between the payment of early premium payments and when multiple subsequent benefit payments are available. A third longevity-contingent instrument of the subsequent set of longevity-contingent instruments includes a third face value benefit and a third premium payment stream. A fourth longevity-contingent instrument of the subsequent set of longevity-contingent instruments includes a fourth face value benefit and a fourth premium payment stream. When available, a portion of the third face value benefit is utilized to fund at least some of the fourth premium payment stream in accordance with the subsequent rive approach.

The method described above module can alternatively be performed by various modules of the communication system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element etc.) that stores operational instructions can, when executed by one or more processing modules of one or more computing devices (e.g., one or more servers) of the communication system 10, cause the one or more computing devices to perform any or all of the steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
interpreting, by a computing device, digitally encoded rive parameters from one or more of a benefactor computing device and a debtor computing device to produce rive approach requirements;
determining, by the computing device, an initial rive approach for riving an initial set of longevity-contingent instruments of a multitude of available longevity-contingent instruments based on the rive approach requirements, wherein a first longevity-contingent instrument of the initial set of longevity-contingent instruments includes a first face value benefit and a first premium payment stream, wherein a second longevity-contingent instrument of the initial set of longevity-contingent instruments includes a second face value benefit and a second premium payment stream, wherein, availability of the first face value benefit is to fund a first sequential portion of the second premium payment stream in accordance with the initial rive approach;
analyzing, by the computing device, a subset of the multitude of available longevity-contingent instruments to produce characterization information, wherein the subset of the multitude of available longevity-contingent instruments includes the first longevity-contingent instrument and the second longevity-contingent instrument, wherein the characterization information includes first characterization information for the first longevity-contingent instrument and second characterization information for the second longevity-contingent instrument; and
when the first characterization information and the second characterization information indicates availability of the first face value benefit to fund the first sequential portion of the second premium payment stream in accordance with the initial rive approach:
selecting, by the computing device, the first longevity-contingent instrument and the second longevity-contingent instrument to include in the initial set of longevity-contingent instruments;
riving, by the computing device, the first longevity-contingent instrument based on the first face value benefit, the first premium payment stream and in accordance with the initial rive approach to produce a first sub-asset of a plurality of sub-assets of the initial set of longevity-contingent instruments and a first sub-liability of a plurality of sub-liabilities of the initial set of longevity-contingent instruments, wherein the first sub-liability is associated with the first premium payment stream;
riving, by the computing device, the second longevity-contingent instrument based on the second face value benefit, the second premium payment stream and in accordance with the initial rive approach to produce a second sub-asset of the plurality of sub-assets and a second sub-liability of the plurality of sub-liabilities, wherein the second sub-liability is associated with the second premium payment stream;
issuing, by the computing device, sub-asset information to the benefactor computing device, wherein the sub-asset information is based on the plurality of sub-assets and the initial rive approach; and
issuing, by the computing device, sub-liability information to the debtor computing device, wherein the sub-liability information is based on the plurality of sub-liabilities and the initial rive approach.

2. The method of claim 1 further comprises one or more of:
associating, by the computing device, the plurality of sub-assets with a benefit cash account, wherein the benefit cash account is associated with the benefactor computing device;
associating, by the computing device, the plurality of sub-liabilities with a premium cash escrow, wherein the premium cash escrow is associated with the debtor computing device;
when available, facilitating, by the computing device, payment of the first face value benefit to the premium cash escrow in accordance with the first sub-liability, wherein the first face value benefit is determined in accordance with the initial rive approach; and
determining, by the computing device, a subsequent rive approach for riving a subsequent set of longevity-contingent instruments of the multitude of available longevity-contingent instruments based on the rive approach requirements, wherein a third longevity-contingent instrument of the subsequent set of longevity-contingent instruments includes a third face value benefit and a third premium payment stream, wherein a fourth longevity-contingent instrument of the subsequent set of longevity-contingent instruments includes a fourth face value benefit and a fourth premium payment stream, wherein, when available, a portion of the third face value benefit is utilized to fund at least some of the fourth premium payment stream in accordance with the subsequent rive approach.

3. The method of claim 1, wherein the interpreting the digitally encoded rive parameters from the one or more of the benefactor computing device and the debtor computing device to produce the rive approach requirements comprises one or more of:
decrypting encrypted asset rive parameters received from the benefactor computing device to produce a first subset of the digitally encoded rive parameters;
decrypting encrypted liability rive parameters received from the debtor computing device to produce a second subset of the digitally encoded rive parameters;
decoding the first subset of the digitally encoded rive parameters to produce asset rive parameters;
decoding the second subset of the digitally encoded rive parameters to produce liability rive parameters; and
aggregating the asset rive parameters and the liability rive parameters to produce the rive approach requirements.

4. The method of claim 1, wherein the determining the initial rive approach comprises one of:
when the rive approach requirements indicate that the plurality of sub-assets of the initial set of longevity-contingent instruments is to be greater than a sum of the plurality of sub-liabilities of the initial set of longevity-contingent instruments and initial sequential portions of a plurality of subsequent premium payment streams of another plurality of sub-liabilities of a subsequent set of longevity-contingent instruments:
establishing the initial rive approach as an initial surplus approach;
when the rive approach requirements indicate that the plurality of sub-assets of the initial set of longevity-contingent instruments is to be less than the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial deficit approach;
when the rive approach requirements indicate that the plurality of sub-assets of the initial set of longevity-contingent instruments is to be substantially the same as the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial break-even approach;
when the rive approach requirements indicate that the plurality of sub-assets of the initial set of longevity-contingent instruments is to be a pre-determined percentage of the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial pro rata approach; and
when the rive approach requirements indicate that the plurality of sub-assets of the initial set of longevity-contingent instruments is to be a pre-determined initial level:
establishing the initial rive approach as an initial consistency approach.

5. The method of claim 1, wherein the analyzing the subset of the multitude of available longevity-contingent instruments to produce the characterization information comprises:
accessing the multitude of available longevity-contingent instruments;
determining the first characterization information to include one or more of:
a first estimated timeframe for payout of the first face value benefit;
a present value of the first face value benefit utilizing the first estimated timeframe; and
a present value of the first premium payment stream;
determining the second characterization information to include one or more of:
a second estimated timeframe for payout of the second face value benefit;
a present value of the second face value benefit utilizing the second estimated timeframe; and
a present value of the second premium payment stream; and
aggregating the first characterization information and the second characterization information to produce the characterization information.

6. The method of claim 1, wherein the riving the first longevity-contingent instrument in accordance with the initial rive approach to produce the first sub-asset and the first sub-liability comprises:
generating beneficiary ownership of the first face value benefit to be associated with the first sub-asset; and
generating fiduciary responsibility of the first premium payment stream to be associated with the first sub-liability.

7. A computing device of a computing system, the computing device comprises:
an interface;
a local memory; and
a processing module operably coupled to the interface and the local memory, wherein the processing module functions to:
interpret digitally encoded rive parameters from one or more of a benefactor computing device and a debtor computing device to produce rive approach requirements;
determine an initial rive approach for riving an initial set of longevity-contingent instruments of a multitude of available longevity-contingent instruments based on the rive approach requirements, wherein a first longevity-contingent instrument of the initial set of longevity-contingent instruments includes a first face value benefit and a first premium payment stream, wherein a second longevity-contingent instrument of the initial set of longevity-contingent instruments includes a second face value benefit and a second premium payment stream, wherein, availability of the first face value benefit is to fund a first sequential portion of the second premium payment stream in accordance with the initial rive approach;
analyze a subset of the multitude of available longevity-contingent instruments to produce characterization information, wherein the subset of the multitude of available longevity-contingent instruments includes the first longevity-contingent instrument and the second longevity-contingent instrument, wherein the characterization information includes first characterization information for the first longevity-contingent instrument and second characterization information for the second longevity-contingent instrument; and
when the first characterization information and the second characterization information indicates availability of the first face value benefit to fund the first sequential portion of the second premium payment stream in accordance with the initial rive approach:
select the first longevity-contingent instrument and the second longevity-contingent instrument to include in the initial set of longevity-contingent instruments;
rive the first longevity-contingent instrument based on the first face value benefit, the first premium payment stream and in accordance with the initial rive approach to produce a first sub-asset of a plurality of sub-assets of the initial set of longevity-contingent instruments and a first sub-liability of a plurality of sub-liabilities of the initial set of longevity-contingent instruments, wherein the first sub-liability is associated with the first premium payment stream;
rive the second longevity-contingent instrument based on the second face value benefit, the second premium payment stream and in accordance with the initial rive approach to produce a second sub-asset of the plurality of sub-assets and a second sub-liability of the plurality of sub-liabilities, wherein the second sub-liability is associated with the second premium payment stream;
issue, via the interface, sub-asset information to the benefactor computing device, wherein the sub-asset information is based on the plurality of sub-assets and the initial rive approach; and
issue, via the interface, sub-liability information to the debtor computing device, wherein the sub-liability information is based on the plurality of sub-liabilities and the initial rive approach.

8. The computing device of claim 7, wherein the processing module further functions to:
associate the plurality of sub-assets with a benefit cash account, wherein the benefit cash account is associated with the benefactor computing device;
associate the plurality of sub-liabilities with a premium cash escrow, wherein the premium cash escrow is associated with the debtor computing device;
when available, facilitate payment of the first face value benefit to the premium cash escrow in accordance with the first sub-liability, wherein the first face value benefit is determined in accordance with the initial rive approach; and
determine a subsequent rive approach for riving a subsequent set of longevity-contingent instruments of the multitude of available longevity-contingent instruments based on the rive approach requirements, wherein a third longevity-contingent instrument of the subsequent set of longevity-contingent instruments includes a third face value benefit and a third premium payment stream, wherein a fourth longevity-contingent instrument of the subsequent set of longevity-contingent instruments includes a fourth face value benefit and a fourth premium payment stream, wherein, when available, a portion of the third face value benefit is utilized to fund at least some of the fourth premium payment stream in accordance with the subsequent rive approach.

9. The computing device of claim 7, wherein the processing module functions to interpret the digitally encoded rive parameters from the one or more of the benefactor computing device and the debtor computing device to produce the rive approach requirements by one or more of:
decrypting encrypted asset rive parameters received from the benefactor computing device to produce a first subset of the digitally encoded rive parameters;
decrypting encrypted liability rive parameters received from the debtor computing device to produce a second subset of the digitally encoded rive parameters;
decoding the first subset of the digitally encoded rive parameters to produce asset rive parameters;
decoding the second subset of the digitally encoded rive parameters to produce liability rive parameters; and
aggregating the asset rive parameters and the liability rive parameters to produce the rive approach requirements.

10. The computing device of claim 7, wherein the processing module functions to determine the initial rive approach by one of:
when the rive approach requirements indicate that the plurality of sub-assets of the initial set of longevity-contingent instruments is to be greater than a sum of the plurality of sub-liabilities of the initial set of longevity-contingent instruments and initial sequential portions of a plurality of subsequent premium payment streams of another plurality of sub-liabilities of a subsequent set of longevity-contingent instruments:
establishing the initial rive approach as an initial surplus approach;
when the rive approach requirements indicate that the plurality of sub-assets of the initial set of longevity-contingent instruments is to be less than the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial deficit approach;
when the rive approach requirements indicate that the plurality of sub-assets of the initial set of longevity-contingent instruments is to be substantially the same as the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial break-even approach;
when the rive approach requirements indicate that the plurality of sub-assets of the initial set of longevity-contingent instruments is to be a pre-determined percentage of the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial pro rata approach; and
when the rive approach requirements indicate that the plurality of sub-assets of the initial set of longevity-contingent instruments is to be a pre-determined initial level:
establishing the initial rive approach as an initial consistency approach.

11. The computing device of claim 7, wherein the processing module functions to analyze the subset of the multitude of available longevity-contingent instruments to produce the characterization information by:
accessing, via the interface, the multitude of available longevity-contingent instruments;
determining the first characterization information to include one or more of:
a first estimated timeframe for payout of the first face value benefit;
a present value of the first face value benefit utilizing the first estimated timeframe; and
a present value of the first premium payment stream;
determining the second characterization information to include one or more of:
a second estimated timeframe for payout of the second face value benefit;
a present value of the second face value benefit utilizing the second estimated timeframe; and
a present value of the second premium payment stream; and
aggregating the first characterization information and the second characterization information to produce the characterization information.

12. The computing device of claim 7, wherein the processing module functions to rive the first longevity-contingent instrument in accordance with the initial rive approach to produce the first sub-asset and the first sub-liability by:
generating beneficiary ownership of the first face value benefit to be associated with the first sub-asset; and
generating fiduciary responsibility of the first premium payment stream to be associated with the first sub-liability.

13. A computer readable memory comprises:
a first memory element that stores operational instructions that, when executed by a processing module of a computing device, causes the processing module to:
interpret digitally encoded rive parameters from one or more of a benefactor computing device and a debtor computing device to produce rive approach requirements;
a second memory element that stores operational instructions that, when executed by the processing module, causes the processing module to:
determine an initial rive approach for riving an initial set of longevity-contingent instruments of a multitude of available longevity-contingent instruments based on the rive approach requirements, wherein a first longevity-contingent instrument of the initial set of longevity-contingent instruments includes a first face value benefit and a first premium payment stream, wherein a second longevity-contingent instrument of the initial set of longevity-contingent instruments includes a second face value benefit and a second premium payment stream, wherein, availability of the first face value benefit is to fund a first sequential portion of the second premium payment stream in accordance with the initial rive approach;
a third memory element that stores operational instructions that, when executed by the processing module, causes the processing module to:
analyze a subset of the multitude of available longevity-contingent instruments to produce characterization information, wherein the subset of the multitude of available longevity-contingent instruments includes the first longevity-contingent instrument and the second longevity-contingent instrument, wherein the characterization information includes first characterization information for the first longevity-contingent instrument and second characterization information for the second longevity-contingent instrument; and
a fourth memory element that stores operational instructions that, when executed by the processing module, causes the processing module to:
when the first characterization information and the second characterization information indicates availability of the first face value benefit to fund the first sequential portion of the second premium payment stream in accordance with the initial rive approach:
select the first longevity-contingent instrument and the second longevity-contingent instrument to include in the initial set of longevity-contingent instruments;
rive the first longevity-contingent instrument based on the first face value benefit, the first premium payment stream and in accordance with the initial rive approach to produce a first sub-asset of a plurality of sub-assets of the initial set of longevity-contingent instruments and a first sub-liability of a plurality of sub-liabilities of the initial set of longevity-contingent instruments, wherein the first sub-liability is associated with the first premium payment stream;
rive the second longevity-contingent instrument based on the second face value benefit, the second premium payment stream and in accordance with the initial rive approach to produce a second sub-asset of the plurality of sub-assets and a second sub-liability of the plurality of sub-liabilities, wherein the second sub-liability is associated with the second premium payment stream;
issue sub-asset information to the benefactor computing device, wherein the sub-asset information is based on the plurality of sub-assets and the initial rive approach; and
issue sub-liability information to the debtor computing device, wherein the sub-liability information is based on the plurality of sub-liabilities and the initial rive approach.

14. The computer readable memory of claim 13 further comprises:
a fifth memory element that stores operational instructions that, when executed by the processing module, causes the processing module to:
associate the plurality of sub-assets with a benefit cash account, wherein the benefit cash account is associated with the benefactor computing device;
associate the plurality of sub-liabilities with a premium cash escrow, wherein the premium cash escrow is associated with the debtor computing device;
when available, facilitate payment of the first face value benefit to the premium cash escrow in accordance with the first sub-liability, wherein the first face value benefit is determined in accordance with the initial rive approach; and
determine a subsequent rive approach for riving a subsequent set of longevity-contingent instruments of the multitude of available longevity-contingent instruments based on the rive approach requirements, wherein a third longevity-contingent instrument of the subsequent set of longevity-contingent instruments includes a third face value benefit and a third premium payment stream, wherein a fourth longevity-contingent instrument of the subsequent set of longevity-contingent instruments includes a fourth face value benefit and a fourth premium payment stream, wherein, when available, a portion of the third face value benefit is utilized to fund at least some of the fourth premium payment stream in accordance with the subsequent rive approach.

15. The computer readable memory of claim 13, wherein the processing module functions to execute the operational instructions stored by the first memory element to cause the processing module to interpret the digitally encoded rive parameters from the one or more of the benefactor computing device and the debtor computing device to produce the rive approach requirements by one or more of:
decrypting encrypted asset rive parameters received from the benefactor computing device to produce a first subset of the digitally encoded rive parameters;
decrypting encrypted liability rive parameters received from the debtor computing device to produce a second subset of the digitally encoded rive parameters;
decoding the first subset of the digitally encoded rive parameters to produce asset rive parameters;
decoding the second subset of the digitally encoded rive parameters to produce liability rive parameters; and
aggregating the asset rive parameters and the liability rive parameters to produce the rive approach requirements.

16. The computer readable memory of claim 13, wherein the processing module functions to execute the operational instructions stored by the second memory element to cause the processing module to determine the initial rive approach by one of:
when the rive approach requirements indicate that the plurality of sub-assets of the initial set of longevity-contingent instruments is to be greater than a sum of the plurality of sub-liabilities of the initial set of longevity-contingent instruments and initial sequential portions of a plurality of subsequent premium payment streams of another plurality of sub-liabilities of a subsequent set of longevity-contingent instruments:
establishing the initial rive approach as an initial surplus approach;
when the rive approach requirements indicate that the plurality of sub-assets of the initial set of longevity-contingent instruments is to be less than the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial deficit approach;
when the rive approach requirements indicate that the plurality of sub-assets of the initial set of longevity-contingent instruments is to be substantially the same as the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial break-even approach;
when the rive approach requirements indicate that the plurality of sub-assets of the initial set of longevity-contingent instruments is to be a pre-determined percentage of the sum of the plurality of sub-liabilities of the initial set of longevity-contingent instruments and the initial sequential portions of the plurality of subsequent premium payment streams of the other plurality of sub-liabilities of the subsequent set of longevity-contingent instruments:
establishing the initial rive approach as an initial pro rata approach; and
when the rive approach requirements indicate that the plurality of sub-assets of the initial set of longevity-contingent instruments is to be a pre-determined initial level:
establishing the initial rive approach as an initial consistency approach.

17. The computer readable memory of claim 13, wherein the processing module functions to execute the operational instructions stored by the third memory element to cause the processing module to analyze the subset of the multitude of available longevity-contingent instruments to produce the characterization information by:
accessing the multitude of available longevity-contingent instruments;
determining the first characterization information to include one or more of:
a first estimated timeframe for payout of the first face value benefit;
a present value of the first face value benefit utilizing the first estimated timeframe; and
a present value of the first premium payment stream;
determining the second characterization information to include one or more of:
a second estimated timeframe for payout of the second face value benefit;
a present value of the second face value benefit utilizing the second estimated timeframe; and
a present value of the second premium payment stream; and
aggregating the first characterization information and the second characterization information to produce the characterization information.

18. The computer readable memory of claim 13, wherein the processing module functions to execute the operational instructions stored by the fourth memory element to cause the processing module to rive the first longevity-contingent instrument in accordance with the initial rive approach to produce the first sub-asset and the first sub-liability by:
generating beneficiary ownership of the first face value benefit to be associated with the first sub-asset; and
generating fiduciary responsibility of the first premium payment stream to be associated with the first sub-liability.
